(19) United States
(12) Patent Application Publication
(10) Pub. No.: US 2023/0050088 A1
(43) Pub. Date: Feb. 16, 2023

(54) METHOD AND DEVICE IN A NODE FOR WIRELESS COMMUNICATION

(71) Applicants: Lu WU, SHANGHAI (CN); Xiaobo ZHANG, SHANGHAI (CN); Jin LIU, SHANGHAI (CN)

(72) Inventors: Lu WU, SHANGHAI (CN); Xiaobo ZHANG, SHANGHAI (CN); Jin LIU, SHANGHAI (CN)

(73) Assignee: SHANGHAI LANGBO COMMUNICATION TECHNOLOGY COMPANY LIMITED, SHANGHAI (CN)

(21) Appl. No.: 17/978,219

(22) Filed: Nov. 1, 2022

Related U.S. Application Data
(63) Continuation of application No. PCT/CN2021/091805, filed on May 4, 2021.

(30) Foreign Application Priority Data
May 6, 2020 (CN) 202010372525.3
Jun. 22, 2020 (CN) 202010571722.8
Jun. 23, 2020 (CN) 202010582475.1

(51) Int. Cl. H04W 72/02; H04W 72/04; H04W 24/08; H04L 1/18

(52) U.S. Cl. CPC H04W 72/02; H04W 72/0446; H04W 72/0453; H04W 24/08; H04L 1/1812

(57) ABSTRACT

Disclosure discloses a method and a device in a node for wireless communications. A first node receives first information; and transmits a first signaling in a first sub-channel; the first information indicates a first resource pool; the first sub-channel is one of L sub-channels, and frequency-domain resource blocks comprised by any one of the L sub-channels belong to the first resource pool; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising at least one sub-channel. The present disclosure makes full use of all resources available in the sidelink resource pool.

### CROSS REFERENCE TO RELATED APPLICATIONS

This application is a continuation of International Application No. PCT/CN2021/091805, filed May 5, 2021, which claims the priority benefit of Chinese Patent Application No. 202010372525.3, filed on May 6, 2020, and claims the priority benefit of Chinese Patent Application No. 202010571722.8, filed on Jun. 22, 2020, and claims the priority benefit of Chinese Patent Application No. 202010582475.1, filed on Jun. 23, 2020, the full disclosure of which is incorporated herein by reference.

### BACKGROUND

### Technical Field

The present disclosure relates to transmission methods and devices in wireless communication systems, and in particular to a Sidelink-related transmission scheme and device in wireless communications.

### Related Art

Application scenarios of future wireless communication systems are becoming increasingly diversified, and different application scenarios have different performance demands on systems. In order to meet different performance requirements of various application scenarios, the 3^{rd} Generation Partner Project (3GPP) Radio Access Network (RAN) #72 plenary session decided to conduct the study of New Radio (NR), or what is called fifth Generation (5G). The work Item (WI) of NR was approved at the 3GPP RAN #75 plenary session to standardize the NR.

In response to rapidly growing Vehicle-to-Everything (V2X) traffic, 3GPP has started standards setting and research work under the framework of NR. Currently, 3GPP has completed planning work targeting 5G V2X requirements and has included these requirements into standard TS22.886, where 3GPP identifies and defines 4 major Use Case Groups, covering cases of Vehicles Platooning, supporting Extended Sensors, Advanced Driving and Remote Driving. At 3GPPRAN #80 Plenary Session, the technical Study Item (SI) of NR V2X has already been started.

### SUMMARY

In NR V2X system, a resource pool in Sidelink comprises a number of Physical Resource Blocks (PRBs). In configurations of sub-channels of different sizes, the remaining PRBs are likely to be insufficient to form a complete sub-channel, and will have to be discarded, especially in the configuration of a large-size sub-channel, where the large quantity of remaining PRBs will result in outstanding waste of resources. According to the requirements of 5GAA WG4, all system resources available in SL communications shall be put into use to reach a maximum system bandwidth.

To address the above problem, a method for SL resource configuration is proposed by the present disclosure to construct a virtual sub-channel by the remaining PRBs to enable effective utilization of SL resources. It should be noted that the embodiments of the UE of the present disclosure and the characteristics in the embodiments may be applied to a base station if no conflict is incurred, and vice versa. In the case of no conflict, the embodiments of the present disclosure and the characteristics in the embodiments may be combined with each other arbitrarily. Furthermore, though originally targeted at SL, the present disclosure is also applicable to Uplink (UL), and although originally targeted at single-carrier communications, the present disclosure is also applicable to multicarrier communications; also, the present disclosure only applies to single-antenna communications but also to multi-antenna communications. The present disclosure is targeted at V2X scenarios and applies to other scenarios like terminal-base station, terminal-relay or relay-base station communications, where technical effects similar to those in the V2X scenarios will be achieved. Additionally, the adoption of a unified solution for various scenarios (including but not limited to V2X scenario and terminal-base station communications) contributes to the reduction of hardcore complexity and costs.

Particularly, for interpretations of the terminology in the present disclosure, refer to definitions given in TS36 series, TS38 series and TS37 series of 3GPP specifications, as well as in the specification protocols of the Institute of Electrical and Electronics Engineers (IEEE).

The present disclosure provides a method in a first node for wireless communications, comprising:

receiving first information; and

transmitting a first signaling in a first sub-channel;

herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, a problem to be solved in the present disclosure is the issue of surplus PRBs remained by the SL resource pool allocating sub-channels.

In one embodiment, a method offered in the present disclosure is to use the remaining PRBs to construct a virtual sub-channel, that is, a second candidate sub-channel.

In one embodiment, a method offered in the present disclosure is to associate a virtual sub-channel, i.e., a second candidate sub-channel with a physical sub-channel, i.e., a first candidate sub-channel.

In one embodiment, a method offered in the present disclosure is to associate mapping of a PSCCH with a virtual sub-channel.

In one embodiment, a method offered in the present disclosure is to associate resource sensing with a virtual sub-channel.

In one embodiment, characteristics of the above methods lie in that PSCCH mapping depends on whether an assigned sub-channel is a first candidate sub-channel or a second candidate sub-channel.

In one embodiment, characteristics of the above methods lie in that resource sensing depends on whether an assigned sub-channel is a first candidate sub-channel or a second candidate sub-channel.

In one embodiment, the above methods are advantageous in that whatever the configuration of a sub-channel, all resources that are available in the SL resource pool can be utilized in an effective manner.

According to one aspect of the present disclosure, the above method is characterized in that the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group, and the first signaling indicates a quantity of the positive integer number of sub-channels comprised by the target sub-channel group.

According to one aspect of the present disclosure, the above method is characterized in that the first sub-channel belongs to the target sub-channel group; when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group; the first signaling indicates a quantity of the positive integer number of sub-channels comprised by the target sub-channel group.

According to one aspect of the present disclosure, the above method is characterized in that when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

According to one aspect of the present disclosure, the above method is characterized in comprising:

transmitting a first signal in the target sub-channel group;

herein, the first signaling indicates priority of the first signal; the first signaling indicates a time-frequency resource occupied by the first signal, and the time-frequency resource occupied by the first signal indicated by the first signaling comprises the target sub-channel group in frequency domain.

According to one aspect of the present disclosure, the above method is characterized in comprising:

monitoring a second signaling in a first target time-frequency resource group; and

monitoring a third signaling in a second target time-frequency resource group;

a measurement on the first target time-frequency resource group being used to determine whether a first candidate time-frequency resource block belongs to a candidate resource pool; and

a measurement on the second target time-frequency resource group being used to determine whether a second candidate time-frequency resource block belongs to a candidate resource pool;

herein, the second signaling indicates the first target time-frequency resource group, while the third signaling indicates the second target time-frequency resource group; both the first target time-frequency resource group and the second target time-frequency resource group belong to a first sensing window in time domain; the first target time-frequency resource group comprises T1 time-frequency resource block(s), and each of the T1 time-frequency resource block(s) comprised by the first target time-frequency resource group comprises the first candidate sub-channel in frequency domain, T1 being a positive integer; the second target time-frequency resource group comprises T2 time-frequency resource block(s), and each of the T2 time-frequency resource block(s) comprised by the second target time-frequency resource group comprises the second candidate sub-channel in frequency domain, T2 being a positive integer; frequency-domain resources occupied by the first candidate time-frequency resource block and frequency-domain resources occupied by the first target time-frequency resource group are the same; frequency-domain resources occupied by the second candidate time-frequency resource block and frequency-domain resources occupied by the second target time-frequency resource group are the same; the candidate resource pool comprises a positive integer number of time-frequency resource block(s), and any time-frequency resource block comprised in the candidate resource pool is later than the first sensing window in time domain, and the time-frequency resource occupied by the first signal indicated by the first signaling belongs to the candidate resource pool.

According to one aspect of the present disclosure, the above method is characterized in that the first node is a UE.

According to one aspect of the present disclosure, the above method is characterized in that the first node is a relay node.

According to one aspect of the present disclosure, the above method is characterized in that the first node is a base station.

The present disclosure provides a method in a second node for wireless communications, comprising:

receiving first information; and

receiving a first signaling in a first sub-channel;

herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

According to one aspect of the present disclosure, the above method is characterized in that the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group, and the first signaling indicates a quantity of the positive integer number of sub-channels comprised by the target sub-channel group.

According to one aspect of the present disclosure, the above method is characterized in that the first sub-channel belongs to the target sub-channel group; when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group; the first signaling indicates a quantity of the positive integer number of sub-channels comprised by the target sub-channel group.

According to one aspect of the present disclosure, the above method is characterized in that when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

According to one aspect of the present disclosure, the above method is characterized in comprising:

receiving a first signal in the target sub-channel group;

herein, the first signaling indicates priority of the first signal; the first signaling indicates a time-frequency resource occupied by the first signal, and the time-frequency resource occupied by the first signal indicated by the first signaling comprises the target sub-channel group in frequency domain.

According to one aspect of the present disclosure, the above method is characterized in that the second node is a base station.

According to one aspect of the present disclosure, the above method is characterized in that the second node is a relay node.

According to one aspect of the present disclosure, the above method is characterized in that the second node is a UE.

The present disclosure provides a first node for wireless communications, comprising:

a first receiver, receiving first information; and

a first transmitter, transmitting a first signaling in a first sub-channel;

herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

The present disclosure provides a second node for wireless communications, comprising:

a second receiver, receiving first information;

the second receiver, receiving a first signaling in a first sub-channel;

herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the present disclosure has the following advantages:

The present disclosure manages to address the issue of surplus PRBs left over through sub-channel allocation by the SL resource pool;

the present disclosure utilizes remaining PRBs in constructing a virtual sub-channel (i.e., a second candidate sub-channel);

the present disclosure creates an association between a virtual sub-channel (that is, a second candidate sub-channel) and a physical sub-channel (that is, a first candidate sub-channel);

the present disclosure creates an association between PSCCH mapping and a virtual sub-channel;

the present disclosure creates an association between resource sensing and a virtual sub-channel;

in the present disclosure, the mapping of a PSCCH depends on whether a sub-channel allocated is a first candidate sub-channel or a second candidate sub-channel;

in the present disclosure, the resource sensing depends on whether a sub-channel allocated is a first candidate sub-channel or a second candidate sub-channel;

in the present disclosure, no matter how a sub-channel is configured, all available resources in the SL resource pool can be utilized effectively;

to support multiplexing of various Intra-UE traffics, the designing of a Hybrid Automatic Repeat reQuest (HARQ) Codebook is a key issue that remains to be solved.

To address the above problem, the present disclosure provides a solution. In the description above, only UL is taken as an example, but the present disclosure is also applicable to Downlink (DL) transmission and Sidelink (SL) transmission, with similar technical effect achieved. Besides, the adoption of a unified solution for various scenarios (including but not limited to UL, DL and SL) contributes to the reduction of hardcore complexity and costs. It should be noted that the embodiments of the UE of the present disclosure and the characteristics in the embodiments may be applied to a base station if no conflict is incurred, and vice versa. In the case of no conflict, the embodiments of the present disclosure and the characteristics in the embodiments may be combined with each other arbitrarily.

The present disclosure provides a method in a first node for wireless communications, comprising:

monitoring first-type signalings, second-type signalings and third-type signalings in a first time-frequency resource pool;

receiving a first signaling in the first time-frequency resource pool; and

transmitting a first information block set in a first radio resource block;

herein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one embodiment, a problem to be solved in the present disclosure is how to design a HARQ Codebook, which is critical to supporting multiplexing of different Intra-UE traffics.

In one embodiment, a problem to be solved in the present disclosure is as follows: in Long Term Evolution (LIE) and NR systems, a Downlink Assignment Index (DAI) is generally employed in cellular link transmission to determine a HARQ feedback codebook, thus increasing the efficiency of HARQ feedback and preventing disagreement between both sides of communications on the understanding of HARQ feedback codebook. The DAI needs to be reconsidered to better support the transmission of different traffics.

In one embodiment, a problem to be solved in the present disclosure is NR Rel-16 specifications support feedbacking SL HARQ on a Physical Uplink Control CHannel (PUCCH), when the PUCCH overlaps with another PUCCH for feedbacking DL HARQ in time domain, which PUCCH is to be dropped shall be determined according to the priority of SL transmission and DL transmission; so how to support the multiplexing of SL HARQ and DL HARQ becomes a key issue.

In one embodiment, a problem to be solved in the present disclosure is that DAI needs to be reconsidered to support multiplexing of SL HARQ and DL HARQ.

In one embodiment, the essence of the above method lies in that first-type signalings, second-type signalings and third-type signalings are respectively for three types of traffics; a first field is a DAI, between the first-type signalings and the third-type signalings only DAIs of the first-type signalings are used for counting second-type signalings. An advantage of the above method is realizing the HARQ multiplexing of various Intra-UE traffics.

In one embodiment, the essence of the above method lies in that first-type signaling and third-type signaling corresponds to DL transmission, while second-type signaling corresponds to SL transmission; a first field is a DAI, between the first-type signaling and the third-type signaling only a DAI of the first-type signaling is used for counting the second-type signaling. An advantage of the above method is realizing the multiplexing of SL HARQ and DL HARQ.

According to one aspect of the present disclosure, the above method is characterized in that the first-type signaling corresponds to a first priority, and the third-type signaling corresponds to a second priority, the first priority being different from the second priority.

According to one aspect of the present disclosure, the above method is characterized in comprising:

receiving a second signaling in the first time-frequency resource pool;

herein, the second signaling is the second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

According to one aspect of the present disclosure, the above method is characterized in comprising:

receiving L1-1 signaling(s) of L1 signalings other than the first signaling in the first time-frequency resource pool, L1 being a positive integer greater than 1;

herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings.

According to one aspect of the present disclosure, the above method is characterized in comprising:

transmitting the second information block subset in a second radio resource block;

herein, the first signaling is the third-type signaling; the second signaling is used to indicate the second radio resource block, the second radio resource block being orthogonal to the first radio resource block in time domain.

According to one aspect of the present disclosure, the above method is characterized in comprising:

receiving L2-1 signaling(s) of L2 signalings other than the second signaling in the first time-frequency resource pool, L2 being a positive integer greater than 1;

herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

According to one aspect of the present disclosure, the above method is characterized in that the first signaling is used for indicating semi-persistent scheduling release, and that the HARQ-ACK associated with the first signaling indicates whether the first signaling is correctly received;

or, comprising:

receiving a first bit block set;

herein, the first signaling comprises scheduling information of the first bit block set; the HARQ-ACK associated with the first signaling indicates whether each bit block in the first bit block set is correctly received.

The present disclosure provides a method in a second node for wireless communications, comprising:

transmitting a first signaling in a first time-frequency resource pool; and

receiving a first information block set in a first radio resource block;

herein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

According to one aspect of the present disclosure, the above method is characterized in that the first-type signaling corresponds to a first priority, and the third-type signaling corresponds to a second priority, the first priority being different from the second priority.

According to one aspect of the present disclosure, the above method is characterized in comprising:

transmitting a second signaling in the first time-frequency resource pool;

herein, the second signaling is the second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

According to one aspect of the present disclosure, the above method is characterized in comprising:

transmitting L1-1 signaling(s) of L1 signalings other than the first signaling in the first time-frequency resource pool, L1 being a positive integer greater than 1;

herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings.

According to one aspect of the present disclosure, the above method is characterized in comprising:

receiving the second information block subset in a second radio resource block;

herein, the first signaling is the third-type signaling; the second signaling is used to indicate the second radio resource block, the second radio resource block being orthogonal to the first radio resource block in time domain.

According to one aspect of the present disclosure, the above method is characterized in comprising:

transmitting L2-1 signaling(s) of L2 signalings other than the second signaling in the first time-frequency resource pool, L2 being a positive integer greater than 1;

herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising:

HARQ-ACKs associated with the corresponding signalings.

According to one aspect of the present disclosure, the above method is characterized in that the first signaling is used for indicating semi-persistent scheduling release, and that the HARQ-ACK associated with the first signaling indicates whether the first signaling is correctly received;

transmitting a first bit block set;

herein, the first signaling comprises scheduling information of the first bit block set; the HARQ-ACK associated with the first signaling indicates whether each bit block in the first bit block set is correctly received.

The present disclosure provides a first node for wireless communications, comprising:

a first receiver, monitoring first-type signalings, second-type signalings and third-type signalings in a first time-frequency resource pool; and receiving a first signaling in the first time-frequency resource pool;

a first transmitter, transmitting a first information block set in a first radio resource block;

herein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

The present disclosure provides a second node for wireless communications, comprising:

a second transmitter, transmitting a first signaling in a first time-frequency resource pool; and

a second receiver, receiving a first information block set in a first radio resource block;

herein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one embodiment, the method in the present disclosure is advantageous in the following aspects:

supporting HARQ multiplexing of various Intra-UE traffics; and

realizing the multiplexing of SL HARQ and DL HARQ.

Inventors find through researches that NR V2X supports a wide range of application scenarios, at least including 4 categories covering 25 traffic types, and requirements of Quality of Service (QoS) vary from traffic to traffic, these QoS requirements are defined by different QoS parameter groups, in which the parameters comprised include but are not limited to one or more of PC5 5G QoS Identifier (PQI), PC5 Flow bit rate, PC5 Link Aggregated Bit Rate or Range. Herein, the PQI is mapped to be QoS properties at a Tx UE, which is used for QoS processing of a control packet in transmission. In relay transmission, due to the introduction of a relay node, an original one-hop transmission from a Tx UE to a Rx UE is transformed to a two-hop transmission divided into a transmission from a Tx UE to a relay node and then a transmission from the relay node to a Rx UE, therefore, how to assign QoS parameter groups in the two-hop transmission to satisfy QoS requirements of a traffic shall be studied.

To address the above problem, the present disclosure provides a solution. It should be noted that though the present disclosure only took the NR V2X scenario for example in the statement above, it is also applicable to other scenarios (such as relay network, Device-to-Device (D2D) network, cellular network, or scenarios supporting Half-Duplex UE) confronting the same difficulty, where similar technical effects can be achieved. Additionally, the adoption of a unified solution for various scenarios (including but not limited to NR V2X scenario, DL communications, etc.) contributes to the reduction of hardcore complexity and costs. If no conflict is incurred, embodiments in a first node in the present disclosure and the characteristics of the embodiments are also applicable to any other node, and vice versa. What's more, the embodiments in the present disclosure and the characteristics in the embodiments can be arbitrarily combined if there is no conflict. Particularly, for interpretations of the terminology, nouns, functions and variants (unless otherwise specified) in the present disclosure, refer to definitions given in TS36 series, TS38 series and TS37 series of 3GPP specifications.

The present disclosure provides a method in a first node for wireless communications, comprising:

determining a first target QoS parameter group; and

transmitting a first information set, a second information set and a third information set;

herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, a problem to be solved in the present disclosure is how to allocate the target QoS parameter group between a transmitting node and a relay node.

In one embodiment, a scheme proposed in the present disclosure includes: a QoS parameter group for a transmitting node and a QoS parameter group for a relay node are respectively determined through consultation between the transmitting node and the relay node, and these two QoS parameter groups respectively work on packet processing in the transmitting node and packet processing in the relay node.

In one embodiment, a beneficial effect of the present disclosure includes: the target QoS parameter group is divided into two QoS parameter groups, which are respectively used for a transmitting node and a relay node, so as to ensure that a packet through relay transmission still satisfies the target QoS parameter group.

According to one aspect of the present disclosure, comprising:

receiving a second signaling;

herein, the second signaling indicates a second QoS parameter set, the second QoS parameter set comprises one or more QoS parameter groups, and the second QoS parameter set is used to determine the second QoS parameter group.

According to one aspect of the present disclosure, comprising:

transmitting a first signaling, the first signaling comprising a first QoS parameter set, the first QoS parameter set comprising multiple QoS parameter groups;

herein, the second signaling indicates the second QoS parameter set from the first QoS parameter set.

According to one aspect of the present disclosure, comprising:

the first packet through the radio bearer transmitting the third information set and the radio bearer transmitting the fourth information set satisfies the first target QoS parameter group.

According to one aspect of the present disclosure, comprising:

the first information set comprises at least one of the second identity or the third identity.

The present disclosure provides a method in a second node for wireless communications, comprising:

receiving a second information set and a third information set;

herein, a first information set is used to indicate a first QoS parameter group, the second information set is used to indicate a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

According to one aspect of the present disclosure, comprising:

transmitting a second signaling;

herein, the second signaling indicates a second QoS parameter set, the second QoS parameter set comprises one or more QoS parameter groups, and the second QoS parameter set is used to determine the second QoS parameter group.

According to one aspect of the present disclosure, comprising:

receiving a first signaling, the first signaling comprising a first QoS parameter set, the first QoS parameter set comprising multiple QoS parameter groups;

herein, the second signaling indicates the second QoS parameter set from the first QoS parameter set.

According to one aspect of the present disclosure, comprising:

the first packet through the radio bearer transmitting the third information set and the radio bearer transmitting the fourth information set satisfies the first target QoS parameter group.

According to one aspect of the present disclosure, comprising:

the first information set comprises at least one of the second identity or the third identity.

The present disclosure provides a first node for wireless communications, comprising:

a first receiver, determining a first target QoS parameter group; and

a first transmitter, transmitting a first information set, a second information set and a third information set;

herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

The present disclosure provides a second node for wireless communications, comprising:

a second receiver, receiving a second information set and a third information set;

herein, a first information set is used to indicate a first QoS parameter group, the second information set is used to indicate a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the present disclosure has the following advantages:

targeting relay transmission, the method provided in the present disclosure enables a target QoS parameter group to be allocated effectively between a transmitting node and a relay node;

as stated by the method provided in the present disclosure, targeting relay transmission, a transmitting node and a relay node respectively determine a QoS parameter group for the transmitting node and a QoS parameter group for the relay node through consultation, and the two QoS parameter groups are respectively used for packet processing in the transmitting node and packet processing in the relay node;

through the method provided in the present disclosure, a target QoS parameter group is divided into 2 QoS parameter groups, which are respectively used for a transmitting node and a relay node to ensure that a packet through relay transmission will still satisfy the target QoS parameter group.

### BRIEF DESCRIPTION OF THE DRAWINGS

Other features, objects and advantages of the present disclosure will become more apparent from the detailed description of non-restrictive embodiments taken in conjunction with the following drawings:

FIG. 1A illustrates a flowchart of processing of a first node according to one embodiment of the present disclosure.

FIG. 1B illustrates a flowchart of a first signaling and a first information block set according to one embodiment of the present disclosure.

FIG. 1C illustrates a flowchart of a first target QoS parameter group, a first information set, a second information set and a third information set according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4A illustrates a schematic diagram of a first communication device and a second communication device according to one embodiment of the present disclosure.

FIG. 4B illustrates a schematic diagram of a first node and a second node according to one embodiment of the present disclosure.

FIG. 5A illustrates a flowchart of radio signal transmission according to one embodiment of the present disclosure.

FIG. 5B illustrates a flowchart of radio signal transmission according to one embodiment of the present disclosure.

FIG. 5C illustrates a schematic diagram of a second node and a third node according to one embodiment of the present disclosure.

FIG. 6A illustrates a flowchart of radio signal transmission according to one embodiment of the present disclosure.

FIG. 6B illustrates a flowchart of radio signal transmission according to another embodiment of the present disclosure.

FIG. 6C illustrates a flowchart of radio signal transmission according to one embodiment of the present disclosure.

FIG. 7A illustrates a schematic diagram of relations among a first candidate sub-channel, a second candidate sub-channel and a first resource pool according to one embodiment of the present disclosure.

FIG. 7B illustrates a schematic diagram of a second target value according to one embodiment of the present disclosure.

FIG. 7C illustrates a schematic diagram of a first radio bearer, a second radio bearer, a first QoS parameter group, a second QoS parameter group and a first target QoS parameter group according to one embodiment of the present disclosure.

FIG. 8A illustrates a schematic diagram of relations among a first sub-channel, a first signaling, a first candidate sub-channel, a second candidate sub-channel and a target sub-channel group according to one embodiment of the present disclosure.

FIG. 8B illustrates a schematic diagram of first-type signaling and second-type signaling according to one embodiment of the present disclosure.

FIG. 8C illustrates a schematic diagram of a first QoS set, a second QoS set and a second QoS parameter group according to one embodiment of the present disclosure.

FIG. 9A illustrates a schematic diagram of relations among a first sub-channel, a first signaling, a first candidate sub-channel, a second candidate sub-channel and a target sub-channel group according to one embodiment of the present disclosure.

FIG. 9B illustrates a schematic diagram of a first information block set according to one embodiment of the present disclosure.

FIG. 9C illustrates a structure block diagram of a processing device in a first node according to one embodiment of the present disclosure.

FIG. 10A illustrates a schematic diagram of relations among a first sub-channel, a first signaling, a first candidate sub-channel, a second candidate sub-channel and a target sub-channel group according to one embodiment of the present disclosure.

FIG. 10B illustrates a schematic diagram of a HARQ-ACK associated with a first signaling according to one embodiment of the present disclosure.

FIG. 10C illustrates a structure block diagram of a processing device in a second node according to one embodiment of the present disclosure.

FIG. 11A illustrates a schematic diagram of relations among a first signaling, a first signal and a target sub-channel group according to one embodiment of the present disclosure.

FIG. 11B illustrates a schematic diagram of a HARQ-ACK associated with a first signaling according to another embodiment of the present disclosure.

FIG. 12A illustrates a structure block diagram of a processing device used in a first node according to one embodiment of the present disclosure.

FIG. 12B illustrates a structure block diagram of a processing device in a first node according to one embodiment of the present disclosure.

FIG. 13A illustrates a structure block diagram of a processing device used in a second node according to one embodiment of the present disclosure.

FIG. 13B illustrates a structure block diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1A

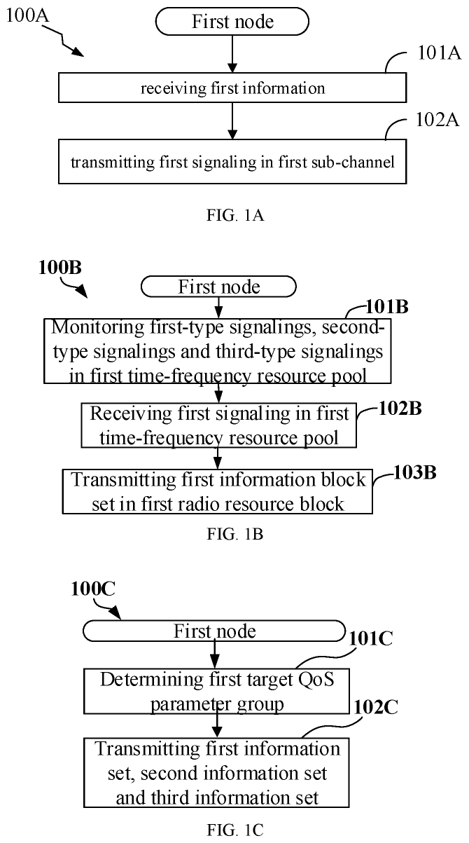

Embodiment 1A illustrates a flowchart of processing of a first node according to one embodiment of the present disclosure, as shown in 1A. In FIG. 1A, each box represents a step.

In Embodiment 1A, a first node in the present disclosure first executes step 101A, receiving first information; and executes step 102A, transmitting a first signaling in a first sub-channel; the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the first resource pool is used for SL Communication.

In one embodiment, the first resource pool is used for SL Transmission.

In one embodiment, the first resource pool is used for SL Reception.

In one embodiment, the first resource pool comprises time-frequency resources used for SL Communication.

In one embodiment, the first resource pool comprises time-frequency resources used for SL Transmission.

In one embodiment, the first resource pool comprises time-frequency resources used for SL Reception.

In one embodiment, the first resource pool comprises Q frequency-domain resource blocks, Q being a positive integer greater than 1.

In one embodiment, the first resource pool comprises multiple Subcarriers.

In one embodiment, any of the Q frequency-domain resource blocks comprises a positive integer number of Physical Resource Block(s) (PRB(s)).

In one embodiment, any of the Q frequency-domain resource blocks comprises a positive integer number of PRB(s).

In one embodiment, any of the Q frequency-domain resource blocks is a PRB.

In one embodiment, the Q frequency-domain resource blocks are Q PRBs, respectively.

In one embodiment, any of the Q frequency-domain resource blocks comprises a positive integer number of subcarrier(s).

In one embodiment, any of the Q frequency-domain resource blocks comprises 12 consecutive subcarriers.

In one embodiment, the Q is 52.

In one embodiment, the Q is 78.

In one embodiment, the Q is 160.

In one embodiment, the first resource pool comprises L sub-channels in frequency domain, L being a positive integer greater than 1.

In one embodiment, the L is a positive integer greater than 1.

In one embodiment, the L is one of positive integers from 2 to 27.

In one embodiment, the L is one of positive integers from 2 to 28.

In one embodiment, any of the L sub-channels comprises M consecutive frequency-domain resource blocks in frequency domain, M being a positive integer greater than 1.

In one embodiment, the M consecutive frequency-domain resource blocks comprised by any of the L sub-channels in frequency domain belong to the first resource pool.

In one embodiment, the M consecutive frequency-domain resource blocks comprised by any of the L sub-channels in frequency domain belong to the Q frequency-domain resource blocks comprised in the first resource pool, M being no greater than the Q.

In one embodiment, any of the M consecutive frequency-domain resource blocks comprised by any of the L sub-channels in frequency domain belongs to one of the Q frequency-domain resource blocks comprised in the first resource pool.

In one embodiment, any of the M consecutive frequency-domain resource blocks comprised by any of the L sub-channels in frequency domain comprises a positive integer number of PRB(s).

In one embodiment, any of the M consecutive frequency-domain resource blocks comprised by any of the L sub-channels in frequency domain comprises one PRB.

In one embodiment, any of the M consecutive frequency-domain resource blocks comprised by any of the L sub-channels in frequency domain comprises a positive integer number of subcarrier(s).

In one embodiment, the M is the size of any one of the L sub-channels.

In one embodiment, the M is one of positive integers 10, 12, 15, 20, 25, 50, 75, and 100.

In one embodiment, the M is equal to 12.

In one embodiment, the M is equal to 20.

In one embodiment, at least two of the L sub-channels are orthogonal in frequency domain.

In one embodiment, at least two of the L sub-channels are overlapping in frequency domain.

In one embodiment, only two of the L sub-channels are overlapping in frequency domain.

In one embodiment, of the L sub-channels there are only 2 being overlapping in frequency domain, while the other L-2 sub-channels are orthogonal in frequency domain.

In one embodiment, of the L sub-channels only the first candidate sub-channel and the second candidate sub-channel are overlapping in frequency domain.

In one embodiment, sub-channels of the L sub-channels other than the first candidate sub-channel and the second candidate sub-channel are orthogonal in frequency domain.

In one embodiment, sub-channels of the L sub-channels other than the second candidate sub-channel are orthogonal in frequency domain.

In one embodiment, sub-channels of the L sub-channels other than the first candidate sub-channel are orthogonal in frequency domain.

In one embodiment, the first resource pool comprises a positive integer number of slot(s) in time domain.

In one embodiment, the first resource pool comprises a positive integer number of multicarrier symbol(s) in time domain.

In one embodiment, the first resource pool comprises multiple Resource Elements (REs).

In one embodiment, any one of the multiple REs comprised in the first resource pool occupies a multicarrier symbol in time domain, and occupies a subcarrier in frequency domain.

In one embodiment, an RE occupies a multicarrier symbol in time domain, and a subcarrier in frequency domain.

In one embodiment, the multicarrier symbol is a Single-Carrier Frequency Division Multiple Access (SC-FDMA) symbol.

In one embodiment, any of the positive integer number of multicarrier symbol(s) is an SC-FDMA symbol.

In one embodiment, the multicarrier symbol is a Discrete Fourier Transform Spread Orthogonal Frequency Division Multiplexing (DFT-S-OFDM) symbol.

In one embodiment, any of the positive integer number of multicarrier symbol(s) is a DFT-S-OFDM symbol.

In one embodiment, the multicarrier symbol is a Frequency Division Multiple Access (FDMA) symbol.

In one embodiment, any of the positive integer number of multicarrier symbol(s) is an FDMA symbol.

In one embodiment, the multicarrier symbol is a Filter Bank Multi-Carrier (FBMC) symbol.

In one embodiment, any of the positive integer number of multicarrier symbol(s) is an FBMC symbol.

In one embodiment, the multicarrier symbol is an Interleaved Frequency Division Multiple Access (IFDMA) symbol.

In one embodiment, any of the positive integer number of multicarrier symbol(s) is an IFDMA symbol.

In one embodiment, the first resource pool comprises multiple time-frequency resource blocks, and the multiple time-frequency resource blocks comprised by the first resource pool comprise multiple REs.

In one embodiment, the first resource pool comprises multiple time-frequency resource blocks, and any of the multiple time-frequency resource blocks comprised by the first resource pool occupies a positive integer number of multicarrier symbol(s) in time domain, and occupies a positive integer number of subcarrier(s) in frequency domain.

In one embodiment, the Q and the M are jointly used for determining the L.

In one embodiment, a value obtained by rounding a quotient of the Q and the M up to a nearest integer is the L.

In one embodiment, a value obtained by rounding a quotient of the Q and the M down to a nearest integer is the L-1.

In one embodiment, the first resource pool comprises a Physical Sidelink Control Channel (PSCCH).

In one embodiment, the first resource pool comprises a Physical Sidelink Shared Channel (PSSCH).

In one embodiment, the first resource pool comprises a Physical Sidelink Feedback Channel (PSFCH).

In one embodiment, the first resource pool comprises a Physical Uplink Control Channel (PUCCH).

In one embodiment, the first resource pool comprises a Physical Uplink Shared Channel (PUSCH).

In one embodiment, the first resource pool is used for transmitting Sidelink Control Information (SCI).

In one embodiment, the first resource pool is used for transmitting a Sidelink Reference Signal (SL RS).

In one embodiment, the first resource pool is used for transmitting a Sidelink Phase-Tracking Reference Signal (SL PTRS).

In one embodiment, the first resource pool is used for transmitting a Sidelink Channel State Information Reference Signal (SL CSIRS).

In one embodiment, the first resource pool is used for transmitting a Sidelink Demodulation Reference Signal (SL DMRS).

In one embodiment, the target sub-channel group comprises a positive integer number of sub-channel(s), and the positive integer number of sub-channel(s) comprised by the target sub-channel group belongs(belong) to the L sub-channels in the first resource pool.

In one embodiment, the target sub-channel group comprises a positive integer number of sub-channel(s), and any of the positive integer number of sub-channel(s) comprised by the target sub-channel group is a sub-channel of the L sub-channels in the first resource pool.

In one embodiment, either the first candidate sub-channel or the second candidate sub-channel belongs to the target sub-channel group.

In one embodiment, the target sub-channel group comprises one of the first candidate sub-channel and the second candidate sub-channel.

In one embodiment, the first candidate sub-channel is a sub-channel in the target sub-channel group, and the second candidate sub-channel is different from any of the positive integer number of sub-channel(s) comprised by the target sub-channel group.

In one embodiment, the second candidate sub-channel is a sub-channel in the target sub-channel group, and the first candidate sub-channel is different from any of the positive integer number of sub-channel(s) comprised by the target sub-channel group.

In one embodiment, the target sub-channel group is used for transmitting a first signal.

In one embodiment, the target sub-channel group is at least used for transmitting the latter of the first signaling and the first signal.

In one embodiment, the target sub-channel group is used for transmitting the first signaling and the first signal.

In one embodiment, the target sub-channel group is used for transmitting the first signal, and the target sub-channel group is not used for transmitting the first signaling.

In one embodiment, the target sub-channel group comprises a PSCCH.

In one embodiment, the target sub-channel group comprises a PSSCH.

In one embodiment, the target sub-channel group at least comprises the latter of a PSCCH and a PSSCH.

In one embodiment, the target sub-channel group comprises a PSCCH and a PSSCH.

In one embodiment, the target sub-channel group comprises a PSSCH, and the target sub-channel group does not comprise a PSCCH.

In one embodiment, the first sub-channel is one of the L sub-channels in the first resource pool.

In one embodiment, the first sub-channel comprises M consecutive frequency-domain resource blocks in frequency domain, and any of the M consecutive frequency-domain resource blocks comprised by the first sub-channel belongs to the first resource pool in frequency domain.

In one embodiment, any of the M consecutive frequency-domain resource blocks comprised by the first sub-channel in frequency domain comprises a positive integer number of PRB(s).

In one embodiment, any of the M consecutive frequency-domain resource blocks comprised by the first sub-channel in frequency domain is a PRB.

In one embodiment, any of the M consecutive frequency-domain resource blocks comprised by the first sub-channel in frequency domain is a positive integer number of subcarrier(s).

In one embodiment, the first sub-channel comprises a PSCCH.

In one embodiment, the first sub-channel comprises a PSSCH.

In one embodiment, the first sub-channel comprises a PSFCH.

In one embodiment, the first sub-channel is used for transmitting the first signaling.

In one embodiment, the first sub-channel is used for transmitting a PSCCH DMRS.

In one embodiment, the first sub-channel is used for transmitting a PSSCH DMRS.

In one embodiment, the first sub-channel is used for transmitting a 1st-stage SCI format.

In one embodiment, the first sub-channel is used for transmitting a 2nd-stage SCI format.

In one embodiment, the first sub-channel belongs to the target sub-channel group.

In one embodiment, the target sub-channel group comprises the first sub-channel.

In one embodiment, the first sub-channel is one of the positive integer number of sub-channel(s) comprised by the target sub-channel group.

In one embodiment, the first sub-channel is different from any of the positive integer number of sub-channel(s) comprised by the target sub-channel group.

In one embodiment, the first signaling comprises all or part of a higher layer signaling.

In one embodiment, the first signaling comprises all or part of a Radio Resource Control (RRC) layer signaling.

In one embodiment, the first signaling comprises one or more fields of an RRC Information Element (IE).

In one embodiment, the first signaling comprises all or part of a Multimedia Access Control (MAC) layer signaling.

In one embodiment, the first signaling comprises one or more fields of a MAC Control Element (CE).

In one embodiment, the first signaling comprises one or more fields of a Physical Layer (PHY) signaling.

In one embodiment, the first signaling comprises a piece of Sidelink Control Information (SCI).

In one embodiment, the first signaling comprises a field of a piece of SCI.

In one embodiment, the first signaling comprises a 1st-stage SCI format.

In one embodiment, for the definition of the 1st-stage SCI format, refer to 3GPP TS38.212, section 8.3.1.

In one embodiment, the first signaling comprises a SCI format 0-1.

In one embodiment, for the definition of the SCI format 0-1, refer to 3GPP TS38.212, section 8.3.1.1.

In one embodiment, the first signaling is used to indicate the target sub-channel group.

In one embodiment, the first signaling is used to indicate the positive integer number of sub-channel(s) comprised by the target sub-channel group.

In one embodiment, the first signaling is used to indicate a quantity of the positive integer number of sub-channel(s) comprised by the target sub-channel group.

In one embodiment, the first signaling is used to indicate index(es) of the positive integer number of sub-channel(s) comprised by the target sub-channel group among the L sub-channels comprised by the first resource pool.

In one embodiment, the first signaling is used to indicate an index of any sub-channel of the positive integer number of sub-channel(s) comprised by the target sub-channel group among the L sub-channels comprised by the first resource pool.

In one embodiment, the first signaling is used to indicate an index of a sub-channel which is the lowest one in frequency domain among the positive integer number of sub-channels comprised by the target sub-channel group among the L sub-channels comprised by the first resource pool.

In one embodiment, the first signaling is used to indicate an index of a sub-channel which is the lowest one in frequency domain among the positive integer number of sub-channels comprised by the target sub-channel group among the L sub-channels comprised by the first resource pool and a quantity of the positive integer number of sub-channels comprised by the target sub-channel group.

In one embodiment, the first signaling is used to schedule the first signal.

In one embodiment, the first signaling is used to indicate a time-frequency resource occupied by the first signal.

In one embodiment, the first signaling is used to indicate a time-domain resource occupied by the first signal.

In one embodiment, the first signaling is used to indicate a frequency-domain resource occupied by the first signal.

In one embodiment, the frequency-domain resource occupied by the first signal indicated by the first signaling comprises the target sub-channel group.

In one embodiment, the frequency-domain resource occupied by the first signal indicated by the first signaling belongs to the target sub-channel group.

In one embodiment, the first signaling is used to indicate a priority of the first signal.

In one embodiment, the first signaling is transmitted on a PC5 interface.

In one embodiment, a channel occupied by the first signaling includes a PSCCH.

In one embodiment, the first information is used to indicate configuration information of the first resource pool.

In one embodiment, the first information indicates time-frequency resources occupied by the first resource pool.

In one embodiment, the first information indicates time-domain resources occupied by the first resource pool.

In one embodiment, the first information indicates frequency-domain resources occupied by the first resource pool.

In one embodiment, the first information indicates a quantity of sub-channels comprised by the first resource pool.

In one embodiment, the first information indicates the L.

In one embodiment, the first information indicates an initial position of the first resource pool.

In one embodiment, the first information indicates a first frequency-domain resource block of the Q frequency-domain resource blocks comprised by the first resource pool.

In one embodiment, the first information indicates a frequency-domain resource block which is the lowest one in frequency domain among the Q frequency-domain resource blocks comprised by the first resource pool.

In one embodiment, the first information indicates a frequency-domain resource block corresponding to a lowest frequency-domain resource block index among the M consecutive frequency-domain resource blocks comprised by a sub-channel corresponding to a lowest index in the first resource pool.

In one embodiment, the first information indicates a quantity of frequency-domain resources comprised in any one of the L sub-channels comprised by the first resource pool.

In one embodiment, the first information indicates the M.

In one embodiment, the first information comprises all or part of a higher layer signaling.

In one embodiment, the first information comprises all or part of an RRC layer signaling.

In one embodiment, the first information comprises one or more fields of an RRC IE.

In one embodiment, the first information is transmitted on a Uu interface.

In one embodiment, the first information comprises a SIB12.

In one embodiment, for the definition of the SIB12, refer to 3GPP TS38.331, section 6.3.1.

In one embodiment, the first information comprises SL-BWP-PoolConfig.

In one embodiment, the first information comprises SL-BWP-PoolConfigCommon.

In one embodiment, for the definition of the SL-BWP-PoolConfig, refer to 3GPP TS38.331, section 6.3.5.

In one embodiment, for the definition of the SL-BWP-PoolConfigCommon, refer to 3GPP TS38.331, section 6.3.5.

In one embodiment, the first information comprises an SL-ResourcePool.

In one embodiment, for the definition of the SL-ResourcePool, refer to 3GPP TS38.331, section 6.3.5.

In one embodiment, the first information comprises a PC5-RRC signaling.

In one embodiment, the first information comprises one or more fields of a PC5-RRC signaling.

In one embodiment, the first information comprises all or part of a MAC layer signal.

In one embodiment, the first information comprises a MAC CE.

In one embodiment, the first information comprises one or more fields of a MAC CE.

In one embodiment, the first information comprises one or more fields of a PHY layer signaling.

In one embodiment, a channel occupied by the first information includes a Physical Downlink Control Channel (PDCCH).

In one embodiment, a channel occupied by the first information includes a Physical Downlink Shared Channel (PDSCH).

### Embodiment 1B

Embodiment 1B illustrates a flowchart of a first signaling and a first information block set according to one embodiment of the present disclosure, as shown in FIG. 1B. In FIG. 1B, each box represents a step. It should be particularly noted that the sequence of boxes arranged herein does not imply a chronological order of steps respectively represented.

In Embodiment 1B, the first node in the present disclosure monitors first-type signalings, second-type signalings and third-type signalings in a first time-frequency resource pool in step 101B; receives a first signaling in the first time-frequency resource pool in step 102B; and transmits a first information block set in a first radio resource block in step 103B; herein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one embodiment, the first time-frequency resource pool comprises a positive integer number of Resource Element(s) (RE(s)).

In one embodiment, an RE occupies a multicarrier symbol in time domain and a subcarrier in frequency domain.

In one embodiment, the multicarrier symbol is an Orthogonal Frequency Division Multiplexing (OFDM) symbol.

In one embodiment, the multicarrier symbol is an SC-FDMA symbol.

In one embodiment, the multicarrier symbol is a DFT-S-OFDM symbol.

In one embodiment, the first time-frequency resource pool comprises a positive integer number of search space(s) in a positive integer number of serving cell(s).

In one embodiment, the first time-frequency resource pool comprises a positive integer number of search space(s).

In one embodiment, the first time-frequency resource pool comprises a positive integer number of PDCCH Candidate(s).

In one embodiment, the first time-frequency resource pool belongs to a positive integer number of Serving Cell(s) in frequency domain.

In one embodiment, the first time-frequency resource pool belongs to a positive integer number of Carrier(s) in frequency domain.

In one embodiment, the first time-frequency resource pool belongs to a positive integer number of Band Width Part(s) (BWP(s)) in frequency domain.

In one embodiment, the first time-frequency resource pool comprises a positive integer number of subcarrier(s) in frequency domain.

In one embodiment, the first time-frequency resource pool comprises a positive integer number of RB(s) in frequency domain.

In one embodiment, the first time-frequency resource pool comprises a positive integer number of Monitoring Occasion(s) in time domain.

In one embodiment, the first time-frequency resource pool comprises a positive integer number of serving cell-monitoring occasion pair(s).

In one embodiment, the first radio resource block belongs to a time unit in time domain, and the time unit to which the first radio resource block belongs is used to determine the first time-frequency resource pool.

In one embodiment, a HARQ-ACK associated with a signaling received on a time-frequency resource outside the first time-frequency resource pool does not get feedback in a time unit to which the first radio resource block belongs in time domain.

In one embodiment, a time-frequency resource occupied by a signaling associated with any HARQ-ACK which gets feedback in a time unit to which the first radio resource block belongs in time domain belongs to the first time-frequency resource pool.

In one embodiment, a time-frequency resource occupied by a signaling associated with any information block in the first information set belongs to the first time-frequency resource pool.

In one embodiment, the time unit comprises a positive integer number of multicarrier symbol(s).

In one embodiment, the time unit comprises a slot.

In one embodiment, the time unit comprises a subframe.

In one embodiment, the Monitoring Occasion refers to a monitoring occasion for a downlink physical layer control channel.

In one embodiment, the downlink physical layer control channel is a PDCCH.

In one embodiment, the downlink physical layer control channel is a short PDCCH (sPDCCH).

In one embodiment, the downlink physical layer control channel is a Narrow Band PDCCH (NB-PDCCH).

In one embodiment, the Monitoring Occasion refers to a monitoring occasion for a PDCCH.

In one embodiment, for the specific meaning of the Monitoring Occasion, refer to 3GPP TS38.213, section 9.1.

In one embodiment, the first time-frequency resource pool comprises a positive integer number of time unit(s) in time domain.

In one embodiment, the first time-frequency resource pool comprises a positive integer number of multicarrier symbol(s) in time domain.

In one embodiment, the first time-frequency resource pool is configured by a higher layer signaling.

In one embodiment, the first time-frequency resource pool is configured by an RRC signaling.

In one embodiment, the first time-frequency resource pool is preconfigured.

In one embodiment, the first time-frequency resource pool comprises a first resource set, a second resource set and a third resource set, and the first node monitors the first-type signalings, the second-type signalings and the third-type signalings respectively in the first resource set, the second resource set and the third resource set.

In one subembodiment, a time unit to which the first radio resource block belongs in time domain is used to determine the first resource set, the second resource set and the third resource set.

In one subembodiment, a first given information block is any information block in the first information block set associated with the first-type signalings, and time-frequency resources occupied by the first-type signalings associated with the first given information block belong to the first resource set.

In one subembodiment, the first signaling is one of the first-type signalings, a second given information block is any information block in the first information block set associated with the second-type signalings, and time-frequency resources occupied by the second-type signalings associated with the second given information block belong to the second resource set.

In one subembodiment, the first signaling is one of the third-type signalings, a second given information block is any information block in the second information block subset of the present disclosure associated with the second-type signalings, and time-frequency resources occupied by the second-type signalings associated with the second given information block belong to the second resource set.

In one subembodiment, a third given information block is any information block in the first information block set associated with the third-type signalings, and time-frequency resources occupied by the third-type signalings associated with the third given information block belong to the third resource set.

In one subembodiment, any two sets of the first resource set, the second resource set and the third resource set are the same.

In one subembodiment, any two sets of the first resource set, the second resource set and the third resource set are different.

In one subembodiment, any two sets of the first resource set, the second resource set and the third resource set are orthogonal.

In one subembodiment, any two sets of the first resource set, the second resource set and the third resource set are non-orthogonal.

In one subembodiment, at least two sets of the first resource set, the second resource set and the third resource set are non-orthogonal.

In one subembodiment, at least two sets of first resource set, the second resource set and the third resource set are orthogonal.

In one embodiment, the first node detects only one type of signalings among the first-type signalings and the third-type signalings in the first time-frequency resource pool.

In one embodiment, the monitoring refers to receiving based on energy detection, namely, sensing energy of radio signals and averaging to acquire a received energy. If the received energy is larger than a second given threshold, it is determined that a signaling is received; otherwise, it is determined that no signaling is received.

In one embodiment, the monitoring refers to coherent reception, namely, performing coherent reception and measuring energy of signals obtained by the coherent reception. If the energy of the signals obtained by the coherent reception is larger than a first given threshold, it is determined that a signaling is received; otherwise, it is determined that no signaling is received.

In one embodiment, the monitoring refers to blind decoding, namely, receiving a signal and performing decoding operation. If it is determined that the decoding is correct according to a Cyclic Redundancy Check (CRC) bit, it is determined that a signaling is received; otherwise, it is determined that no signaling is received.

In one embodiment, the phrase of monitoring first-type signalings, second-type signalings and third-type signalings in a first time-frequency resource pool includes: the first node determines respectively according to CRC whether the first-type signalings, the second-type signalings and the third-type signalings are transmitted in the first time-frequency resource pool.

In one embodiment, the phrase of monitoring first-type signalings, second-type signalings and third-type signalings in a first time-frequency resource pool includes: the first node determines whether the first-type signalings, the second-type signalings and the third-type signalings are transmitted by respectively performing blind decoding in the first time-frequency resource pool.

In one embodiment, the first-type signaling is dynamically configured.

In one embodiment, the first-type signaling is a physical layer signaling.

In one embodiment, the first-type signaling is a Downlink Control Information (DCI) signaling.

In one embodiment, the first-type signaling is transmitted on a downlink physical layer control channel (i.e., a downlink channel that can only be used for bearing physical layer signalings).

In one embodiment, the first-type signaling includes a signaling used for indicating Semi-Persistent Scheduling (SPS) Release.

In one embodiment, the first-type signaling includes a signaling used for scheduling a downlink physical layer data channel.

In one embodiment, the first-type signaling includes a signaling used for scheduling a Physical Downlink Shared Channel (PDSCH).

In one embodiment, the downlink physical layer data channel is a PDSCH.

In one embodiment, the downlink physical layer data channel is a short PDSCH (sPDSCH).

In one embodiment, the downlink physical layer data channel is a Narrow Band PDSCH (NB-PDSCH).

In one embodiment, the third-type signaling is dynamically configured.

In one embodiment, the third-type signaling is a physical layer signaling.

In one embodiment, the third-type signaling is a DCI signaling.

In one embodiment, the third-type signaling is transmitted on a downlink physical layer control channel.

In one embodiment, the third-type signaling includes a signaling used for indicating SPS Release.

In one embodiment, the third-type signaling includes a signaling used for scheduling a downlink physical layer data channel.

In one embodiment, the third-type signaling includes a signaling used for scheduling a PDSCH.

In one embodiment, the second-type signaling is a higher layer signaling.

In one embodiment, the second-type signaling is a RRC signaling.

In one embodiment, the second-type signaling is a MAC CE signaling.

In one embodiment, the second-type signaling is dynamically configured.

In one embodiment, the second-type signaling is a physical layer signaling.

In one embodiment, the second-type signaling is a DCI signaling.

In one embodiment, the second-type signaling is transmitted on a downlink physical layer control channel.

In one embodiment, the second-type signaling includes a signaling used for indicating SPS Release.

In one embodiment, the second-type signaling includes a signaling used for scheduling a downlink physical layer data channel.

In one embodiment, the second-type signaling includes a signaling used for scheduling a PDSCH.

In one embodiment, the second-type signaling includes a signaling used for scheduling a SideLink (SL).

In one embodiment, the second-type signaling includes a signaling used for scheduling a Physical Sidelink Shared CHannel (PSSCH).

In one embodiment, any two of the first-type signaling, the second-type signaling and the third-type signaling are mutually different.

In one embodiment, the third-type signaling and the first-type signaling are of a same format.

In one embodiment, a priority corresponding to the third-type signaling is different from a priority corresponding to the first-type signaling.

In one embodiment, a priority indicated by the third-type signaling is different from a priority indicated by the first-type signaling.

In one embodiment, the first-type signaling and the third-type signaling are used for scheduling a DL, while the second-type signaling is used for scheduling a non-DL.

In one embodiment, the first-type signaling and the third-type signaling are used for scheduling a DL, while the second-type signaling is used for scheduling a SL.

In one embodiment, a format of the third-type signaling is different from that of the first-type signaling.

In one embodiment, a format of the third-type signaling and a format of the first-type signaling belong to a first format set, while a format of the second-type signaling belongs to a second format set, any format in the first format set does not belong to the second format set; the first format set comprises a positive integer number of format(s), and the second format set comprises a positive integer number of format(s).

In one subembodiment, the first format set comprises a format of DL DCI.

In one subembodiment, the second format set comprises a format of non-DL DCI.

In one subembodiment, the second format set comprises a format of SL DCI.

In one subembodiment, the second format set comprises a format of DL DCI.

In one embodiment, the format of DL DCI includes at least one of DCI Format 1_0, DCI Format 1_1 or DCI Format 1_2.

In one embodiment, the format of SL DCI includes at least one of DCI Format 3_0 or DCI Format 3_1.

In one embodiment, specific definitions of the DCI Format 1_0, the DCI Format 1_1, the DCI Format 1_2, the DCI Format 3_0 or the DCI Format 3_1 can be found in 3GPP TS38.212, section 7.3.1.

In one embodiment, the first-type signaling is transmitted via a Radio Interface between a UE and a base station.

In one embodiment, the second-type signaling is transmitted via a Radio Interface between a UE and a base station.

In one embodiment, the third-type signaling is transmitted via a Radio Interface between a UE and a base station.

In one embodiment, the first-type signaling is transmitted via a Uu Interface.

In one embodiment, the second-type signaling is transmitted via a Uu Interface.

In one embodiment, the third-type signaling is transmitted via a Uu Interface.

In one embodiment, an information block in the first information block set comprises a HARQ-ACK associated with the first signaling.

In one embodiment, a first information block comprises a HARQ-ACK associated with the first signaling, the first information block being an information block in the first information block set.

In one embodiment, the first information block set comprises a positive integer number of information block(s).

In one embodiment, any information block in the first information block set comprises a HARQ-ACK.

In one embodiment, the first information block set comprises Uplink Control Information (UCI).

In one embodiment, when the first signaling is the first-type signaling, a signaling associated with any information block in the first information block set is either the first-type signaling or the second-type signaling.

In one embodiment, when the first signaling is the first-type signaling, a signaling associated with any information block in the first information block set is one of the first-type signaling, the second-type signaling or the third-type signaling.

In one embodiment, when the first signaling is the third-type signaling, a signaling associated with any information block in the first information block set is the third-type signaling.

In one embodiment, when the first signaling is the third-type signaling, a signaling associated with any information block in the first information block set is either the first-type signaling or the third-type signaling.

In one embodiment, the first target value is used to determine a number of information blocks comprised in the first information block set.

In one embodiment, when the first signaling is the first-type signaling, the number of information blocks comprised in the first information block set is equal to a sum of a number of the first-type signalings transmitted in the first time-frequency resource pool and a number of the second-type signalings transmitted in the first time-frequency resource pool.

In one embodiment, when the first signaling is the third-type signaling, the number of information blocks comprised in the first information block set is equal to a number of the third-type signalings transmitted in the first time-frequency resource pool.

In one embodiment, the first field comprises a positive integer number of bit(s).

In one embodiment, a value of the first field is a non-negative integer.

In one embodiment, the first field comprises a Downlink assignment index field.

In one embodiment, the first field indicates at least one of a total Downlink Assignment Index (DAI) or a counter DAI.

In one embodiment, the specific definition of the Downlink assignment index field can be found in 3GPP TS38.212, section 7.3.1.2.

In one embodiment, the specific definition of the total DAI can be found in 3GPP TS38.213, section 9.1.

In one embodiment, the specific definition of the counter DAI can be found in 3GPP TS38.213, section 9.1.

In one embodiment, the first field indicates a total DAI, and the first target value is the total DAI.

In one embodiment, the first field indicates a total DAI and a counter DAI, and the first target value is the total DAI.

In one embodiment, the first field indicates a counter DAI, and the first target value is the counter DAI.

In one embodiment, the first target value is a total DAI.

In one embodiment, the first target value is a counter DAI.

In one embodiment, the first field comprised in the first-type signaling indicates a DAI of the first-type signaling and a DAI of the second-type signaling, and the first field comprised in the third-type signaling indicates a DAI of the third-type signaling.

In one embodiment, the second-type signaling comprises a first field, and the first field comprised in the second-type signaling indicates a DAI of the second-type signaling.

In one embodiment, the number of the first-type signalings transmitted in the first time-frequency resource pool is a non-negative integer, the number of the second-type signalings transmitted in the first time-frequency resource pool is a non-negative integer, and the number of the third-type signalings transmitted in the first time-frequency resource pool is a non-negative integer.

In one embodiment, the number of the first-type signalings transmitted in the first time-frequency resource pool is a total number of serving cell-monitoring occasion pairs for transmitting the first-type signalings in the first time-frequency resource pool.

In one embodiment, the number of the second-type signalings transmitted in the first time-frequency resource pool is a total number of serving cell-monitoring occasion pairs for transmitting the second-type signalings in the first time-frequency resource pool.

In one embodiment, the number of the third-type signalings transmitted in the first time-frequency resource pool is a total number of serving cell-monitoring occasion pairs for transmitting the third-type signalings in the first time-frequency resource pool.

In one embodiment, according to a first rule, the number of the first-type signalings transmitted in the first time-frequency resource pool is a total number of serving cell-monitoring occasion pairs for transmitting the first-type signalings that have been accumulated in a first time window by a monitoring occasion to which the first signaling belongs.

In one embodiment, according to a first rule, the number of the second-type signalings transmitted in the first time-frequency resource pool is a total number of serving cell-monitoring occasion pairs for transmitting the second-type signalings that have been accumulated in a first time window by a monitoring occasion to which the first signaling belongs.

In one embodiment, according to a first rule, the number of the third-type signalings transmitted in the first time-frequency resource pool is a total number of serving cell-monitoring occasion pairs for transmitting the third-type signalings that have been accumulated in a first time window by a monitoring occasion to which the first signaling belongs.

In one embodiment, the first rule includes firstly increasing indexes of serving cells and secondly increasing indexes of monitoring occasions.

In one embodiment, the first rule includes frequency domain first and time domain second.

In one embodiment, the first time window comprises time-domain resources occupied by the first time-frequency resource pool.

In one embodiment, the HARQ-ACK associated with the first signaling indicates whether a bit block set scheduled by the first signaling is correctly received.

In one embodiment, the first signaling comprises a signaling used for scheduling a downlink physical layer data channel, and the HARQ-ACK associated with the first signaling indicates whether a transmission of the downlink physical layer data channel scheduled by the first signaling is correctly received.

In one embodiment, the first signaling comprises a signaling used for scheduling a PDSCH, and the HARQ-ACK associated with the first signaling indicates whether a transmission of the PDSCH scheduled by the first signaling is correctly received.

In one embodiment, the HARQ-ACK associated with the first signaling indicates whether the first signaling is correctly received.

In one embodiment, the first signaling comprises a signaling used for indicating SPS Release, and the HARQ-ACK associated with the first signaling indicates whether the first signaling is correctly received.

In one embodiment, the first radio resource block comprises a time-domain resource, a frequency-domain resource and a code-domain resource.

In one embodiment, the first radio resource block comprises a time-domain resource and a frequency-domain resource.

In one embodiment, the first radio resource block comprises a positive integer number of RE(s).

In one embodiment, the first radio resource block comprises a positive integer number of subcarrier(s) in frequency domain.

In one embodiment, the first radio resource block comprises a positive integer number of RB(s) in frequency domain.

In one embodiment, the first radio resource block comprises a positive integer number of multicarrier symbol(s) in time domain.

In one embodiment, the first radio resource block belongs to a time unit in time domain.

In one embodiment, the first radio resource block is configured by a higher layer signaling.

In one embodiment, the first radio resource block is configured by an RRC signaling.

In one embodiment, the first radio resource block is configured by a MAC CE signaling.

In one embodiment, the first radio resource block is preconfigured.

In one embodiment, the first radio resource block comprises a PUCCH resource.

In one embodiment, the first radio resource block is reserved for a PUCCH.

In one embodiment, the first radio resource block is reserved for transmission of the first information block subset.

### Embodiment 1C

Embodiment 1C illustrates a flowchart of a first target QoS parameter group, a first information set, a second information set and a third information set according to one embodiment of the present disclosure, as shown in FIG. 1C.

In Embodiment 1C, a first node 100C in the present disclosure determines a first target QoS parameter group in step 101C; and transmits a first information set, a second information set and a third information set in step 102C; herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the first node determines the first target QoS parameter group according to a traffic to which the first packet belongs.

In one embodiment, the first node determines the first target QoS parameter group according to a QoS flow to which the first packet belongs.

In one embodiment, the first node determines the first target QoS parameter group according to a PC5 QoS flow to which the first packet belongs.

In one embodiment, the first target QoS parameter group is determined on a V2X layer of the first node.

In one embodiment, the first target QoS parameter group is transmitted from a V2X layer of the first node to an RRC layer of the first node.

In one embodiment, the first node receives RRC configuration information transmitted by a serving base station of the first node, the RRC configuration information comprising the first target QoS parameter group.

In one embodiment, the first target QoS parameter group comprises at least one parameter among a PQI, a PC5 Flow bit rate, a PC5 Link Aggregated Bit Rate or a Range.

In one embodiment, a receiver of the first information set is a serving base station of the first node.

In one embodiment, the first information set is transmitted from an RRC layer of the first node to a V2X layer of the first node.

In one embodiment, the first information set is transmitted via a Uu interface.

In one embodiment, the first information set is transmitted through Uplink.

In one embodiment, the first information set is higher layer information.

In one embodiment, the first information set is RRC layer information.

In one embodiment, the first information set comprises all or part of Information Elements (IEs) in an RRC signaling.

In one embodiment, the first information set comprises an SL-TxResourceReq IE in an RRC signaling.

In one embodiment, the first information set comprises all or part of fields of an IE in an RRC signaling.

In one embodiment, the first information set comprises an sl-QoS-InfoList field in an RRC signaling.

In one embodiment, the first information set comprises an sl-QoS-Info field in an RRC signaling.

In one embodiment, the first information set comprises an sl-QoS-Profile field in an RRC signaling.

In one embodiment, the first information set is SidelinkUEInformationNR.

In one embodiment, as a response to the first information set, a serving base station of the first node transmits an RRCReconfiguration message, the RRCReconfiguration message comprising sl-ConfigDedicatedNR.

In one embodiment, a receiver of the first information set and a receiver of the second information set are non quasi co-located (non-QCL).

In one embodiment, a receiver of the first information set and a receiver of the second information set are two different communication nodes.

In one embodiment, a receiver of the second information set is the second node.

In one embodiment, the second information set is a response to the second signaling.

In one embodiment, the second information set is transmitted via a PC5 interface.

In one embodiment, the second information set is transmitted through Sidelink.

In one embodiment, the second information set is transmitted via unicast.

In one embodiment, the second information set is transmitted via groupcast.

In one embodiment, the second information set is higher layer information.

In one embodiment, the second information set is RRC layer information.

In one embodiment, the second information set is RRCReconfigurationSidelink.

In one embodiment, the second information set is RRCReconfigurationCompleteSidelink.

In one embodiment, the second information set comprises all or part of IEs in an RRC signaling.

In one embodiment, the second information set comprises RRCReconfigurationSidelink-IEs.

In one embodiment, the second information set comprises RRCReconfigurationCompleteSidelink-IEs.

In one embodiment, the second information set comprises an SL-RelayResourceReq IE in an RRC signaling.

In one embodiment, the second information set comprises all or part of fields of an IE in an RRC signaling.

In one embodiment, the second information set comprises an SL-SDAP-ConfigPC5 field in an RRC signaling.

In one embodiment, the second information set comprises an sl-QoS-InfoList field in an RRC signaling.

In one embodiment, the second information set comprises an sl-QoS-Info field in an RRC signaling.

In one embodiment, the second information set comprises an sl-QoS-Profile field in an RRC signaling.

In one embodiment, the second information set comprises an sl-MappedQoS-FlowsToAddList field in an RRC signaling.

In one embodiment, a version number can be comprised in the first information set, the second information set, the first signaling, an RRC signaling comprised in the second signaling, or an IE in an RRC signaling, or a field of an RRC signaling, for instance, the first information set is SidelinkUEInformationNR-r16.

In one embodiment, a receiver of the first information set and a receiver of the third information set are non-QCL.

In one embodiment, a receiver of the first information set and a receiver of the third information set are two different communication nodes.

In one embodiment, a receiver of the third information set is the second node.

In one embodiment, a receiver of the second information set and a receiver of the third information set are QCL.

In one embodiment, a receiver of the second information set and a receiver of the third information set are a same communication node.

In one embodiment, the third information set is transmitted after the second signaling.

In one embodiment, the third information set is transmitted via a PC5 interface.

In one embodiment, the third information set is transmitted through Sidelink.

In one embodiment, the third information set is transmitted via unicast.

In one embodiment, the third information set is transmitted via groupcast.

In one embodiment, the third information set is transmitted via broadcast.

In one embodiment, the third information set comprises third SCI and a third Media Access Control Protocol Data Unit (MAC PDU).

In one embodiment, the third SCI is transmitted through a Physical Sidelink Control Channel (PSCCH), and the third MAC PDU is transmitted through a Physical Sidelink Shared Channel (PSSCH).

In one embodiment, the third SCI indicates a time-frequency resource occupied by the third MAC PDU.

In one embodiment, the third SCI comprises a first part of the first identity.

In one embodiment, the third SCI comprises a first part of the third identity.

In one embodiment, the first part of the first identity comprised in the third SCI comprises 8 bits.

In one embodiment, the first part of the first identity comprised in the third SCI comprises least significant 8 bits of the first identity.

In one embodiment, the first part of the third identity comprised in the third SCI comprises 16 bits.

In one embodiment, the first part of the third identity comprised in the third SCI comprises lower 16 bits of the third identity.

In one embodiment, the third MAC PDU comprises a third SL-SCH subheader.

In one embodiment, the third SL-SCH subheader comprises a second part of the first identity.

In one embodiment, the third SL-SCH subheader comprises a second part of the third identity.

In one embodiment, the second part of the first identity comprised in the third SL-SCH subheader comprises 16 bits.

In one embodiment, the second part of the first identity comprised in the third SL-SCH subheader comprises higher 16 bits of the first identity.

In one embodiment, the second part of the third identity comprised in the third SL-SCH subheader comprises 8 bits.

In one embodiment, the second part of the third identity comprised in the third SL-SCH subheader comprises higher 8 bits of the third identity.

In one embodiment, the first part of the first identity comprised in the third SCI and the second part of the first identity comprised in the third SL-SCH subheader compose the first identity.

In one embodiment, the first part of the third identity comprised in the third SCI and the second part of the third identity comprised in the third SL-SCH subheader compose the third identity.

In one embodiment, the first identity comprises 24 bits.

In one embodiment, the first identity is a Link layer identifier.

In one embodiment, the first identity is a ProSe UE Identifier (ID).

In one embodiment, the first identity is a Source-Layer-2 identifier.

In one embodiment, the first identity indicates the first node.

In one embodiment, a number of bits comprised in the third identity is equal to a number of bits comprised in the first identity.

In one embodiment, a number of bits comprised in the third identity is a positive integral multiple of 8.

In one embodiment, the third identity comprises 24 bits.

In one embodiment, the third identity comprises 32 bits.

In one embodiment, the third identity is a Link layer identifier.

In one embodiment, the third identity is a virtual Link layer identifier.

In one embodiment, all or part of bits in the first identity and all or part of bits in the second identity are used to generate the third identity.

In one embodiment, all or part of bits in the first identity, all or part of bits in the second identity and the second QoS parameter group are used to generate the third identity.

In one embodiment, the third identity is a ProSe UE ID.

In one embodiment, the second identity is a ProSe Layer-2 Group ID.

In one embodiment, the third identity is a ProSe Relay UE ID.

In one embodiment, the third identity is a Destination-Layer-2 ID.

In one embodiment, the third identity indicates the second node.

In one embodiment, the third identity is associated with the second QoS parameter group.

In one embodiment, the third MAC PDU comprises a third MAC sub-Protocol Data Unit (subPDU).

In one embodiment, the third MAC subPDU comprises the first packet.

In one embodiment, the first packet is a MAC CE.

In one embodiment, the first packet is a MAC Service Data Unit (SDU).

In one embodiment, the first packet is a padding.

In one embodiment, the first packet is at least one of a MAC CE, a MAC SDU or a padding.

In one embodiment, a receiver of the fourth information set is a node other than the second node.

In one embodiment, a receiver of the fourth information set and a receiver of the first information set are different communication nodes.

In one embodiment, the fourth information set is transmitted via a PC5 interface.

In one embodiment, the fourth information set is transmitted through Sidelink.

In one embodiment, the fourth information set is transmitted via unicast.

In one embodiment, the fourth information set is transmitted via groupcast.

In one embodiment, the fourth information set is transmitted via broadcast.

In one embodiment, the fourth information set comprises fourth SCI and a fourth MAC PDU.

In one embodiment, the fourth SCI is transmitted through a PSCCH, and the fourth MAC PDU is transmitted through a PSSCH.

In one embodiment, the fourth SCI indicates a time-frequency resource occupied by the fourth MAC PDU.

In one embodiment, the fourth SCI comprises a first part of the third identity.

In one embodiment, the fourth SCI comprises a first part of the second identity.

In one embodiment, the first part of the third identity comprised in the fourth SCI comprises 8 bits.

In one embodiment, the first part of the third identity comprised in the fourth SCI comprises lower 8 bits of the third identity.

In one embodiment, the first part of the second identity comprised in the fourth SCI comprises 16 bits.

In one embodiment, the first part of the second identity comprised in the fourth SCI comprises lower 16 bits of the second identity.

In one embodiment, the fourth MAC PDU comprises a fourth SL-SCH subheader.

In one embodiment, the fourth SL-SCH subheader comprises a second part of the third identity.

In one embodiment, the fourth SL-SCH subheader comprises a second part of the second identity.

In one embodiment, the second part of the third identity comprised in the fourth SL-SCH subheader comprises 16 bits.

In one embodiment, the second part of the third identity comprised in the fourth SL-SCH subheader comprises higher 16 bits of the third identity.

In one embodiment, the second part of the second identity comprised in the fourth SL-SCH subheader comprises 8 bits.

In one embodiment, the second part of the second identity comprised in the fourth SL-SCH subheader comprises higher 8 bits of the second identity.

In one embodiment, the first part of the third identity comprised in the fourth SCI and the second part of the third identity comprised in the fourth SL-SCH subheader compose the third identity.

In one embodiment, the first part of the second identity comprised in the fourth SCI and the second part of the second identity comprised in the fourth SL-SCH subheader compose the second identity.

In one embodiment, the fourth MAC PDU comprises a fourth MAC subPDU.

In one embodiment, the fourth MAC subPDU comprises the first packet.

In one embodiment, the second identity comprises 24 bits.

In one embodiment, the second identity is a Link Layer identifier.

In one embodiment, the second identity is a ProSe UE Identifier (ID).

In one embodiment, the second identity is a ProSe Layer-2 Group ID.

In one embodiment, the second identity is a Destination-Layer-2 ID.

In one embodiment, the second identity indicates a node other than the first node and the second node.

In one embodiment, the second identity indicates a groupcast group.

In one embodiment, the first target QoS parameter group is used for generating the first QoS parameter group.

In one subembodiment, the first target QoS parameter group and the second QoS parameter group are jointly used for generating the first QoS parameter group.

In one embodiment, the first target QoS parameter group is used for generating the second QoS parameter group.

In one subembodiment, the first target QoS parameter group and the first QoS parameter group are jointly used for generating the second QoS parameter group.

In one embodiment, the first target QoS parameter group is used for generating the first QoS parameter group and the second QoS parameter group.

In one embodiment, the first target QoS parameter group is used for generating at least one of the first QoS parameter group or the second QoS parameter group.

In one embodiment, the first QoS parameter group and the second QoS parameter group are determined by the first node, without need for standardization.

In one embodiment, the first QoS parameter group and the second QoS parameter group are determined by the first node and the second node through consultation.

In one embodiment, the first QoS parameter group comprises at least one parameter among a PQI, a PC5 Flow bit rate, a PC5 Link Aggregated Bit Rate or a Range.

In one embodiment, the second QoS parameter group comprises at least one parameter among a PQI, a PC5 Flow bit rate, a PC5 Link Aggregated Bit Rate or a Range.

In one embodiment, the first target QoS parameter group is different from the first QoS parameter group.

In one embodiment, the first target QoS parameter group is different from the second QoS parameter group.

In one embodiment, the first target QoS parameter group is the same as the first QoS parameter group.

In one embodiment, the first target QoS parameter group is the same as the second QoS parameter group.

In one embodiment, the first QoS parameter group is the same as the second QoS parameter group.

In one embodiment, the first QoS parameter group is different from the second QoS parameter group.

In one embodiment, the PQI is a particular 5G Quality Identifier (5QI).

In one embodiment, the PQI comprises a group of 5G QoS characteristics.

In one embodiment, the PQI is mapped to a group of 5G QoS characteristics.

In one embodiment, the PQI is used for reference to a group of PC5 QoS characteristics.

In one embodiment, the PC5 QoS characteristics include at least one of a Resource Type, a Priority Level, a Packet Delay Budget (PDB), a Packet Error Rate (PER), an Averaging Window or a Maximum Data Burst Volume (MDBV).

In one embodiment, a value of the PQI comprised by the first target QoS parameter group is any value among 21, 22, 23, 55, 56, 57, 58, 59, 90 and 91.

In one embodiment, a value of the PQI comprised by the first QoS parameter group is any value among 21, 22, 23, 55, 56, 57, 58, 59, 90 and 91.

In one embodiment, a value of the PQI comprised by the second QoS parameter group is any value among 21, 22, 23, 55, 56, 57, 58, 59, 90 and 91.

In one embodiment, a value of the PQI comprised by the first target QoS parameter group is any value in a first column of Table 5.4.4-1 in 3GPP specs 23.287, section 5.4.4.

In one embodiment, a value of the PQI comprised by the first QoS parameter group is any value in a first column of Table 5.4.4-1 in 3GPP specs 23.287, section 5.4.4.

In one embodiment, a value of the PQI comprised by the second QoS parameter group is any value in a first column of Table 5.4.4-1 in 3GPP specs 23.287, section 5.4.4.

In one embodiment, a value of the PQI comprised by the first target QoS parameter group is any value in a first column of Table 5.7.4-1 in 3GPP specs 23.501, section 5.7.4.

In one embodiment, a value of the PQI comprised by the first QoS parameter group is any value in a first column of Table 5.7.4-1 in 3GPP specs 23.501, section 5.7.4.

In one embodiment, a value of the PQI comprised by the second QoS parameter group is any value in a first column of Table 5.7.4-1 in 3GPP specs 23.501, section 5.7.4.

In one embodiment, Resource Types respectively comprised in the first target QoS parameter group, the first QoS parameter group and the second QoS parameter group are the same.

In one embodiment, a Resource Type comprised in the first target QoS parameter group is the same as a Resource Type comprised in the first QoS parameter group.

In one embodiment, a Resource Type comprised in the first target QoS parameter group is the same as a Resource Type comprised in the second QoS parameter group.

In one embodiment, Default Priority Levels respectively comprised in the first target QoS parameter group, the first QoS parameter group and the second QoS parameter group are the same.

In one embodiment, a Default Priority Level comprised in the first target QoS parameter group is the same as a Default Priority Level comprised in the first QoS parameter group.

In one embodiment, a Default Priority Level comprised in the first target QoS parameter group is the same as a Default Priority Level comprised in the second QoS parameter group.

In one embodiment, a sum of a Packet Delay Budget comprised in the first QoS parameter group and a Packet Delay Budget comprised in the second QoS parameter group is no greater than a Packet Delay Budget comprised in the first target QoS parameter group.

In one embodiment, a Packet Delay Budget comprised in the first target QoS parameter group is no smaller than a Packet Delay Budget comprised in the first QoS parameter group.

In one embodiment, a Packet Delay Budget comprised in the first target QoS parameter group is greater than a Packet Delay Budget comprised in the first QoS parameter group.

In one embodiment, a Packet Delay Budget comprised in the first target QoS parameter group is no smaller than a Packet Delay Budget comprised in the second QoS parameter group.

In one embodiment, a Packet Delay Budget comprised in the first target QoS parameter group is greater than a Packet Delay Budget comprised in the second QoS parameter group.

In one embodiment, a product of a first difference and a second difference is no less than a third difference; the first difference, the second difference and the third difference are respectively a difference between and a Packet Error Rate comprised in the first QoS parameter group, a difference between 1 and a Packet Error Rate comprised in the second QoS parameter group, and a difference between 1 and a Packet Error Rate comprised in the first target QoS parameter group.

In one embodiment, a Packet Error Rate comprised in the first target QoS parameter group is no smaller than a Packet Error Rate comprised in the first QoS parameter group.

In one embodiment, a Packet Error Rate comprised in the first target QoS parameter group is greater than a Packet Error Rate comprised in the first QoS parameter group.

In one embodiment, a Packet Error Rate comprised in the first target QoS parameter group is no smaller than a Packet Error Rate comprised in the second QoS parameter group.

In one embodiment, a Packet Error Rate comprised in the first target QoS parameter group is greater than a Packet Error Rate comprised in the second QoS parameter group.

In one embodiment, Maximum Data Burst Volumes respectively comprised in the first target QoS parameter group, the first QoS parameter group and the second QoS parameter group are the same.

In one embodiment, a Maximum Data Burst Volume comprised in the first target QoS parameter group is the same as a Maximum Data Burst Volume comprised in the second QoS parameter group.

In one embodiment, a larger value of a first peak rate and a second peak rate is no greater than a first target peak rate, the first target peak rate, the first peak rate and the second peak rate are respectively a quotient of a Maximum Data Burst Volume comprised in the first target QoS parameter group and a Packet Delay Budget comprised in the first target QoS parameter group, a quotient of a Maximum Data Burst Volume comprised in the first QoS parameter group and a Packet Delay Budget comprised in the first QoS parameter group, and a quotient of a Maximum Data Burst Volume comprised in the second QoS parameter group and a Packet Delay Budget comprised in the second QoS parameter group.

In one embodiment, the first target peak rate, the first peak rate and the second peak rate are the same.

In one embodiment, the first target peak rate is equal to the first peak rate.

In one embodiment, the first target peak rate is greater than the first peak rate.

In one embodiment, the first target peak rate is equal to the second peak rate.

In one embodiment, the first target peak rate is greater than the second peak rate.

In one embodiment, Averaging Windows respectively comprised in the first target QoS parameter group, the first QoS parameter group and the second QoS parameter group are the same.

In one embodiment, an Averaging Window comprised in the first target QoS parameter group is the same as an Averaging Window comprised in the second QoS parameter group.

In one embodiment, an Averaging Window comprised in the first target QoS parameter group is the same as an Averaging Window comprised in the second QoS parameter group.

In one embodiment, PC5 Flow Bit Rates respectively comprised in the first target QoS parameter group, the first QoS parameter group and the second QoS parameter group are the same.

In one embodiment, a larger value of PC5 Flow Bit Rates comprised in the first QoS parameter group and PC5 Flow Bit Rates comprised in the second QoS parameter group is no greater than PC5 Flow Bit Rates comprised in the first target QoS parameter group.

In one embodiment, PC5 Flow Bit Rates comprised in the first target QoS parameter group are equal to PC5 Flow Bit Rates comprised in the first QoS parameter group.

In one embodiment, PC5 Flow Bit Rates comprised in the first target QoS parameter group are greater than PC5 Flow Bit Rates comprised in the first QoS parameter group.

In one embodiment, PC5 Flow Bit Rates comprised in the first target QoS parameter group are equal to PC5 Flow Bit Rates comprised in the second QoS parameter group.

In one embodiment, PC5 Flow Bit Rates comprised in the first target QoS parameter group are greater than PC5 Flow Bit Rates comprised in the second QoS parameter group.

In one embodiment, PC5 Link Aggregated Bit Rates respectively comprised in the first target QoS parameter group, the first QoS parameter group and the second QoS parameter group are the same.

In one embodiment, a larger value of a PC5 Link Aggregated Bit Rate comprised in the first QoS parameter group and a PC5 Link Aggregated Bit Rate comprised in the second QoS parameter group is no greater than a PC5 Link Aggregated Bit Rate comprised in the first target QoS parameter group.

In one embodiment, a PC5 Link Aggregated Bit Rate comprised in the first target QoS parameter group is equal to a PC5 Link Aggregated Bit Rate comprised in the first QoS parameter group.

In one embodiment, a PC5 Link Aggregated Bit Rate comprised in the first target QoS parameter group is greater than a PC5 Link Aggregated Bit Rate comprised in the first QoS parameter group.

In one embodiment, a PC5 Link Aggregated Bit Rate comprised in the first target QoS parameter group is equal to a PC5 Link Aggregated Bit Rate comprised in the second QoS parameter group.

In one embodiment, a PC5 Link Aggregated Bit Rate comprised in the first target QoS parameter group is greater than a PC5 Link Aggregated Bit Rate comprised in the second QoS parameter group.

In one embodiment, a sum of a Range comprised in the first QoS parameter group and a Range comprised in the second QoS parameter group is no smaller than a Range comprised in the first target QoS parameter group.

In one embodiment, a Range comprised in the first target QoS parameter group is no greater than a Range comprised in the first QoS parameter group.

In one embodiment, a Range comprised in the first target QoS parameter group is smaller than a Range comprised in the first QoS parameter group.

In one embodiment, a Range comprised in the first target QoS parameter group is no greater than a Range comprised in the second QoS parameter group.

In one embodiment, a Range comprised in the first target QoS parameter group is smaller than a Range comprised in the second QoS parameter group.

In one embodiment, a first radio bearer is a radio bearer for transmitting the third information set, and the first radio bearer is used by the first node for transmitting a service to which the first packet belongs to the second node.

In one embodiment, the first radio bearer is used by the first node for transmitting a QoS flow to which the first packet belongs to the second node.

In one embodiment, the first radio bearer is used by the first node for transmitting a PC5 QoS flow to which the first packet belongs to the second node.

In one embodiment, a second radio bearer is a radio bearer for transmitting the fourth information set, and the second radio bearer is used by the second node for transmitting a service to which the first packet belongs to the third node.

In one embodiment, the second radio bearer is used by the second node for transmitting a QoS flow to which the first packet belongs to the third node.

In one embodiment, the second radio bearer is used by the second node for transmitting a PC5 QoS flow to which the first packet belongs to the third node.

In one embodiment, the first radio bearer and the second radio bearer are respectively Dedicated Radio Bearers (DRBs).

In one embodiment, the first radio bearer and the second radio bearer are respectively Signaling Radio Bearers (SRBs).

In one embodiment, the first radio bearer and the second radio bearer are respectively Radio Link Control (RLC) RBs.

In one embodiment, the first QoS parameter group is applied in QoS processing of a packet transmitted on the first radio bearer.

In one embodiment, the second QoS parameter group is applied in QoS processing of a packet transmitted on the second radio bearer.

In one embodiment, the QoS processing includes that a packet after being transmitted satisfies a QoS parameter group.

In one embodiment, the QoS processing includes packet filter.

In one embodiment, the QoS processing includes determining a resource type to which a packet belongs is one of a Guaranteed bit rate (GBR), a non-GBR or a Delay Critical GBR according to Resource Type.

In one embodiment, the QoS processing includes determining a transmission priority level for a packet according to Priority Level, thus ensuring that a packet of a higher priority level is given higher priority in transmission.

In one subembodiment, the larger a value of the Priority Level, the lower level of the priority, on the contrary, the smaller a value of the Priority Level, the higher level of the priority.

In one embodiment, the QoS processing includes ensuring that a packet is transmitted within the Packet Delay Budget.

In one embodiment, the QoS processing includes ensuring that the packet error rate of a packet is no greater than the Packet Error Rate.

In one embodiment, the QoS processing includes ensuring that a maximum data burst volume is no greater than the Maximum Data Burst Volume

In one embodiment, the QoS processing includes bit rate control to ensure a transmission rate no greater than PC5 Flow Bit Rates.

In one embodiment, the QoS processing includes PC5 Link Aggregated Bit Rate control to ensure a link aggregated transmission rate no greater than PC5 Link Aggregated Bit Rates.

In one embodiment, the QoS processing includes ensuring that a transmission range is no greater than the Range.

In one embodiment, the QoS processing includes ensuring that a transmission range is no greater than the packet error rate of a receiver of the Range.

### Embodiment 2

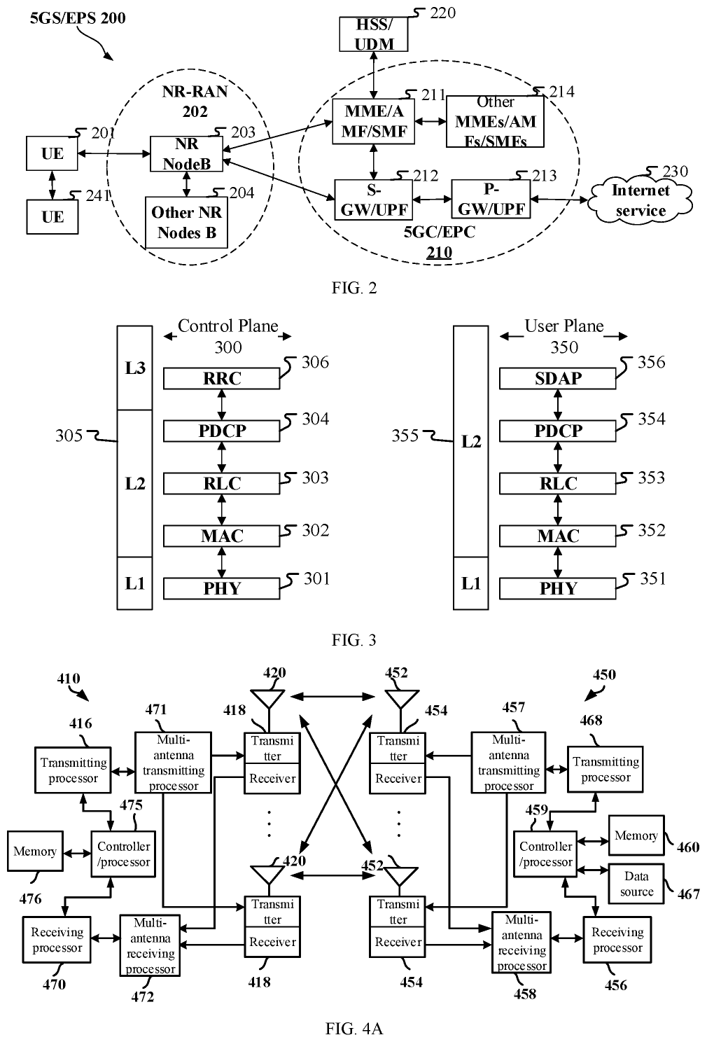

Embodiment 2 illustrates a schematic diagram of a network architecture according to the present disclosure, as shown in FIG. 2. FIG. 2 is a diagram illustrating a network architecture 200 of 5G NR, Long-Term Evolution (LIE), and Long-Term Evolution Advanced (LIE-A) systems. The 5G NR or LIE network architecture 200 may be called a 5G System/Evolved Packet System (5GS/EPS) 200 or other appropriate terms, which may comprise one or more UEs 201, a UE 241 in sidelink communication with the UE(s) 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present disclosure can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN, examples of the gNB 203 include satellite, aircraft or a terrestrial base station relayed by satellite. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching Streaming (PSS) services.

In one embodiment, the first node in the present disclosure includes the UE 201.

In one embodiment, the second node in the present disclosure includes the UE 241.

In one embodiment, the UE in the present disclosure includes the UE 201.

In one embodiment, the UE in the present disclosure includes the UE 241.

In one embodiment, the base station in the present disclosure includes the gNB203.

In one embodiment, the receiver of the first information in the present disclosure includes the UE201.

In one embodiment, the receiver of the first information in the present disclosure includes the UE241.

In one embodiment, the transmitter of the first information in the present disclosure includes the gNB203.

In one embodiment, the transmitter of the first information in the present disclosure includes the UE201.

In one embodiment, the transmitter of the first information in the present disclosure includes the UE241.

In one embodiment, the transmitter of the first signaling in the present disclosure includes the UE201.

In one embodiment, the receiver of the first signaling in the present disclosure includes the UE241.

In one embodiment, the transmitter of the first signal in the present disclosure includes the UE201.

In one embodiment, the receiver of the first signal in the present disclosure includes the UE241.

In one embodiment, the receiver of the second signaling in the present disclosure includes the UE201.

In one embodiment, the receiver of the third signaling in the present disclosure includes the UE201.

In one embodiment, the UE201 corresponds to the first node in the present disclosure.

In one embodiment, the UE241 corresponds to the second node in the present disclosure.

In one embodiment, the gNB203 corresponds to the second node in the present disclosure.

In one embodiment, the UE241 corresponds to the third node in the present disclosure.

In one embodiment, the UE201 and the UE241 respectively support transmission in SL.

In one embodiment, the UE201 and the UE241 respectively support a PC5 interface.

In one embodiment, the UE201 and the UE241 respectively support Vehicle-to-Everything.

In one embodiment, the UE201 and the UE241 respectively support V2X service.

In one embodiment, the UE201 and the UE241 respectively support D2D service.

In one embodiment, the UE201 and the UE241 respectively support public safety service.

In one embodiment, the gNB203 supports Vehicle-to-Everything.

In one embodiment, the gNB203 supports V2X service.

In one embodiment, the gNB203 supports D2D service.

In one embodiment, the gNB203 supports public safety service.

In one embodiment, the gNB203 is a Marco Cell base station.

In one embodiment, the gNB203 is a Micro Cell base station.

In one embodiment, the gNB203 is a Pico Cell base station.

In one embodiment, the gNB203 is a Femtocell.

In one embodiment, the gNB203 is a base station supporting large delay difference.

In one embodiment, the gNB203 is a flight platform.

In one embodiment, the gNB203 is satellite equipment.

In one embodiment, a radio link from the UE 201 to the gNB203 is a UL.

In one embodiment, a radio link from the gNB203 to the UE 201 is a DL.

In one embodiment, a radio link between the UE 201 and the UE 241 corresponds to SL in the present disclosure.

### Embodiment 3

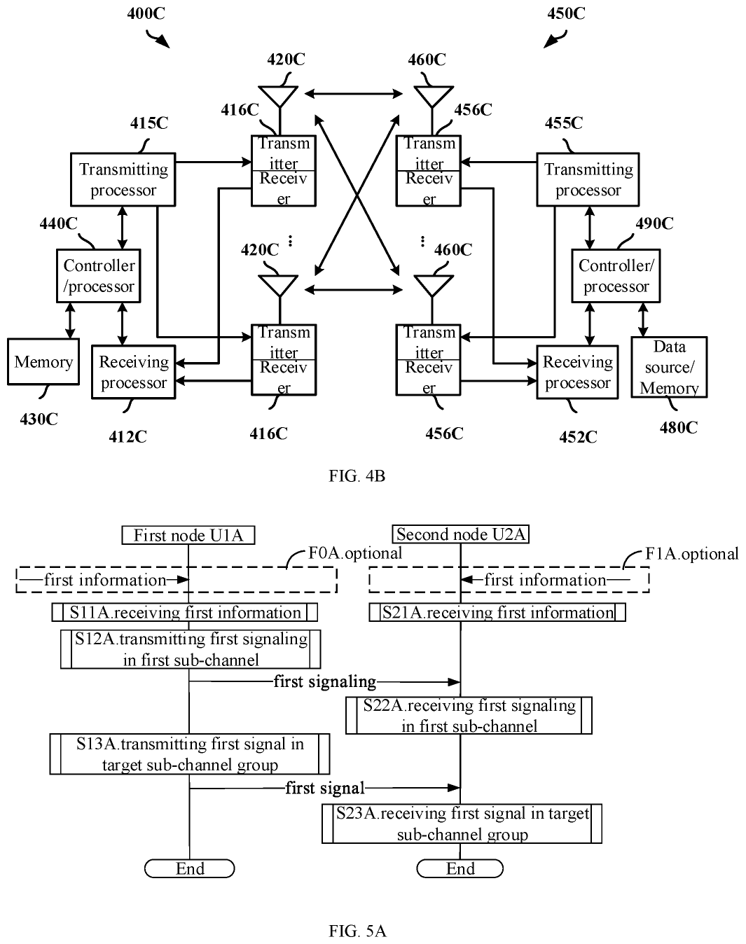

Embodiment 3 illustrates a schematic diagram of one embodiment of a radio protocol architecture of a user plane and a control plane according to the present disclosure, as shown in FIG. 3. FIG. 3 is a schematic diagram illustrating an example of a radio protocol architecture of a user plane 350 and a control plane 300. In FIG. 3, the radio protocol architecture for a control plane 300 between a first node (UE or RSU in V2X, or vehicle-mounted equipment or vehicle-mounted communication modules) and a second node (gNB, UE, or RSU in V2X, or vehicle-mounted equipment or vehicle-mounted communication modules), or between two UEs is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes of the network side. The PDCP sublayer 304 provides data encryption and integrity protection, and also provides support for handover of a second node between first nodes. The RLC sublayer 303 provides segmentation and reassembling of a packet, retransmission of a lost packet through ARQ, and detection of duplicate packets and protocol errors. The MAC sublayer 302 provides mapping between a logical channel and a transport channel as well as multiplexing between logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS flows and a Data Radio Bearer (DRB), so as to support diversified traffics. Although not described in FIG. 3, the first node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first information in the present disclosure is generated by the RRC sublayer 306.

In one embodiment, the first information in the present disclosure is transmitted from the MAC sublayer 302 to the PHY 301.

In one embodiment, the first signaling in the present disclosure is generated by the PHY 301.

In one embodiment, the second signaling in the present disclosure is generated by the PHY 301.

In one embodiment, the third signaling in the present disclosure is generated by the PHY 301.

In one embodiment, the first signaling in the present disclosure is generated by the MAC sublayer 302.

In one embodiment, the second signaling in the present disclosure is generated by the MAC sublayer 302.

In one embodiment, the third signaling in the present disclosure is generated by the MAC sublayer 302.

In one embodiment, the first signal in the present disclosure is generated by the RRC sublayer 306.

In one embodiment, the first signal in the present disclosure is transmitted from the MAC sublayer 302 to the PHY 301.

In one embodiment, the first signal in the present disclosure is generated by the MAC sublayer 302.

In one embodiment, the first signal in the present disclosure is generated by the PHY 301.

In one embodiment, the radio protocol architecture in FIG. 3 is applicable to the third node in the present disclosure.

In one embodiment, the first bit block set in the present disclosure is generated by the RRC sublayer 306.

In one embodiment, the first bit block set in the present disclosure is generated by the MAC sublayer 302.

In one embodiment, the first bit block set in the present disclosure is generated by the MAC sublayer 352.

In one embodiment, the first bit block set in the present disclosure is generated by the PHY 301.

In one embodiment, the first bit block set in the present disclosure is generated by the PHY 351.

In one embodiment, the monitoring in the present disclosure is performed in the PHY 301.

In one embodiment, the monitoring in the present disclosure is performed in the PHY 351.

In one embodiment, the first signaling in the present disclosure is generated by the PHY 351.

In one embodiment, the second signaling in the present disclosure is generated by the PHY 351.

In one embodiment, the L1-1 signaling(s) in the present disclosure is(are) generated by the PHY 301.

In one embodiment, the L1-1 signaling(s) in the present disclosure is(are) generated by the PHY 351.

In one embodiment, the L2-1 signaling(s) in the present disclosure is(are) generated by the PHY 301.

In one embodiment, the L2-1 signaling(s) in the present disclosure is(are) generated by the PHY 351.

In one embodiment, the first information block set in the present disclosure is generated by the PHY 301.

In one embodiment, the first information block set in the present disclosure is generated by the PHY 351.

In one embodiment, the second information block subset in the present disclosure is generated by the PHY 301.

In one embodiment, the second information block subset in the present disclosure is generated by the PHY 351.

In one embodiment, the protocol architecture in FIG. 3 is applicable to the first node in the present disclosure.

In one embodiment, the protocol architecture in FIG. 3 is applicable to the second node in the present disclosure.

In one embodiment, the protocol architecture in FIG. 3 is applicable to the third node in the present disclosure.

In one embodiment, the first target QoS parameter group in the present disclosure is generated by the V2X307.

In one embodiment, the first information set in the present disclosure is generated by the RRC306.

In one embodiment, the second information set in the present disclosure is generated by the RRC306.

In one embodiment, the first signaling in the present disclosure is generated by the RRC306.

In one embodiment, the second signaling in the present disclosure is generated by the RRC306.

In one embodiment, the third information set in the present disclosure is generated by the MAC302 or the MAC352.

In one embodiment, the fourth information set in the present disclosure is generated by the MAC302 or the MAC352.

In one embodiment, the first identity in the present disclosure is generated by the V2X307.

In one embodiment, the second identity in the present disclosure is generated by the V2X307.

In one embodiment, the third identity in the present disclosure is generated by the V2X307, or the RRC306 or the MAC302.

In one embodiment, the L2 305 or 355 is a higher layer.

In one embodiment, the RRC sublayer 306 in the L3 belongs to a higher layer.

### Embodiment 4A

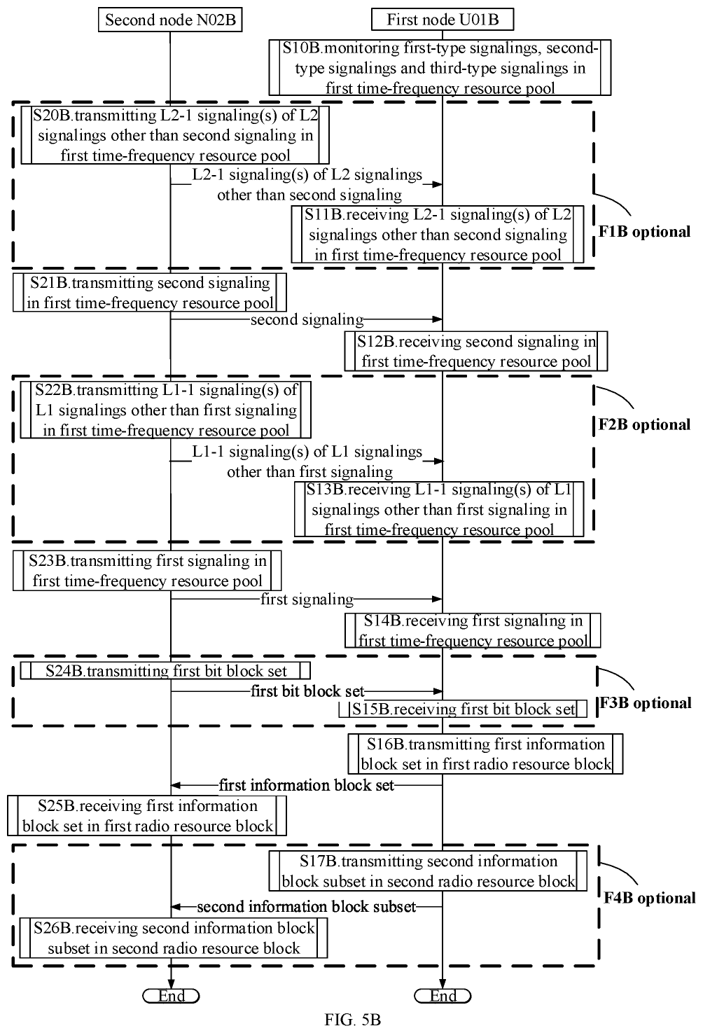

Embodiment 4A illustrates a schematic diagram of a first communication device and a second communication device according to the present disclosure, as shown in FIG. 4A. FIG. 4A is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 implements the functionality of the L2 layer. The controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 performs functions of the L2 layer. The controller/processor 459 can be associated with a memory 460 that stores program code and data. The memory 460 can be called a computer readable medium. In a transmission between the first communication device 410 and the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present disclosure includes the second communication device 450, and the second node in the present disclosure includes the first communication device 410.

In one subembodiment, the first node is a UE, and the second node is a UE.

In one subembodiment, the first node is a UE, and the second node is a relay node.

In one subembodiment, the first node is a relay node, and the second node is a base station.

In one subembodiment, the first node is a relay node, and the second node is a UE.

In one subembodiment, the first node is a UE, and the second node is a base station.

In one embodiment, the third node in the present disclosure includes the second communication device 450.

In one subembodiment, the second communication device 450 comprises at least one controller/processor; the at least one controller/processor is in charge of HARQ operation.

In one subembodiment, the first communication device 410 comprises at least one controller/processor; the at least one controller/processor is in charge of HARQ operation.

In one subembodiment, the first communication device 410 comprises at least one controller/processor; the at least one controller/processor is in charge of error detection using ACK and/or NACK protocols as a way to support HARQ operation.

In one embodiment, the second communication device 450 comprises at least one processor and at least one memory, the at least one memory comprises computer program codes; the at least one memory and the computer program codes are configured to be used in collaboration with the at least one processor, the second communication device 450 at least receives first information; and transmits a first signaling in a first sub-channel; herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the second communication device 450 comprises a memory that stores computer readable instruction program, the computer readable instruction program generates actions when executed by at least one processor, which include: receiving first information; and transmitting a first signaling in a first sub-channel; herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the first communication device 410 comprises at least one processor and at least one memory, the at least one memory comprises computer program codes; the at least one memory and the computer program codes are configured to be used in collaboration with the at least one processor. The first communication device 410 at least receives first information; and receives a first signaling in a first sub-channel; herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the first communication device 410 comprises a memory that stores computer readable instruction program, the computer readable instruction program generates actions when executed by at least one processor, which include: receiving first information; and receiving a first signaling in a first sub-channel; herein, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, at least one of the antenna 452, the receiver 454, the multi-antenna receiving processor 458, the receiving processor 456, the controller/processor 459, the memory 460 or the data source 467 is used for receiving first information in the present disclosure.

In one embodiment, at least one of the antenna 452, the receiver 454, the multi-antenna receiving processor 458, the receiving processor 456, the controller/processor 459, the memory 460 or the data source 467 is used for receiving a second signaling in the present disclosure.

In one embodiment, at least one of the antenna 452, the receiver 454, the multi-antenna receiving processor 458, the receiving processor 456, the controller/processor 459, the memory 460 or the data source 467 is used for receiving a third signaling in the present disclosure.

In one embodiment, at least one of the antenna 452, the transmitter 454, the multi-antenna transmitting processor 457, the transmitting processor 468, the controller/processor 459, the memory 460 or the data source 467 is used for transmitting a first signaling in a first sub-channel in the present disclosure.

In one embodiment, at least one of the antenna 452, the transmitter 454, the multi-antenna transmitting processor 457, the transmitting processor 468, the controller/processor 459, the memory 460 or the data source 467 is used for transmitting a first signal in a target sub-channel group in the present disclosure.

In one embodiment, at least one of the antenna 420, the multi-antenna receiving processor 472, the receiving processor 470, the controller/processor 475 or the memory 476 is used for receiving first information in the present disclosure.

In one embodiment, at least one of the antenna 420, the multi-antenna receiving processor 472, the receiving processor 470, the controller/processor 475 or the memory 476 is used for receiving a first signaling in a first sub-channel in the present disclosure.

In one embodiment, at least one of the antenna 420, the multi-antenna receiving processor 472, the receiving processor 470, the controller/processor 475 or the memory 476 is used for receiving a first signal in a target sub-channel group in the present disclosure.

In one embodiment, the second communication device 450 comprises at least one processor and at least one memory, the at least one memory comprises computer program codes; the at least one memory and the computer program codes are configured to be used in collaboration with the at least one processor, the second communication device 450 at least monitors first-type signalings, second-type signalings and third-type signalings in a first time-frequency resource pool; receives a first signaling in the first time-frequency resource pool; and transmits a first information block set in a first radio resource block; herein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one subembodiment, the second communication device 450 corresponds to the first node in the present disclosure.

In one embodiment, the second communication device 450 comprises a memory that stores computer readable instruction program, the computer readable instruction program generates actions when executed by at least one processor, which include: monitoring first-type signalings, second-type signalings and third-type signalings in a first time-frequency resource pool; receiving a first signaling in the first time-frequency resource pool; and transmitting a first information block set in a first radio resource block; herein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one subembodiment, the second communication device 450 corresponds to the first node in the present disclosure.

In one embodiment, the first communication device 410 comprises at least one processor and at least one memory, the at least one memory comprises computer program codes; the at least one memory and the computer program codes are configured to be used in collaboration with the at least one processor. The first communication device 410 at least transmits a first signaling in a first time-frequency resource pool; and receives a first information block set in a first radio resource block; herein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one subembodiment, the first communication device 410 corresponds to the second node in the present disclosure.

In one embodiment, the first communication device 410 comprises a memory that stores computer readable instruction program, the computer readable instruction program generates actions when executed by at least one processor, which include: transmitting a first signaling in a first time-frequency resource pool; and receiving a first information block set in a first radio resource block; herein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one subembodiment, the first communication device 410 corresponds to the second node in the present disclosure.

In one embodiment, at least one of the antenna 452, the receiver 454, the multi-antenna receiving processor 458, the receiving processor 456, the controller/processor 459, the memory 460 or the data source 467 is used for monitoring the first-type signalings, the second-type signalings and the third-type signalings in the first time-frequency resource pool in the present disclosure.

In one embodiment, at least one of the antenna 452, the receiver 454, the multi-antenna receiving processor 458, the receiving processor 456, the controller/processor 459, the memory 460 or the data source 467 is used for receiving the L2-1 signaling(s) of the L2 signalings other than the second signaling in the first time-frequency resource pool in the present disclosure.

In one embodiment, at least one of the antenna 420, the transmitter 418, the multi-antenna transmitting processor 471, the transmitting processor 416, the controller/processor 475 or the memory 476 is used for transmitting the L2-1 signaling(s) of the L2 signalings other than the second signaling in the first time-frequency resource pool in the present disclosure.

In one embodiment, at least one of the antenna 452, the receiver 454, the multi-antenna receiving processor 458, the receiving processor 456, the controller/processor 459, the memory 460 or the data source 467 is used for receiving the second signaling in the first time-frequency resource pool in the present disclosure.

In one embodiment, at least one of the antenna 420, the transmitter 418, the multi-antenna transmitting processor 471, the transmitting processor 416, the controller/processor 475 or the memory 476 is used for transmitting the second signaling in the first time-frequency resource pool in the present disclosure.

In one embodiment, at least one of the antenna 452, the receiver 454, the multi-antenna receiving processor 458, the receiving processor 456, the controller/processor 459, the memory 460 or the data source 467 is used for receiving L1-1 signaling(s) of the L1 signalings other than the first signaling in the first time-frequency resource pool in the present disclosure.

In one embodiment, at least one of the antenna 420, the transmitter 418, the multi-antenna transmitting processor 471, the transmitting processor 416, the controller/processor 475 or the memory 476 is used for transmitting L1-1 signaling(s) of the L1 signalings other than the first signaling in the first time-frequency resource pool in the present disclosure.

In one embodiment, at least one of the antenna 452, the receiver 454, the multi-antenna receiving processor 458, the receiving processor 456, the controller/processor 459, the memory 460 or the data source 467 is used for receiving the first signaling in the first time-frequency resource pool in the present disclosure.

In one embodiment, at least one of the antenna 420, the transmitter 418, the multi-antenna transmitting processor 471, the transmitting processor 416, the controller/processor 475 or the memory 476 is used for transmitting the first signaling in the first time-frequency resource pool in the present disclosure.

In one embodiment, at least one of the antenna 452, the receiver 454, the multi-antenna receiving processor 458, the receiving processor 456, the controller/processor 459, the memory 460 or the data source 467 is used for receiving the first bit block set in the present disclosure.

In one embodiment, at least one of the antenna 420, the transmitter 418, the multi-antenna transmitting processor 471, the transmitting processor 416, the controller/processor 475 or the memory 476 is used for transmitting the first bit block set in the present disclosure.

In one embodiment, at least one of the antenna 452, the transmitter 454, the multi-antenna transmitting processor 458, the transmitting processor 468, the controller/processor 459, the memory 460 or the data source 467 is used for transmitting the first information block set in the first radio resource block in the present disclosure.

In one embodiment, at least one of the antenna 420, the multi-antenna receiving processor 472, the receiving processor 470, the controller/processor 475 or the memory 476 is used for receiving the first information block set in the first radio resource block in the present disclosure.

In one embodiment, at least one of the antenna 452, the transmitter 454, the multi-antenna transmitting processor 458, the transmitting processor 468, the controller/processor 459, the memory 460 or the data source 467 is used for transmitting the second information block subset in the second radio resource block in the present disclosure.

In one embodiment, at least one of the antenna 420, the multi-antenna receiving processor 472, the receiving processor 470, the controller/processor 475 or the memory 476 is used for receiving the second information block subset in the second radio resource block in the present disclosure.

### Embodiment 4B

Embodiment 4B illustrates a schematic diagram of a first node and a second node according to the present disclosure, as shown in FIG. 4B.

The first node (450C) can comprise a controller/processor 490C, a receiving processor 452C, a transmitting processor 455C, a transmitter/receiver 456C and a data source/memory 480C, the transmitter/receiver 456C comprising an antenna 460C.

The second node (400C) can comprise a controller/processor 440C, a receiving processor 412C, a transmitting processor 415C, a transmitter/receiver 416C and a memory 430C, the transmitter/receiver 416C comprising an antenna 420C.

In a transmission from the second node 400C to the first node 450C, at the second node 400C, a higher-layer packet is provided to the controller/processor 440C. The controller/processor 440C provides functions of the L2, the V2X layer and layers above. In the transmission from the second node 400C to the first node 450C, the controller/processor 440C provides header compression, encryption, packet segmentation and reordering, and multiplexing between logical channels and transport channels, as well as radio resource allocation of the first node 450C based on various priorities. The controller/processor 440C is also responsible for HARQ operation, a retransmission of a lost packet and a signaling to the first node 450C. The transmitting processor 415C implements signal processing functions used for the L1 (that is, PHY), including coding, interleaving, scrambling, modulation, power control/allocation, precoding and physical layer control signaling generation. The generated modulation symbols are divided into parallel streams and each stream is mapped to a corresponding multicarrier subcarrier and/or multicarrier symbol, which is then mapped from the transmitting processor 415C to the antenna 420C through the transmitter 416C to be transmitted in the form of a radio frequency signal.

In a transmission from the second node 400C to the first node 450C, at the first node 450C, each receiver 456C receives a radio frequency signal via a corresponding antenna 460C, and then recovers baseband information modulated onto a radio frequency carrier, and provides the baseband information to the receiving processor 452C. The receiving processor 452C provides signal receiving processing functions of the L1. The signal receiving processing functions include receiving of a physical layer signal, performing demodulation of multicarrier symbols in multicarrier symbol streams based on different modulation schemes (e.g., Binary Phase Shift Keying (BPSK), Quadrature Phase Shift Keying (QPSK)), and then de-scrambling, decoding and de-interleaving so as to recover data or control signal transmitted by the second node 400C on a physical channel. Afterwards the data and control signal are provided to the controller/processor 490C. The controller/processor 490C is in charge of functionality of the L2, the V2X layer and above layers. The controller/processor can be associated with the memory 480C that stores program codes and data. The memory 480C can be called a computer readable medium.

In a transmission from the first node 450C to the second node 400C, at the first node 450C, the data source/memory 480C is used for providing higher layer data to the controller/processor 490C. The data source/memory 480C represents the L2, the V2X layer and above layers. The controller/processor 490C provides header compression, encryption, packet segmentation and reordering as well as multiplexing between logical channels and transport channels based on radio resource allocation of the second node 410C, thus implementing the L2 layer protocols used for the user plane and the control plane. The controller/processor 490C is also responsible for HARQ operation, retransmission of a lost packet, and a signaling to the second node 410C. The transmitting processor 455C provides signal transmitting processing functions of the L1 (that is, PHY). The signal transmitting processing functions include coding and interleaving to promote Forward Error Correction (FEC) at the UE450 and modulation of a baseband signal based on different modulation schemes (e.g., BPSK, QPSK), and the modulation symbols are divided into parallel streams of which each is mapped to a corresponding multicarrier subcarrier and/or multicarrier symbol, and then is mapped from the transmitting processor 455C to the antenna 460C through the transmitter 456C in the form of a radio frequency signal.

In a transmission from the first node 450C to the second node 400C, at the second node 400C, each receiver 416C receives a radio frequency signal via a corresponding antenna 420C, and then recovers baseband information modulated onto a radio frequency carrier, and provides the baseband information to the receiving processor 412C. The receiving processor 412C provides signal receiving processing functions of the L1 (that is, PHY). The signal receiving processing functions include acquiring multicarrier symbol streams, performing demodulation of multicarrier symbols in multicarrier symbol streams based on different modulation schemes (e.g., BPSK, QPSK), and then decoding and de-interleaving so as to recover data and/or control signal transmitted by the first node 450C on a physical channel. Afterwards the data and control signal are provided to the controller/processor 440C. The controller/processor 440C is in charge of functionality of the L2, the V2X layer and above layers. The controller/processor 440C can be associated with the memory 430C that stores program codes and data. The memory 430C can be called a computer readable medium.

In one embodiment, the first node 450C comprises at least one processor and at least one memory, the at least one memory comprises computer program codes; the at least one memory and the computer program codes are configured to be used in collaboration with the at least one processor, the first node 450C at least determines a first target QoS parameter group; and transmits a first information set, a second information set and a third information set; herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the first node 450C comprises a memory that stores computer readable instruction program, the computer readable instruction program generates actions when executed by at least one processor, which include: determining a first target QoS parameter group; and transmitting a first information set, a second information set and a third information set; herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the second node 400C comprises at least one processor and at least one memory, the at least one memory comprises computer program codes; the at least one memory and the computer program codes are configured to be used in collaboration with the at least one processor. The second node 400C at least receives a second information set and a third information set; herein, a first information set is used to indicate a first QoS parameter group, the second information set is used to indicate a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the second node 400C comprises a memory that stores computer readable instruction program, the computer readable instruction program generates actions when executed by at least one processor, which include: receiving a second information set and a third information set; herein, a first information set is used to indicate a first QoS parameter group, the second information set is used to indicate a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the first node 450C is a UE.

In one embodiment, the first node 450C is a UE supporting V2X.

In one embodiment, the first node 450C is a UE supporting D2D.

In one embodiment, the first node 450C is vehicle-counted equipment.

In one embodiment, the first node 450C is an RSU.

In one embodiment, the second node 400C is a base station supporting V2X.

In one embodiment, the second node 400C is an RSU.

In one embodiment, the second node 400C is a UE supporting V2X.

In one embodiment, at least one of the transmitter 456C (comprising the antenna 460C), the transmitting processor 455C or the controller/processor 490C is used for transmitting the first information set in the present disclosure.

In one embodiment, at least one of the transmitter 456C (comprising the antenna 460C), the transmitting processor 455C or the controller/processor 490C is used for transmitting the second information set in the present disclosure.

In one embodiment, at least one of the receiver 416C (comprising the antenna 420C), the receiving processor 412C or the controller/processor 440C is used for receiving the second information set in the present disclosure.

In one embodiment, at least one of the transmitter 456C (comprising the antenna 460C), the transmitting processor 455C or the controller/processor 490C is used for transmitting the third information set in the present disclosure.

In one embodiment, at least one of the receiver 416C (comprising the antenna 420C), the receiving processor 412C or the controller/processor 440C is used for receiving the third information set in the present disclosure.

In one embodiment, at least one of the transmitter 456C (comprising the antenna 460C), the transmitting processor 455C or the controller/processor 490C is used for transmitting the first signaling in the present disclosure.

In one embodiment, at least one of the receiver 416C (comprising the antenna 420C), the receiving processor 412C or the controller/processor 440C is used for receiving the first signaling in the present disclosure.

In one embodiment, at least one of the transmitter 416 (comprising the antenna 420C), the transmitting processor 415C or the controller/processor 440C is used for transmitting the second signaling in the present disclosure.

In one embodiment, at least one of the receiver 456C (comprising the antenna 460C), the receiving processor 452C or the controller/processor 490C is used for receiving the second signaling in the present disclosure.

In one embodiment, the controller/processor 490C is used for generating the first target QoS parameter group in the present disclosure.

In one embodiment, the controller/processor 490C is used for generating the first QoS parameter group in the present disclosure.

In one embodiment, the controller/processor 490C is used for generating the second QoS parameter group in the present disclosure.

In one embodiment, the controller/processor 490C is used for generating the first QoS parameter set in the present disclosure.

In one embodiment, the controller/processor 440C is used for generating the second QoS parameter set in the present disclosure.

### Embodiment 5A

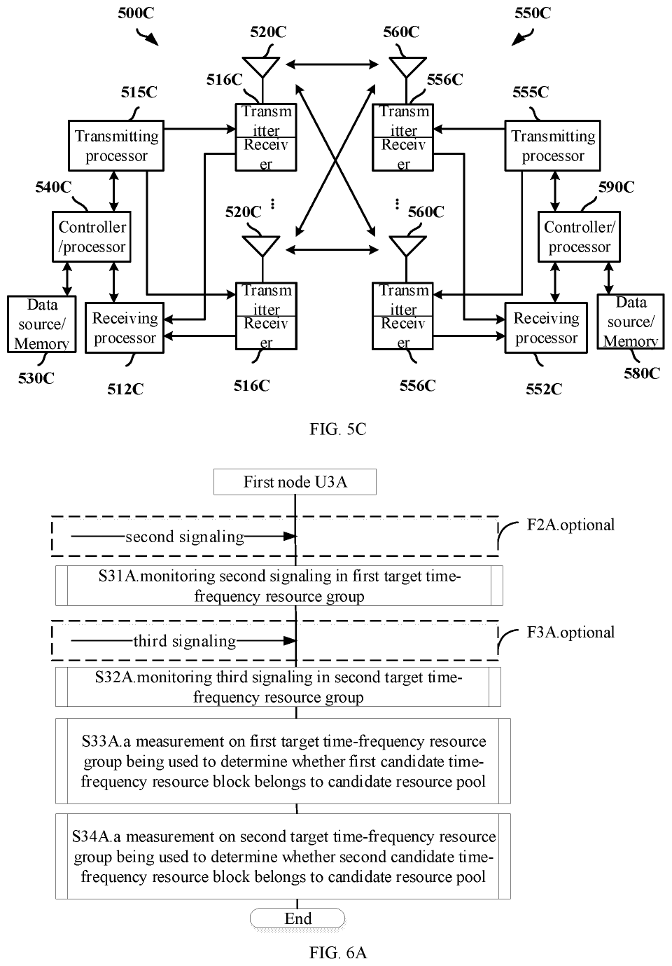

Embodiment 5A illustrates a flowchart of radio signal transmission according to one embodiment of the present disclosure, as shown in FIG. 5A. In FIG. 5A, a first node U1A and a second node U2A are in communication via an air interface; steps marked by a box F0A and a box F1A in FIG. 5A are optional, respectively.

The first node U1A receives first information in step S11A; transmits a first signaling in a first sub-channel in step S12A; and transmits a first signal in a target sub-channel group in step S13A.

The second node U2A receives first information in S21A; receives a first signaling in a first sub-channel group in step S22A; and receives a first signal in a target sub-channel group in step S23A.

In Embodiment 5A, the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group; the first signaling indicates priority of the first signal; the first signaling indicates a time-frequency resource occupied by the first signal, and the time-frequency resource occupied by the first signal indicated by the first signaling comprises the target sub-channel group in frequency domain.

In one embodiment, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group, and the first signaling indicates a quantity of the positive integer number of sub-channels comprised by the target sub-channel group.

In one embodiment, the first sub-channel belongs to the target sub-channel group; when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group; the first signaling indicates a quantity of the positive integer number of sub-channels comprised by the target sub-channel group.

In one embodiment, when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

In one embodiment, the first node U1A and the second node U2A are in communication via a PC5 interface.

In one embodiment, the step marked by the box F0A in FIG. 5A exists.

In one embodiment, the step marked by the box F0A in FIG. 5A does not exist.

In one embodiment, the step marked by the box F1A in FIG. 5A exists.

In one embodiment, the step marked by the box F1A in FIG. 5A does not exist.

In one embodiment, when the first information is transmitted to a physical layer of the first node U1A through a higher layer of the first node U1A, the step marked by the box F0A in FIG. 5A does not exist.

In one embodiment, when the first information is transmitted to a PHY layer of the first node U1A through a MAC sublayer of the first node U1A, the step marked by the box F0A in FIG. 5A does not exist.

In one embodiment, when the first information is transmitted to a physical layer of the second node U2A through a higher layer of the second node U2A, the step marked by the box F1A in FIG. 5A does not exist.

In one embodiment, when the first information is transmitted to a PHY layer of the second node U2A through a MAC sublayer of the second node U2A, the step marked by the box F1A in FIG. 5A does not exist.

In one embodiment, the phrase of “receiving first information” includes receiving the first information transmitted via a Uu interface.

In one embodiment, the phrase of “receiving first information” includes receiving the first information transmitted via a PC5 interface.

In one embodiment, in step S11A of the first node U1A, the phrase of “receiving first information” includes receiving the first information transmitted to a physical layer of the first node U1A through a higher layer of the first node U1A.

In one embodiment, in step 21A of the second node U2A, the phrase of “receiving first information” includes receiving the first information transmitted to a physical layer of the second node U2A through a higher layer of the second node U2A.

In one embodiment, in step S11A of the first node U1A, a transmitter of the first information includes the base station.

In one embodiment, in step S11A of the first node U1A, a transmitter of the first information includes a UE.

In one embodiment, in step S11A of the first node U1A, a transmitter of the first information includes a higher layer of the first node U1A.

In one embodiment, in step 21A of the second node U2A, a transmitter of the first information includes the base station.

In one embodiment, in step 21A of the second node U2A, a transmitter of the first information includes a UE.

In one embodiment, in step 21A of the second node U2A, a transmitter of the first information includes a higher layer of the second node U2A.

In one embodiment, the first signal is a baseband signal.

In one embodiment, the first signal is a radio frequency (RF) signal.

In one embodiment, the first signal is a radio signal.

In one embodiment, the first signal is transmitted on a Sidelink Shared Channel (SL-SCH).

In one embodiment, the first signal is transmitted on a PSSCH.

In one embodiment, the first signal is transmitted on a PUSCH.

In one embodiment, the first signal comprises all or part of a higher layer signaling.

In one embodiment, the first signal comprises all or part of a MAC layer signaling.

In one embodiment, the first signal comprises a MAC CE.

In one embodiment, the first signal comprises one or more fields in a MAC CE.

In one embodiment, the first signal comprises a MAC Protocol Data Unit (PDU).

In one embodiment, the first signal comprises one or more MAC subPDUs in a MAC PDU.

In one embodiment, the first signal comprises all or part of an RRC layer signal.

In one embodiment, the first signal comprises one or more fields of an RRC IE.

In one embodiment, the first signal comprises one or more fields of a PHY layer signaling.

In one embodiment, the first signal comprises a first bit block, the first bit block comprising a positive integer number of bit(s).

In one embodiment, a first bit block is used for generating the first signal, the first bit block comprising a positive integer number of bit(s).

In one embodiment, a first bit block comprises a positive integer number of bit(s), and the first signal comprises all or part of bit(s) in the first bit block.

In one embodiment, the first bit block comprises a positive integer number of bit(s), and all or part of the positive integer number of bit(s) in the first bit block is(are) used for generating the first signal.

In one embodiment, the first bit block comprises 1 Codeword (CW).

In one embodiment, the first bit block comprises 1 Code Block (CB).

In one embodiment, the first bit block comprises 1 Code Block Group (CBG).

In one embodiment, the first bit block comprises 1 Transport Block (TB).

In one embodiment, the first signal is obtained by all or part of bit(s) comprised in the first bit block sequentially through TB-level CRC Attachment, Code Block Segmentation, CB-level CRC Attachment, Channel Coding, Rate Matching, Code Block Concatenation, scrambling, Modulation, Layer Mapping, Antenna Port Mapping and Mapping to Physical Resource Blocks, Baseband Signal Generation, and Modulation and Upconversion.

In one embodiment, the first signal is an output by the first bit block sequentially through a Modulation Mapper, a Layer Mapper, Precoding, a Resource Element Mapper and multicarrier symbol Generation.

In one embodiment, the channel coding is based on a polar code.

In one embodiment, the channel coding is based on a Low-density Parity-Check (LDPC) code.

In one embodiment, only the first bit block is used for generating the first signal.

In one embodiment, there is one bit block other than the first bit block being used for generating the first signal, too.

### Embodiment 5B

Embodiment 5B illustrates a flowchart of radio signal transmission according to one embodiment of the present disclosure, as shown in FIG. 5B. In FIG. 5B, a first node U01B and a second node N02B are in communication via an air interface. In FIG. 5B, dotted-line framed boxes F1B, F2B, F3B and F4B are optional. Each box represents a step. It should be particularly noted that the sequence of boxes arranged herein does not imply a chronological order of steps respectively represented.

The first node U01B monitors first-type signalings, second-type signalings and third-type signalings in a first time-frequency resource pool in step SLOB; receives L2-1 signaling(s) of L2 signalings other than a second signaling in the first time-frequency resource pool in step S11B; and receives the second signaling in the first time-frequency resource pool in step S12B; receives L1-1 signaling(s) of L1 signalings other than a first signaling in the first time-frequency resource pool in step S13B; and receives the first signaling in the first time-frequency resource pool in step S14B; receives a first bit block set in step S15B; transmits a first information block set in a first radio resource block in step S16B; and transmits a second information block subset in a second radio resource block in step Sl7B.

The second node N02B transmits L2-1 signaling(s) of L2 signalings other than a second signaling in a first time-frequency resource pool in step S20B; and transmits the second signaling in the first time-frequency resource pool in step S21B; transmits L1-1 signaling(s) of L1 signalings other than a first signaling in the first time-frequency resource pool in step S22B; and transmits the first signaling in the first time-frequency resource pool in step S23B; transmits a first bit block set in step S24B; receives a first information block set in a first radio resource block in step S25B; and receives a second information block subset in a second radio resource block in step S26B.

In Embodiment 5B, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool. The second signaling is a second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset. The first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings. When the first signaling is the third-type signaling, the second signaling is used to indicate the second radio resource block, the second radio resource block being orthogonal to the first radio resource block in time domain. The second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings. The first signaling comprises scheduling information of the first bit block set; the HARQ-ACK associated with the first signaling indicates whether each bit block in the first bit block set is correctly received.

In one embodiment, the first signaling is the third-type signaling, the second signaling is used to indicate the second radio resource block, the second radio resource block being orthogonal to the first radio resource block in time domain, and the box F4B exists.

In one embodiment, the first signaling is the first-type signaling, and the box F4B does not exist.

In one embodiment, when the first signaling is the first-type signaling, a number of the first-type signalings and a number of the second-type signalings transmitted in the first time-frequency resource pool are jointly used by the second node N02B for determining the first target value; when the first signaling is the third-type signaling, a number of the third-type signalings transmitted in the first time-frequency resource pool is used by the second node N02B for determining the first target value.

In one embodiment, when the first signaling is the first-type signaling, a number of the first-type signalings and a number of the second-type signalings transmitted in the first time-frequency resource pool are jointly used by the first node U01B for determining the first target value; when the first signaling is the third-type signaling, a number of the third-type signalings transmitted in the first time-frequency resource pool is used by the first node U01B for determining the first target value.

In one embodiment, the first signaling is the first-type signaling, a number of the first-type signalings and a number of the second-type signalings transmitted in the first time-frequency resource pool are used by the second node N02B for determining a first integer, and the first integer is used by the second node N02B for determining the first target value.

In one embodiment, the first signaling is the first-type signaling, a number of the first-type signalings and a number of the second-type signalings transmitted in the first time-frequency resource pool are used by the first node U01B for determining a first integer, and the first integer is used by the first node U01B for determining the first target value.

In one embodiment, the first signaling is the first-type signaling, and a sum of a number of the first-type signalings and a number of the second-type signalings transmitted in the first time-frequency resource pool is used by the second node N02B for determining the first target value.

In one embodiment, the first signaling is the first-type signaling, and a sum of a number of the first-type signalings and a number of the second-type signalings transmitted in the first time-frequency resource pool is used by the first node U01B for determining the first target value.

In one embodiment, the first signaling is the first-type signaling, a number of the first-type signalings and a number of the second-type signalings transmitted in the first time-frequency resource pool are used by the second node N02B for determining a first integer, and an output of the first integer being input to a first function is equal to the first target value.

In one embodiment, the first signaling is the first-type signaling, a number of the first-type signalings and a number of the second-type signalings transmitted in the first time-frequency resource pool are used by the first node U01B for determining a first integer, and an output of the first integer being input to a first function is equal to the first target value.

In one embodiment, the first integer is equal to a result of linear transformation of a number of the first-type signalings and a number of the second-type signalings transmitted in the first time-frequency resource pool.

In one embodiment, the first integer is equal to a sum of a number of the first-type signalings and a number of the second-type signalings transmitted in the first time-frequency resource pool.

In one embodiment, the first integer is linear with a sum of a number of the first-type signalings and a number of the second-type signalings transmitted in the first time-frequency resource pool.

In one embodiment, the first signaling is the third-type signaling, a number of the third-type signalings transmitted in the first time-frequency resource pool is used by the second node N02B for determining a second integer, and the second integer is used by the second node N02B for determining the first target value.

In one embodiment, the first signaling is the third-type signaling, a number of the third-type signalings transmitted in the first time-frequency resource pool is used by the first node U01B for determining a second integer, and the second integer is used by the first node U01B for determining the first target value.

In one embodiment, the first signaling is the third-type signaling, a number of the third-type signalings transmitted in the first time-frequency resource pool is used by the second node N02B for determining a second integer, and an output of the second integer being input to the first function is equal to the first target value.

In one embodiment, the first signaling is the third-type signaling, a number of the third-type signalings transmitted in the first time-frequency resource pool is used by the first node U01B for determining a second integer, and an output of the second integer being input to the first function is equal to the first target value.

In one embodiment, the first signaling is the third-type signaling, and an output of a number of the third-type signalings transmitted in the first time-frequency resource pool being input to the first function is equal to the first target value.

In one embodiment, the first signaling is the first-type signaling, and the first target value is used by the first node for determining a sum of a number of the first-type signalings and a number of the second-type signalings transmitted in the first time-frequency resource pool.

In one embodiment, the first signaling is the third-type signaling, and the first target value is used by the first node for determining a number of the third-type signalings transmitted in the first time-frequency resource pool.

In one embodiment, the first signaling is the third-type signaling, and a number of the second-type signalings transmitted in the first time-frequency resource pool is not used by the second node N02B for determining the first target value.

In one embodiment, the first signaling is the third-type signaling, and a number of the second-type signalings transmitted in the first time-frequency resource pool is not used by the first node U01B for determining the first target value.

In one embodiment, the first function includes linear transformation and modulus operation.

In one embodiment, the first function includes linear transformation.

In one embodiment, with a second reference value being input to the first function, an output of the first function obtained is equal to a given value; the given value is equal to a target value mod a first reference value and then plus 1, and the target value is equal to a non-negative integer obtained by the second reference value subtracted by 1, the first reference value being a positive integer.

In one subembodiment, the given value is the first target value, the first signaling is the first-type signaling, and the second reference value is a sum of the number of the first-type signalings and the number of the second-type signalings transmitted in the first time-frequency resource pool.

In one subembodiment, the given value is the first target value, the first signaling is the third-type signaling, and the second reference value is the number of the third-type signalings transmitted in the first time-frequency resource pool.

In one embodiment, with a second reference value being input to the first function, an output of the first function obtained is equal to a given value; the given value is X, the second reference value is Y, a first reference value is T, and the relationship between X and Y fulfills X=(Y−1)mod T+1, X, Y and T being positive integers respectively.

In one subembodiment, the given value is the first target value, the first signaling is the first-type signaling, and the second reference value is a sum of the number of the first-type signalings and the number of the second-type signalings transmitted in the first time-frequency resource pool.

In one subembodiment, the given value is the first target value, the first signaling is the third-type signaling, and the second reference value is the number of the third-type signalings transmitted in the first time-frequency resource pool.

In one embodiment, the first signaling explicitly indicates the first radio resource block.

In one embodiment, the first signaling implicitly indicates the first radio resource block.

In one embodiment, the first signaling is used for indicating the first radio resource block from a first radio resource block set.

In one embodiment, the first signaling comprises a fourth field, and the fourth field in the first signaling indicates the first radio resource block.

In one embodiment, the first signaling comprises a fourth field, and the fourth field in the first signaling indicates an index of the first radio resource block in a first radio resource block set.

In one embodiment, the fourth field is a PUCCH resource indicator field.

In one embodiment, the specific definition of the PUCCH resource indicator field can be found in 3GPP TS38.212, section 7.3.1.2.

In one embodiment, the fourth field comprises a positive integer number of bit(s).

In one embodiment, the fourth field comprises 3 bits.

In one embodiment, the first radio resource block is a radio resource block in a first radio resource block set, the first radio resource block set is one of N radio resource block sets, and any one of the N radio resource block sets comprises a positive integer number of radio resource block(s), N being a positive integer greater than 1.

In one subembodiment, a number of bits comprised in the first information block set is used to determine the first radio resource block set out of the N radio resource block sets.

In one subembodiment, a number of bits comprised in the first information block subset in the present disclosure is used to determine the first radio resource block set out of the N radio resource block sets.

In one subembodiment, the N radio resource block sets respectively correspond to N value sets, any value in the N value sets belongs to only one value set of the N value sets, and any of the N value sets comprises a positive integer number of value(s), any value in the N value sets being a positive integer; a first value set is a value set to which a number of bits comprised by the first information block set belongs among the N value sets, and the first radio resource block set is one of the N radio resource block sets that corresponds to the first value set.

In one subembodiment, the N radio resource block sets respectively correspond to N value sets, any value in the N value sets belongs to only one value set of the N value sets, and any of the N value sets comprises a positive integer number of value(s), any value in the N value sets being a positive integer; a first value set is a value set to which a number of bits comprised by the first information block subset of the present disclosure belongs among the N value sets, and the first radio resource block set is one of the N radio resource block sets that corresponds to the first value set.

In one embodiment, the method in the first node also includes:

receiving first information;

herein, the first information indicates N radio resource block sets, and any of the N radio resource block sets comprises a positive integer number of radio resource block(s), N being a positive integer greater than 1; the first radio resource block is a radio resource block in the N radio resource block sets.

In one embodiment, the first information is semi-statically configured.

In one embodiment, the first information is carried by a higher layer signaling.

In one embodiment, the first information is carried by an RRC signaling.

In one embodiment, the first information is carried by a MAC CE signaling.

In one embodiment, the first information belongs to an IE in an RRC signaling.

In one embodiment, the first information comprises multiple IEs in an RRC signaling.

In one embodiment, the method in the second node also includes:

transmitting first information;

herein, the first information indicates N radio resource block sets, and any of the N radio resource block sets comprises a positive integer number of radio resource block(s), N being a positive integer greater than 1; the first radio resource block is a radio resource block in the N radio resource block sets.

In one embodiment, the first receiver also receives first information; herein, the first information indicates N radio resource block sets, and any of the N radio resource block sets comprises a positive integer number of radio resource block(s), N being a positive integer greater than 1; the first radio resource block is a radio resource block in the N radio resource block sets.

In one embodiment, the second transmitter also transmits first information; herein, the first information indicates N radio resource block sets, and any of the N radio resource block sets comprises a positive integer number of radio resource block(s), N being a positive integer greater than 1; the first radio resource block is a radio resource block in the N radio resource block sets.

In one embodiment, the second signaling is used for indicating SPS Release, and the HARQ-ACK associated with the second signaling indicates whether the second signaling is correctly received.

In one embodiment, the method in the first node also includes:

receiving a second bit block set;

herein, the second signaling comprises scheduling information of the second bit block set; the HARQ-ACK associated with the second signaling indicates whether each bit block in the second bit block set is correctly received.

In one embodiment, the method in the second node also includes:

transmitting a second bit block set;

herein, the second signaling comprises scheduling information of the second bit block set; the HARQ-ACK associated with the second signaling indicates whether each bit block in the second bit block set is correctly received.

In one embodiment, the second bit block set comprises a positive integer number of Transport Block(s) (TB(s)).

In one embodiment, the second bit block set comprises one TB.

In one embodiment, the second bit block set comprises a positive integer number of Code Block Group(s) (CBG(s)).

In one embodiment, the second bit block set comprises a positive integer number of bit(s).

In one embodiment, the scheduling information of the second bit block set comprises at least one of an occupied time-domain resource, an occupied frequency-domain resource, a Modulation and Coding Scheme (MCS), configuration information of DeModulation Reference Signals (DMRS), a Hybrid Automatic Repeat reQuest (HARQ) process ID, a Redundancy Version (RV), a New Data Indicator (NDI), or a transmission antenna port, or a corresponding Transmission Configuration Indicator (TCI) state.

In one subembodiment, the configuration information of DMRS comprises at least one of a Reference Signal (RS) sequence, a mapping mode, a DMRS type, an occupied time-domain resource, an occupied frequency-domain resource, occupied code-domain resource, a cyclic shift or an Orthogonal Cover Code (OCC).

In one embodiment, the HARQ-ACK associated with the second signaling indicates whether a bit block set scheduled by the second signaling is correctly received.

In one embodiment, the second signaling comprises a signaling used for scheduling a downlink physical layer data channel, and the HARQ-ACK associated with the second signaling indicates whether transmission of the downlink physical layer data channel scheduled by the second signaling is correctly received.

In one embodiment, the second signaling comprises a signaling used for scheduling a PDSCH, and the HARQ-ACK associated with the second signaling indicates whether transmission of the PDSCH scheduled by the second signaling is correctly received.

In one embodiment, the HARQ-ACK associated with the second signaling indicates whether the second signaling is correctly received.

In one embodiment, the second signaling comprises a signaling used for indicating SPS Release, and the HARQ-ACK associated with the second signaling indicates whether the second signaling is correctly received.

In one embodiment, the second signaling comprises a signaling used for scheduling SL transmission, and the HARQ-ACK associated with the second signaling indicates whether the SL transmission scheduled by the second signaling is correctly received.

In one embodiment, the second signaling comprises a signaling used for scheduling a Physical Sidelink Shared CHannel (PSSCH), and the HARQ-ACK associated with the second signaling indicates whether the PSSCH scheduled by the second signaling is correctly received.

In one embodiment, the second signaling indicates an SL time-frequency resource, and the HARQ-ACK associated with the second signaling indicates whether SL transmission on the SL time-frequency resource indicated by the second signaling is correctly received.

In one embodiment, the first signaling is the first-type signaling, and the number of the first-type signalings transmitted in the first time-frequency resource pool is equal to the L1 in the present disclosure.

In one embodiment, the first signaling is the third-type signaling, and the number of the third-type signalings transmitted in the first time-frequency resource pool is equal to the L1 in the present disclosure.

In one embodiment, a first information block comprises the HARQ-ACK associated with the first signaling, and the first information block is one of the L1 information blocks.

In one embodiment, a given information block is any one of the L1 information blocks, and a given signaling is one of the L1 signalings corresponding to the given information block, the given information block comprising a HARQ-ACK associated with the given signaling.

In one subembodiment, the given information block comprises Uplink Control Information (UCI).

In one subembodiment, the given information block comprises a HARQ-ACK.

In one subembodiment, the HARQ-ACK associated with the given signaling indicates whether a bit block set scheduled by the given signaling is correctly received.

In one subembodiment, the given signaling comprises a signaling used for scheduling of a downlink physical layer data channel, and the HARQ-ACK associated with the given signaling indicates whether transmission of the downlink physical layer data channel scheduled by the given signaling is correctly received.

In one subembodiment, the given signaling comprises a signaling used for scheduling of a PDSCH, and the HARQ-ACK associated with the given signaling indicates whether transmission of the PDSCH scheduled by the given signaling is correctly received.

In one subembodiment, the HARQ-ACK associated with the given signaling indicates whether the given signaling is correctly received.

In one subembodiment, the given signaling is used for indicating SPS Release, and the HARQ-ACK associated with the given signaling indicates whether the given signaling is correctly received.

In one embodiment, the phrase that the first signaling is a last one of the L1 signalings means that by arranging the L1 signalings in an order according to a first rule, the first signaling is a signaling ranking last among the L1 signalings.

In one embodiment, the phrase that the first signaling is a last one of the L1 signalings means that by indexing the L1 signalings according to a first rule, the first signaling is a signaling with a largest index among the L1 signalings.

In one embodiment, the second radio resource block comprises a time-domain resource, a frequency-domain resource and a code-domain resource.

In one embodiment, the second radio resource block comprises a time-domain resource and a frequency-domain resource.

In one embodiment, the second radio resource block comprises a positive integer number of RE(s).

In one embodiment, the second radio resource block comprises a positive integer number of subcarrier(s) in frequency domain.

In one embodiment, the second radio resource block comprises a positive integer number of RB(s) in frequency domain.

In one embodiment, the second radio resource block comprises a positive integer number of multicarrier symbol(s) in time domain.

In one embodiment, the second radio resource block belongs to a time unit in time domain.

In one embodiment, the second radio resource block is configured by a higher layer signaling.

In one embodiment, the second radio resource block is configured by an RRC signaling.

In one embodiment, the second radio resource block is configured by a MAC CE signaling.

In one embodiment, the second radio resource block is preconfigured.

In one embodiment, the second radio resource block comprises a PUCCH resource.

In one embodiment, the second radio resource block is reserved for a PUCCH.

In one embodiment, the second radio resource block is reserved for transmission of the second information block subset.

In one embodiment, the second signaling is used for indicating a second radio resource block, the second radio resource block being reserved for the second information block subset.

In one embodiment, the first signaling is the first-type signaling, and the first information bock set comprises the first information block subset and the second information block subset; the first node drops transmitting the second information block subset in the second radio resource block.

In one embodiment, the first radio resource block and the second radio resource block belong to a same time unit in time domain.

In one embodiment, the second radio resource block and the first radio resource block are orthogonal in time domain.

In one embodiment, the second signaling explicitly indicates the second radio resource block.

In one embodiment, the second signaling implicitly indicates the second radio resource block.

In one embodiment, the second signaling indicates the second radio resource block in a second radio resource block set.

In one embodiment, the second signaling comprises a fourth field, and the fourth field in the second signaling indicates the second radio resource block.

In one embodiment, the second signaling comprises a fourth field, and the fourth field in the second signaling indicates an index of the second radio resource block in a second radio resource block set.

In one embodiment, the second radio resource is a radio resource block in a second radio resource block set, the second radio resource block set is one of N radio resource block sets, and any of the N radio resource block sets comprises a positive integer number of radio resource block(s), N being a positive integer greater than 1.

In one subembodiment, a number of bits comprised in the second information block subset in the present disclosure is used for determining the second radio resource block set out of the N radio resource block sets.

In one subembodiment, the N radio resource block sets respectively correspond to N value sets, any value in the N value sets belongs to only one value set of the N value sets, and any of the N value sets comprises a positive integer number of value(s), any value in the N value sets being a positive integer; a second value set is a value set to which a number of bits comprised by the second information block set belongs among the N value sets, and the second radio resource block set is one of the N radio resource block sets that corresponds to the second value set.

In one subembodiment, the N radio resource block sets respectively correspond to N value sets, any value in the N value sets belongs to only one value set of the N value sets, and any of the N value sets comprises a positive integer number of value(s), any value in the N value sets being a positive integer; a second value set is a value set to which a number of bits comprised by the second information block subset of the present disclosure belongs among the N value sets, and the second radio resource block set is one of the N radio resource block sets that corresponds to the second value set.

In one embodiment, the second signaling is a second-type signaling, and the number of the second-type signalings transmitted in the first time-frequency resource pool is equal to the L2 in the present disclosure.

In one embodiment, a second information block comprises the HARQ-ACK associated with the second signaling, and the second information block is one of the L2 information blocks.

In one embodiment, a given information block is any one of the L2 information blocks, and a given signaling is one of the L2 signalings corresponding to the given information block, the given information block comprising a HARQ-ACK associated with the given signaling.

In one subembodiment, the given information block comprises Uplink Control Information (UCI).

In one subembodiment, the given information block comprises a HARQ-ACK.

In one subembodiment, the HARQ-ACK associated with the given signaling indicates whether a bit block set scheduled by the given signaling is correctly received.

In one subembodiment, the given signaling comprises a signaling used for scheduling of a downlink physical layer data channel, and the HARQ-ACK associated with the given signaling indicates whether transmission of the downlink physical layer data channel scheduled by the given signaling is correctly received.

In one subembodiment, the given signaling comprises a signaling used for scheduling of a PDSCH, and the HARQ-ACK associated with the given signaling indicates whether transmission of the PDSCH scheduled by the given signaling is correctly received.

In one subembodiment, the HARQ-ACK associated with the given signaling indicates whether the given signaling is correctly received.

In one subembodiment, the given signaling is used for indicating SPS Release, and the HARQ-ACK associated with the given signaling indicates whether the given signaling is correctly received.

In one embodiment, the phrase that the second signaling is a last one of the L2 signalings means that by arranging the L2 signalings in an order according to a first rule, the second signaling is a signaling ranking last among the L2 signalings.

In one embodiment, the phrase that the second signaling is a last one of the L2 signalings means that by indexing the L2 signalings according to a first rule, the second signaling is a signaling with a largest index among the L2 signalings.

In one embodiment, a bit block set comprises a positive integer number of bit block(s), of which each bit block comprises a positive integer number of bit(s).

### Embodiment 5C

Embodiment 5C illustrates a schematic diagram of a second node and a third node according to one embodiment of the present disclosure, as shown in FIG. 5C.

The second node (550C) comprises a controller/processor 590C, a data source/memory 580C, a receiving processor 552C, a transmitter/receiver 556C and a transmitting processor 555C, the transmitter/receiver 556C comprising an antenna 560C.

The third node (500C) comprises a controller/processor 540C, a data source/memory 530C, a receiving processor 512C, a transmitter/receiver 516C and a transmitting processor 515C, the transmitter/receiver 516C comprising an antenna 520C.

In Sidelink (SL) transmission from the third node 500C to the second node 550C, at the third node 500C, a higher-layer packet is provided to the controller/processor 540C. The controller/processor 540C provides functions of the L2, the V2X layer and layers above. In the SL transmission, the controller/processor 540C provides header compression, encryption, packet segmentation and reordering, and multiplexing between logical channels and transport channels. The controller/processor 540C is also responsible for HARQ operation (if supportable), repeated transmissions and a signaling to the second node 550C. The transmitting processor 515C implements signal processing functions used for the L1 (that is, PHY), including coding, interleaving, scrambling, modulation, power control/allocation, precoding and physical layer control signaling generation. The generated modulation symbols are divided into parallel streams and each stream is mapped to a corresponding multicarrier subcarrier and/or multicarrier symbol, which is then mapped from the transmitting processor 515C to the antenna 520C through the transmitter 516C to be transmitted in the form of a radio frequency signal.

In Sidelink (SL) transmission from the third node 500C to the second node 550C, at the second node 550C, each receiver 556C receives a radio frequency signal via a corresponding antenna 560C, and then recovers baseband information modulated onto a radio frequency carrier, and provides the baseband information to the receiving processor 552C. The receiving processor 552C provides signal receiving processing functions of the L1. The signal receiving processing functions include receiving of a physical layer signal, performing demodulation of multicarrier symbols in multicarrier symbol streams based on different modulation schemes (e.g., BPSK, QPSK), and then de-scrambling, decoding and de-interleaving so as to recover data or control signal transmitted by the third node 500C on a physical channel. Afterwards the data and control signal are provided to the controller/processor 590C. The controller/processor 590C is in charge of functionality of the L2, the V2X layer and above layers. The controller/processor can be associated with the memory 580C that stores program codes and data. The memory 580C can be called a computer readable medium.

In SL transmission from the second node 550C to the third node 500C, at the second node 550C, the higher layer data is provided to the controller/processor 590C. The controller/processor 590C provides functions of the L2, the V2X layer and above layers. The controller/processor 590C provides header compression, encryption, packet segmentation and reordering as well as multiplexing between logical channels and transport channels. The controller/processor 590C is also responsible for HARQ operation (if supportable), repeated transmissions, and a signaling to the third node 500C. The transmitting processor 555C provides signal transmitting processing functions of the L1 (that is, PHY), including coding, interleaving, scrambling, modulation, power control/allocation, precoding and physical layer control signaling generation. The generated modulation symbols are divided into parallel streams and each stream is mapped to a corresponding multicarrier subcarrier and/or multicarrier symbol, which is then mapped from the transmitting processor 555C to the antenna 560C through the transmitter 556C in the form of a radio frequency signal.

In SL transmission from the second node 550C to the third node 500C, at the third node 500C, each receiver 516C receives a radio frequency signal via a corresponding antenna 520C, and then recovers baseband information modulated onto a radio frequency carrier, and provides the baseband information to the receiving processor 512C. The receiving processor 512C provides signal receiving processing functions of the L1 (that is, PHY). The signal receiving processing functions include receiving of a physical layer signal, performing demodulation of multicarrier symbols in multicarrier symbol streams based on different modulation schemes (e.g., BPSK, QPSK), and then de-scrambling, decoding and de-interleaving so as to recover data or control signal transmitted by the second node 550C on a physical channel. Afterwards the data and control signal are provided to the controller/processor 540C. The controller/processor 540C is in charge of functionality of the L2, the V2X layer and above layers. The controller/processor can be associated with the memory 530C that stores program codes and data. The memory 530C can be called a computer readable medium.

In one embodiment, the third node 500C is a base station supporting V2X.

In one embodiment, the third node 500C is a UE.

In one embodiment, the third node 500C is a UE supporting V2X.

In one embodiment, the third node 500C is a UE supporting D2D.

In one embodiment, the third node 500C is vehicle-mounted equipment.

In one embodiment, the third node 500C is an RSU.

In one embodiment, the transmitter 556C (comprising the antenna 560C), the transmitting processor 555C and the controller/processor 590C are used for transmitting the fourth information set in the present disclosure.

In one embodiment, the receiver 516C (comprising the antenna 520C), the receiving processor 512C and the controller/processor 540C are used for receiving the fourth information set in the present disclosure.

### Embodiment 6A

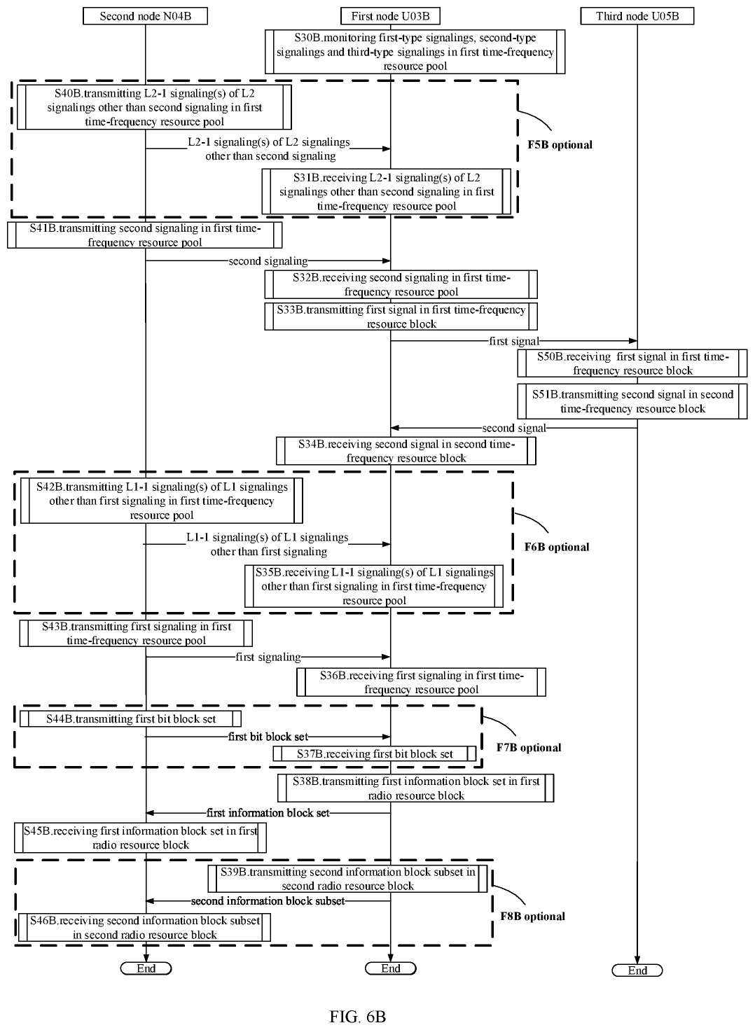

Embodiment 6A illustrates a flowchart of radio signal transmission according to one embodiment of the present disclosure, as shown in FIG. 6A. In FIG. 6A, a first node U3A is in communication with other communication nodes via an air interface. Steps marked by a box F2A and a box F3A in the FIG. 6A are optional, respectively.

The first node U3A monitors a second signaling in a first target time-frequency resource group in step S31A; and monitors a third signaling in a second target time-frequency resource group in step S32A; makes a measurement on the first target time-frequency resource group in step S33A to be used to determine whether a first candidate time-frequency resource block belongs to a candidate resource pool; and makes a measurement on the second target time-frequency resource group in step S34A to be used to determine whether a second candidate time-frequency resource block belongs to a candidate resource pool.

In Embodiment 6A, the second signaling indicates the first target time-frequency resource group, while the third signaling indicates the second target time-frequency resource group; both the first target time-frequency resource group and the second target time-frequency resource group belong to a first sensing window in time domain; the first target time-frequency resource group comprises T1 time-frequency resource block(s), and each of the T1 time-frequency resource block(s) comprised by the first target time-frequency resource group comprises the first candidate sub-channel in frequency domain, T1 being a positive integer; the second target time-frequency resource group comprises T2 time-frequency resource block(s), and each of the T2 time-frequency resource block(s) comprised by the second target time-frequency resource group comprises the second candidate sub-channel in frequency domain, T2 being a positive integer; frequency-domain resources occupied by the first candidate time-frequency resource block and frequency-domain resources occupied by the first target time-frequency resource group are the same; frequency-domain resources occupied by the second candidate time-frequency resource block and frequency-domain resources occupied by the second target time-frequency resource group are the same; the candidate resource pool comprises a positive integer number of time-frequency resource block(s), and any time-frequency resource block comprised in the candidate resource pool is later than the first sensing window in time domain, and the time-frequency resource occupied by the first signal indicated by the first signaling belongs to the candidate resource pool.

In one embodiment, the first target time-frequency resource group comprises multiple REs.

In one embodiment, the first target time-frequency resource group occupies a positive integer number of slot(s) in time domain.

In one embodiment, the first target time-frequency resource group comprises a slot in time domain.

In one embodiment, the first target time-frequency resource group comprises multiple slots in time domain.

In one embodiment, the first target time-frequency resource group occupies a positive integer number of multicarrier symbol(s) in time domain.

In one embodiment, the first target time-frequency resource group comprises a multicarrier symbol in time domain.

In one embodiment, the first target time-frequency resource group comprises multiple multicarrier symbols in time domain.

In one embodiment, the first target time-frequency resource group occupies a positive integer number of PRB(s) in frequency domain.

In one embodiment, the first target time-frequency resource group comprises a PRB in frequency domain.

In one embodiment, the first target time-frequency resource group occupies a positive integer number of subcarrier(s) in frequency domain.

In one embodiment, the first target time-frequency resource group comprises T1 time-frequency resource block(s), and any time-frequency resource block of the T1 time-frequency resource block(s) comprised by the first target time-frequency resource group comprises multiple REs, T1 being a positive integer.

In one embodiment, when T1 is greater than 1, the T1 time-frequency resource blocks comprised by the first target time-frequency resource group are orthogonal in time domain.

In one embodiment, when T1 is greater than 1, the T1 time-frequency resource blocks comprised by the first target time-frequency resource group are Time-Division Multiplexing (TDM).

In one embodiment, the T1 time-frequency resource blocks comprised by the first target time-frequency resource group respectively occupy T1 slots in time domain.

In one embodiment, the T1 time-frequency resource blocks comprised by the first target time-frequency resource group respectively occupy T1 multicarrier symbols in time domain.

In one embodiment, the T1 time-frequency resource blocks comprised by the first target time-frequency resource group respectively occupy T1 time-domain resource blocks in time domain.

In one subembodiment, the T1 time-domain resource blocks are T1 slots respectively.

In one subembodiment, the T1 time-domain resource blocks are T1 multicarrier symbols respectively.

In one embodiment, any of the T1 time-frequency resource blocks comprised by the first target time-frequency resource group occupies a positive integer number of PRB(s) in frequency domain.

In one embodiment, any of the T1 time-frequency resource blocks comprised by the first target time-frequency resource group occupies a positive integer number of sub-channel(s) in frequency domain.

In one embodiment, at least two of the T1 time-frequency resource blocks comprised by the first target time-frequency resource group occupy a same frequency-domain resource.

In one embodiment, any two of the T1 time-frequency resource blocks comprised by the first target time-frequency resource group occupy a same frequency-domain resource.

In one embodiment, each of the T1 time-frequency resource blocks comprised by the first target time-frequency resource group occupies a positive integer number of sub-channel(s) in frequency domain.

In one embodiment, each of the T1 time-frequency resource blocks comprised by the first target time-frequency resource group occupies a positive integer number of sub-channel(s) in frequency domain, and the first candidate sub-channel is a sub-channel of the positive integer number of sub-channel(s) occupied by any of the T1 time-frequency resource blocks comprised by the first target time-frequency resource group in frequency domain.

In one embodiment, each of the T1 time-frequency resource blocks comprised by the first target time-frequency resource group comprises the first candidate sub-channel in frequency domain.

In one embodiment, any of the T1 time-frequency resource blocks comprised by the first target time-frequency resource group comprises the first candidate sub-channel in frequency domain.

In one embodiment, each of the T1 time-frequency resource blocks comprised by the first target time-frequency resource group belongs to the first candidate sub-channel in frequency domain.

In one embodiment, a channel occupied by the first target time-frequency resource group includes a PSCCH.

In one embodiment, a channel occupied by the first target time-frequency resource group includes a PSSCH.

In one embodiment, the second target time-frequency resource group comprises multiple REs.

In one embodiment, the second target time-frequency resource group occupies a positive integer number of slot(s) in time domain.

In one embodiment, the second target time-frequency resource group comprises a slot in time domain.

In one embodiment, the second target time-frequency resource group comprises multiple slots in time domain.

In one embodiment, the second target time-frequency resource group occupies a positive integer number of multicarrier symbol(s) in time domain.

In one embodiment, the second target time-frequency resource group comprises a multicarrier symbol in time domain.

In one embodiment, the second target time-frequency resource group comprises multiple multicarrier symbols in time domain.

In one embodiment, the second target time-frequency resource group occupies a positive integer number of PRB(s) in frequency domain.

In one embodiment, the second target time-frequency resource group comprises a PRB in frequency domain.

In one embodiment, the second target time-frequency resource group occupies a positive integer number of subcarrier(s) in frequency domain.

In one embodiment, the second target time-frequency resource group comprises T2 time-frequency resource block(s), and any time-frequency resource block of the T2 time-frequency resource block(s) comprised by the second target time-frequency resource group comprises multiple REs, T2 being a positive integer.

In one embodiment, when T2 is greater than 1, the T2 time-frequency resource blocks comprised by the second target time-frequency resource group are orthogonal in time domain.

In one embodiment, when T2 is greater than 1, the T2 time-frequency resource blocks comprised by the second target time-frequency resource group are TDM.

In one embodiment, the T2 time-frequency resource blocks comprised by the second target time-frequency resource group respectively occupy T2 slots in time domain.

In one embodiment, the T2 time-frequency resource blocks comprised by the second target time-frequency resource group respectively occupy T2 multicarrier symbols in time domain.

In one embodiment, the T2 time-frequency resource blocks comprised by the second target time-frequency resource group respectively occupy T2 time-domain resource blocks in time domain.

In one subembodiment, the T2 time-domain resource blocks are T2 slots respectively.

In one subembodiment, the T2 time-domain resource blocks are T2 multicarrier symbols respectively.

In one embodiment, any of the T2 time-frequency resource blocks comprised by the second target time-frequency resource group occupies a positive integer number of PRB(s) in frequency domain.

In one embodiment, any of the T2 time-frequency resource blocks comprised by the second target time-frequency resource group occupies a positive integer number of sub-channel(s) in frequency domain.

In one embodiment, at least two of the T2 time-frequency resource blocks comprised by the second target time-frequency resource group occupy a same frequency-domain resource.

In one embodiment, any two of the T2 time-frequency resource blocks comprised by the second target time-frequency resource group occupy a same frequency-domain resource.

In one embodiment, each of the T2 time-frequency resource blocks comprised by the second target time-frequency resource group occupies a positive integer number of sub-channel(s) in frequency domain.

In one embodiment, each of the T2 time-frequency resource blocks comprised by the second target time-frequency resource group occupies a positive integer number of sub-channel(s) in frequency domain, and the second candidate sub-channel is a sub-channel of the positive integer number of sub-channel(s) occupied by any of the T2 time-frequency resource blocks comprised by the second target time-frequency resource group in frequency domain.

In one embodiment, each of the T2 time-frequency resource blocks comprised by the second target time-frequency resource group comprises the second candidate sub-channel in frequency domain.

In one embodiment, any of the T2 time-frequency resource blocks comprised by the second target time-frequency resource group comprises the second candidate sub-channel in frequency domain.

In one embodiment, each of the T2 time-frequency resource blocks comprised by the second target time-frequency resource group belongs to the second candidate sub-channel in frequency domain.

In one embodiment, a channel occupied by the second target time-frequency resource group includes a PSCCH.

In one embodiment, a channel occupied by the second target time-frequency resource group includes a PSSCH.

In one embodiment, time-domain resources comprised by the second target time-frequency resource group and time-domain resources comprised by the first target time-frequency resource group are the same.

In one embodiment, a time-domain resource occupied by at least one of the T2 time-frequency resource blocks comprised by the second target time-frequency resource group is the same as a time-domain resource occupied by one of the T1 time-frequency resource blocks comprised by the first target time-frequency resource group.

In one embodiment, a slot occupied by at least one of the T2 time-frequency resource blocks comprised by the second target time-frequency resource group in time domain is the same as a slot occupied by one of the T1 time-frequency resource blocks comprised by the first target time-frequency resource group in time domain.

In one embodiment, a positive integer number of multicarrier symbol(s) occupied by at least one of the T2 time-frequency resource blocks comprised by the second target time-frequency resource group in time domain is(are) the same as a positive integer number of multicarrier symbol(s) occupied by one of the T1 time-frequency resource blocks comprised by the first target time-frequency resource group in time domain.

In one embodiment, the T2 time-frequency resource blocks comprised by the second target time-frequency resource group and the T1 time-frequency resource blocks comprised by the first target time-frequency resource group are overlapping in frequency domain.

In one embodiment, a frequency-domain resource occupied by one of the T2 time-frequency resource blocks comprised by the second target time-frequency resource group and a frequency-domain resource occupied by one of the T1 time-frequency resource blocks comprised by the first target time-frequency resource group are the same.

In one embodiment, at least one of the T2 time-frequency resource blocks comprised by the second target time-frequency resource group is different from any of the T1 time-frequency resource blocks comprised by the first target time-frequency resource group are the same.

In one embodiment, the first target time-frequency resource group comprises the first candidate sub-channel in frequency domain, and the second target time-frequency resource group comprises the second candidate sub-channel in frequency domain.

In one embodiment, any of the T1 time-frequency resource blocks comprised by the first target time-frequency resource group comprises the first candidate sub-channel in frequency domain.

In one embodiment, any of the T2 time-frequency resource blocks comprised by the second target time-frequency resource group comprises the second candidate sub-channel in frequency domain.

In one embodiment, a frequency-domain resource occupied by one of T1 time-frequency resource blocks comprised by the first target time-frequency resource group in frequency domain is the same as the first candidate sub-channel.

In one embodiment, a sub-channel occupied by one of T1 time-frequency resource blocks comprised by the first target time-frequency resource group in frequency domain is the same as the first candidate sub-channel.

In one embodiment, at least one of T1 time-frequency resource blocks comprised by the first target time-frequency resource group in frequency domain belongs to the first candidate sub-channel.

In one embodiment, a sub-channel occupied by one of T2 time-frequency resource blocks comprised by the second target time-frequency resource group in frequency domain is the same as the second candidate sub-channel.

In one embodiment, at least one of T2 time-frequency resource blocks comprised by the second target time-frequency resource group in frequency domain is the same as the second candidate sub-channel.

In one embodiment, the second signaling comprises all or part of a higher layer signaling.

In one embodiment, the second signaling comprises all or part of an RRC layer signaling.

In one embodiment, the second signaling comprises all or part of a MAC layer signaling.

In one embodiment, the second signaling comprises one or more fields of a PHY layer signaling.

In one embodiment, the second signaling comprises a piece of SCI.

In one embodiment, the second signaling comprises a field of a piece of SCI.

In one embodiment, the second signaling comprises a 1^{st}-stage SCI format.

In one embodiment, the second signaling comprises a SCI format 0-1.

In one embodiment, the second signaling is used to indicate the first target time-frequency resource group.

In one embodiment, the second signaling is used to indicate time-frequency resources comprised by the first target time-frequency resource group.

In one embodiment, the second signaling is used to indicate time-domain resources comprised by the first target time-frequency resource group.

In one embodiment, the second signaling is used to indicate frequency-domain resources comprised by the first target time-frequency resource group.

In one embodiment, the second signaling is used to indicate the positive integer number of sub-channel(s) comprised by the first target time-frequency resource group in frequency domain.

In one embodiment, the second signaling is used to indicate slots comprised by the first target time-frequency resource group in time domain.

In one embodiment, the second signaling is used to schedule a radio signal transmitted in the first target time-frequency resource group.

In one embodiment, the second signaling is used to indicate priority of a radio signal transmitted in the first target time-frequency resource group.

In one embodiment, the second signaling is transmitted on a PC5.

In one embodiment, a channel occupied by the second signaling includes a PSCCH.

In one embodiment, the third signaling comprises all or part of a higher layer signaling.

In one embodiment, the third signaling comprises all or part of an RRC layer signaling.

In one embodiment, the third signaling comprises all or part of a MAC layer signaling.

In one embodiment, the third signaling comprises one or more fields of a PHY layer signaling.

In one embodiment, the third signaling comprises a piece of SCI.

In one embodiment, the third signaling comprises a field of a piece of SCI.

In one embodiment, the third signaling comprises a 1^{st}-stage SCI format.

In one embodiment, the third signaling comprises a SCI format 0-1.

In one embodiment, the third signaling is used to indicate the second target time-frequency resource group.

In one embodiment, the third signaling is used to indicate time-frequency resources comprised by the second target time-frequency resource group.

In one embodiment, the third signaling is used to indicate time-domain resources comprised by the second target time-frequency resource group.

In one embodiment, the third signaling is used to indicate frequency-domain resources comprised by the second target time-frequency resource group.

In one embodiment, the third signaling is used to indicate the positive integer number of sub-channel(s) comprised by the second target time-frequency resource group in frequency domain.

In one embodiment, the third signaling is used to indicate slots comprised by the second target time-frequency resource group in time domain.

In one embodiment, the third signaling is used to schedule a radio signal transmitted in the second target time-frequency resource group.

In one embodiment, the third signaling is used to indicate priority of a radio signal transmitted in the second target time-frequency resource group.

In one embodiment, the third signaling is transmitted on a PC5.

In one embodiment, a channel occupied by the third signaling includes a PSCCH.

In one embodiment, monitoring the second signaling in the first target time-frequency resource group refers to receiving based on blind detection, namely, the first node U3A receives a signal in the first target time-frequency resource group and performs decoding operation, if the decoding is determined to be correct according to a CRC bit, it is determined that the second signaling is received successfully in the first target time-frequency resource group; otherwise, the second signaling is not successfully detected in the first target time-frequency resource group.

In one embodiment, monitoring the second signaling in the first target time-frequency resource group refers to receiving based on coherent detection, namely, the first node U3A performs coherent reception on a radio signal employing an RS sequence corresponding to DMRS of the second signaling in the first target time-frequency resource group, and measures energy of a signal obtained by the coherent reception; if the energy of the signal obtained by the coherent reception is greater than a first given threshold, it is determined that the second signaling is received successfully in the first target time-frequency resource group; otherwise, the second signaling is not successfully detected in the first target time-frequency resource group.

In one embodiment, monitoring the second signaling in the first target time-frequency resource group refers to receiving based on energy detection, namely, the first node U3A senses energy of a radio signal in the first target time-frequency resource group and averages in time to acquire a received energy; if the received energy is greater than a second given threshold, it is determined that the second signaling is received successfully in the first target time-frequency resource group; otherwise, the second signaling is not successfully detected in the first target time-frequency resource group.

In one embodiment, the phrase that the second signaling is detected means that after the second signaling is received based on blind detection, it is determined according to a CRC bit that decoding is correct.

In one embodiment, monitoring the third signaling in the second target time-frequency resource group refers to receiving based on blind detection, namely, the first node U3A receives a signal in the second target time-frequency resource group and performs decoding operation, if the decoding is determined to be correct according to a CRC bit, it is determined that the third signaling is received successfully in the second target time-frequency resource group; otherwise, the third signaling is not successfully detected in the second target time-frequency resource group.

In one embodiment, monitoring the third signaling in the second target time-frequency resource group refers to receiving based on coherent detection, namely, the first node U3A performs coherent reception on a radio signal employing an RS sequence corresponding to DMRS of the third signaling in the second target time-frequency resource group, and measures energy of a signal obtained by the coherent reception; if the energy of the signal obtained by the coherent reception is greater than a first given threshold, it is determined that the third signaling is received successfully in the second target time-frequency resource group; otherwise, the third signaling is not successfully detected in the second target time-frequency resource group.

In one embodiment, monitoring the third signaling in the second target time-frequency resource group refers to receiving based on energy detection, namely, the first node U3A senses energy of a radio signal in the second target time-frequency resource group and averages in time to acquire a received energy; if the received energy is greater than a second given threshold, it is determined that the third signaling is received successfully in the second target time-frequency resource group; otherwise, the third signaling is not successfully detected in the second target time-frequency resource group.

In one embodiment, the phrase that the third signaling is detected means that after the third signaling is received based on blind detection, it is determined according to a CRC bit that decoding is correct.

In one embodiment, the first sensing window comprises a positive integer number of time-domain resource(s).

In one embodiment, the positive integer number of time-domain resource(s) comprised by the first sensing window is(are) a positive integer number of slot(s) respectively.

In one embodiment, the positive integer number of time-domain resource(s) comprised by the first sensing window is(are) a positive integer number of subframe(s) respectively.

In one embodiment, a time interval between an end time of the first sensing window and a start time of an earliest multicarrier symbol comprised by the candidate resource pool in time domain is equal to a duration of T0 slot(s), T0 being a positive integer; any of the T0 slot(s) is a slot comprised in the first resource pool.

In one embodiment, any time-domain resource of T1 time-domain resource(s) occupied by the T1 time-frequency resource block(s) in the first target time-frequency resource group is one of the positive integer number of time-domain resource(s) comprised by the first sensing window.

In one embodiment, any time-domain resource of T2 time-domain resource(s) occupied by the T2 time-frequency resource block(s) in the second target time-frequency resource group is one of the positive integer number of time-domain resource(s) comprised by the first sensing window.

In one embodiment, at least one time-domain resource of T1 time-domain resource(s) occupied by the T1 time-frequency resource block(s) in the first target time-frequency resource group is the same as a time-domain resource of T2 time-domain resource(s) occupied by the T2 time-frequency resource block(s) in the second target time-frequency resource group.

In one embodiment, T1 time-domain resource(s) occupied by the T1 time-frequency resource block(s) in the first target time-frequency resource group is(are) the same as T2 time-domain resource(s) occupied by the T2 time-frequency resource block(s) in the second target time-frequency resource group, T1 being equal to T2.

In one embodiment, at least one time-domain resource of T1 time-domain resource(s) occupied by the T1 time-frequency resource block(s) in the first target time-frequency resource group is different from a time-domain resource of T2 time-domain resource(s) occupied by the T2 time-frequency resource block(s) in the second target time-frequency resource group.

In one embodiment, the candidate resource pool comprises a positive integer number of time-frequency resource block(s), and each time-frequency resource block in the candidate resource pool belongs to the first resource pool.

In one embodiment, any of the positive integer number of time-frequency resource block(s) comprised by the candidate resource pool is later than an end time of the first sensing window in time domain.

In one embodiment, a start time of any of the positive integer number of time-frequency resource block(s) comprised by the candidate resource pool in time domain is later than an end time of the first sensing window.

In one embodiment, a time-frequency resource occupied by the first signal belongs to the candidate resource pool.

In one embodiment, a time-frequency resource occupied by the first signal belongs to the positive integer number of time-frequency resource block(s) comprised by the candidate resource pool.

In one embodiment, the first node U3A autonomously selects a time-frequency resource occupied by the first signal from the positive integer number of time-frequency resource block(s) comprised by the candidate resource pool.

In one embodiment, the first node U3A autonomously determines a time-frequency resource occupied by the first signal out of the positive integer number of time-frequency resource block(s) comprised by the candidate resource pool.

In one embodiment, the first candidate time-frequency resource block is one of the multiple time-frequency resource blocks comprised by the first resource pool.

In one embodiment, the second candidate time-frequency resource block is one of the multiple time-frequency resource blocks comprised by the first resource pool.

In one embodiment, the first candidate time-frequency resource block corresponds to the first target time-frequency resource group, while the second candidate time-frequency resource block corresponds to the second target time-frequency resource group.

In one embodiment, frequency-domain resources occupied by the first candidate time-frequency resource block are the same as frequency-domain resources occupied by the first target time-frequency resource group, and time-domain resources occupied by the first candidate time-frequency resource block are later than the first target time-frequency resource group in time domain.

In one embodiment, frequency-domain resources occupied by the first candidate time-frequency resource block are the same as frequency-domain resources occupied by the first target time-frequency resource group, and time-domain resources occupied by the first candidate time-frequency resource block are later than any time-domain resource in the first target time-frequency resource group in time domain.

In one embodiment, frequency-domain resources occupied by the second candidate time-frequency resource block are the same as frequency-domain resources occupied by the second target time-frequency resource group, and time-domain resources occupied by the second candidate time-frequency resource block are later than the second target time-frequency resource group in time domain.

In one embodiment, frequency-domain resources occupied by the second candidate time-frequency resource block are the same as frequency-domain resources occupied by the second target time-frequency resource group, and time-domain resources occupied by the second candidate time-frequency resource block are later than any time-domain resource in the second target time-frequency resource group in time domain.

In one embodiment, the second signaling and the first signaling are jointly used for determining a first threshold.

In one embodiment, the second signaling indicates priority of a radio signal transmitted on the first target time-frequency resource group, the first signaling indicates priority of the first signal, and the priority of the radio signal transmitted on the first target time-frequency resource group and the priority of the first signal are jointly used for determining a first threshold.

In one embodiment, priority of a radio signal transmitted on the first target time-frequency resource group is one of P positive integer(s), P being a positive integer.

In one embodiment, the third signaling and the first signaling are jointly used for determining a second threshold.

In one embodiment, the third signaling indicates priority of a radio signal transmitted on the second target time-frequency resource group, the first signaling indicates priority of the first signal, and the priority of the radio signal transmitted on the second target time-frequency resource group and the priority of the first signal are jointly used for determining a second threshold.

In one embodiment, priority of a radio signal transmitted on the second target time-frequency resource group is one of P positive integer(s), P being a positive integer.

In one embodiment, when a measurement on the first target time-frequency resource group is higher than a first threshold, the first candidate time-frequency resource block is ruled out from the candidate resource pool.

In one embodiment, when a measurement on the first target time-frequency resource group is higher than a first threshold, the first candidate time-frequency resource block is different from any time-frequency resource block in the candidate resource pool.

In one embodiment, when a measurement on the second target time-frequency resource group is higher than a second threshold, the second candidate time-frequency resource block is ruled out from the candidate resource pool.

In one embodiment, when a measurement on the second target time-frequency resource group is higher than a second threshold, the second candidate time-frequency resource block is different from any time-frequency resource block in the candidate resource pool.

In one embodiment, a measurement on the first target time-frequency resource group is PSSCH-Reference Signal Receiving Power (PSSCH-RSRP).

In one embodiment, a measurement on the first target time-frequency resource group is PSCCH-Reference Signal Receiving Power (PSCCH-RSRP).

In one embodiment, a measurement on the first target time-frequency resource group is Reference Signal Receiving Power (RSRP) of DMRS of a PSSCH.

In one embodiment, a measurement on the first target time-frequency resource group is filtered Reference Signal Receiving Power (filtered RSRP) of a filter.

In one embodiment, a measurement on the first target time-frequency resource group is Layer-1 filtered Reference Signal Receiving Power (L1-filtered RSRP).

In one embodiment, a measurement on the first target time-frequency resource group is Layer-3 filtered Reference Signal Receiving Power (L3-filtered RSRP).

In one embodiment, a measurement on the first target time-frequency resource group is Received Signal Strength Indication (RSSI).

In one embodiment, a measurement on the second target time-frequency resource group is PSSCH-RSRP.

In one embodiment, a measurement on the second target time-frequency resource group is PSCCH-RSRP.

In one embodiment, a measurement on the second target time-frequency resource group is RSRP of DMRS of a PSSCH.

In one embodiment, a measurement on the second target time-frequency resource group is filtered RSRP of a filter.

In one embodiment, a measurement on the second target time-frequency resource group is L1-filtered RSRP.

In one embodiment, a measurement on the second target time-frequency resource group is L3-filtered RSRP.

In one embodiment, a measurement on the second target time-frequency resource group is RSSI.

### Embodiment 6B

Embodiment 6B illustrates a flowchart of radio signal transmission according to another embodiment of the present disclosure, as shown in FIG. 6B. In FIG. 6B, a first node U03B, a second node N04B and a third node U05B communication with one another via an air interface. In FIG. 6B, dotted-line framed boxes F5B, F6B, F7B and F8B are optional. In FIG. 6B, each box represents a step. It should be particularly noted that the sequence of boxes arranged herein does not imply a chronological order of steps respectively represented.

The first node U03B monitors first-type signalings, second-type signalings and third-type signalings in a first time-frequency resource pool in step S30B; receives L2-1 signaling(s) of L2 signalings other than a second signaling in the first time-frequency resource pool in step S31B; and receives the second signaling in the first time-frequency resource pool in step S32B; transmits a first signal in a first time-frequency resource block in step.

S33B; and receives a second signal in a second time-frequency resource block in step S34B; receives L1-1 signaling(s) of L1 signalings other than a first signaling in the first time-frequency resource pool in step S35B; and receives the first signaling in the first time-frequency resource pool in step S36B; receives a first bit block set in step S37B; transmits a first information block set in a first radio resource block in step S38B; and transmits a second information block subset in a second radio resource block in step S39B.

The second node N04B transmits L2-1 signaling(s) of L2 signalings other than a second signaling in a first time-frequency resource pool in step S40B; and transmits the second signaling in the first time-frequency resource pool in step S41B; transmits L1-1 signaling(s) of L1 signalings other than a first signaling in the first time-frequency resource pool in step S42B; and transmits the first signaling in the first time-frequency resource pool in step S43B; transmits a first bit block set in step S44B; receives a first information block set in a first radio resource block in step S45B; and receives a second information block subset in a second radio resource block in step S46B.

The third node U05B receives a first signal in a first time-frequency resource block in step S50B; and transmits a second signal in a second time-frequency resource block in step S51B.

In Embodiment 6B, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool. The second signaling is a second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset. The first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings. When the first signaling is the third-type signaling, the second signaling is used to indicate the second radio resource block, the second radio resource block being orthogonal to the first radio resource block in time domain. The second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings. The first signaling comprises scheduling information of the first bit block set; the HARQ-ACK associated with the first signaling indicates whether each bit block in the first bit block set is correctly received. The second signaling is used to indicate the first time-frequency resource block, the HARQ-ACK associated with the second signaling indicates whether the first signal is correctly received by a target receiver of the first signal, and the second signal indicates whether the first signal is correctly received by the transmitter of the second signal; the target receiver of the first signal is different from a transmitter of the second signaling, the target receiver of the first signal including the transmitter of the second signal.

In one embodiment, the first signaling is the third-type signaling, the second signaling is used to indicate the second radio resource block, the second radio resource block being orthogonal to the first radio resource block in time domain, and the box F8B exists.

In one embodiment, the first signaling is the first-type signaling, and the box F8B does not exist.

In one embodiment, when the first signaling is the first-type signaling, a number of the first-type signalings and a number of the second-type signalings transmitted in the first time-frequency resource pool are jointly used by the second node N04B for determining the first target value; when the first signaling is the third-type signaling, a number of the third-type signalings transmitted in the first time-frequency resource pool is used by the second node N04B for determining the first target value.

In one embodiment, when the first signaling is the first-type signaling, a number of the first-type signalings and a number of the second-type signalings transmitted in the first time-frequency resource pool are jointly used by the first node U03B for determining the first target value; when the first signaling is the third-type signaling, a number of the third-type signalings transmitted in the first time-frequency resource pool is used by the first node U03B for determining the first target value.

In one embodiment, the method in the first node also includes:

transmitting a first signal in a first time-frequency resource block; and

receiving a second signal in a second time-frequency resource block;

herein, the second signaling is used to indicate the first time-frequency resource block, the HARQ-ACK associated with the second signaling indicates whether the first signal is correctly received by a target receiver of the first signal, and the second signal indicates whether the first signal is correctly received by the transmitter of the second signal; the target receiver of the first signal is different from a transmitter of the second signaling, the target receiver of the first signal including the transmitter of the second signal.

In one embodiment, the first transmitter also transmits a first signal in a first time-frequency resource block; and the first receiver also receives a second signal in a second time-frequency resource block; herein, the second signaling is used to indicate the first time-frequency resource block, the HARQ-ACK associated with the second signaling indicates whether the first signal is correctly received by a target receiver of the first signal, and the second signal indicates whether the first signal is correctly received by the transmitter of the second signal; the target receiver of the first signal is different from a transmitter of the second signaling, the target receiver of the first signal including the transmitter of the second signal.

In one embodiment, the first signal is transmitted by a radio interface between UEs.

In one embodiment, the second signal is transmitted by a radio interface between UEs.

In one embodiment, the first signal is transmitted by a radio interface in Sidelink.

In one embodiment, the second signal is transmitted by a radio interface in Sidelink.

In one embodiment, the first signal is transmitted by a PC5 interface.

In one embodiment, the second signal is transmitted by a PC5 interface.

In one embodiment, the second signaling explicitly indicates the first time-frequency resource block.

In one embodiment, the second signaling implicitly indicates the first time-frequency resource block.

In one embodiment, the second signaling explicitly indicates the second time-frequency resource block.

In one embodiment, the second signaling implicitly indicates the second time-frequency resource block.

In one embodiment, the second time-frequency resource block is implicitly indicated by the first time-frequency resource block.

In one embodiment, the first time-frequency resource block is used by the third node U05B for determining the second time-frequency resource block.

In one embodiment, the first time-frequency resource block is used by the first node U03B for determining the second time-frequency resource block.

In one embodiment, the first signal comprises a PSSCH, and the second signal comprises a Physical Sidelink Feedback CHannel (PSFCH).

In one embodiment, the first signal comprises a Physical Sidelink Control CHannel (PSCCH), and the second signal comprises a PSFCH.

In one embodiment, the first time-frequency resource block comprises time-frequency resources reserved for a PSCCH and a PSSCH, and the second time-frequency resource block comprises time-frequency resources reserved for a PSFCH.

In one embodiment, both the first time-frequency resource block and the second time-frequency resource block are composed by SL time-frequency resources.

In one embodiment, a method in a third node for wireless communications is characterized in comprising:

receiving a first signal in a first time-frequency resource block; and

transmitting a second signal in a second time-frequency resource block;

herein, the second signal indicates whether the first signal is correctly received by the third node; a target receiver of the first signal includes the third node.

In one embodiment, a third node for wireless communications is characterized in comprising:

a third receiver, receiving a first signal in a first time-frequency resource block; and

a third transmitter, transmitting a second signal in a second time-frequency resource block;

herein, the second signal indicates whether the first signal is correctly received by the third node; a target receiver of the first signal includes the third node.

In one embodiment, the third node is different from the first node, and the third node is different from the second node.

In one embodiment, a processing device in the third node comprises a third receiver and a third transmitter.

In one embodiment, the third node is a UE.

In one embodiment, the third node is a relay node.

In one embodiment, the third node is vehicle-mounted equipment.

In one embodiment, the third node is a UE supporting V2X communication.

In one embodiment, the third node is a relay node supporting V2X communication.

In one embodiment, the third receiver comprises at least one of the antenna 452, the receiver 454, the multi-antenna receiving processor 458, the receiving processor 456, the controller/processor 459, the memory 460 or the data source 467 in FIG. 4A of the present disclosure.

In one embodiment, the third receiver comprises at least the first five of the antenna 452, the receiver 454, the multi-antenna receiving processor 458, the receiving processor 456, the controller/processor 459, the memory 460 and the data source 467 in FIG. 4A of the present disclosure.

In one embodiment, the third receiver comprises at least the first four of the antenna 452, the receiver 454, the multi-antenna receiving processor 458, the receiving processor 456, the controller/processor 459, the memory 460 and the data source 467 in FIG. 4A of the present disclosure.

In one embodiment, the third receiver comprises at least the first three of the antenna 452, the receiver 454, the multi-antenna receiving processor 458, the receiving processor 456, the controller/processor 459, the memory 460 and the data source 467 in FIG. 4A of the present disclosure.

In one embodiment, the third receiver comprises at least the first two of the antenna 452, the receiver 454, the multi-antenna receiving processor 458, the receiving processor 456, the controller/processor 459, the memory 460 and the data source 467 in FIG. 4A of the present disclosure.

In one embodiment, the third transmitter comprises at least one of the antenna 452, the transmitter 454, the multi-antenna transmitting processor 457, the transmitting processor 468, the controller/processor 459, the memory 460 or the data source 467 in FIG. 4A of the present disclosure.

In one embodiment, the third transmitter comprises at least the first five of the antenna 452, the transmitter 454, the multi-antenna transmitting processor 457, the transmitting processor 468, the controller/processor 459, the memory 460 and the data source 467 in FIG. 4A of the present disclosure.

In one embodiment, the third transmitter comprises at least the first four of the antenna 452, the transmitter 454, the multi-antenna transmitting processor 457, the transmitting processor 468, the controller/processor 459, the memory 460 and the data source 467 in FIG. 4A of the present disclosure.

In one embodiment, the third transmitter comprises at least the first three of the antenna 452, the transmitter 454, the multi-antenna transmitting processor 457, the transmitting processor 468, the controller/processor 459, the memory 460 and the data source 467 in FIG. 4A of the present disclosure.

In one embodiment, the third transmitter comprises at least the first two of the antenna 452, the transmitter 454, the multi-antenna transmitting processor 457, the transmitting processor 468, the controller/processor 459, the memory 460 and the data source 467 in FIG. 4A of the present disclosure.

### Embodiment 6C

Embodiment 6C illustrates a flowchart of radio signal transmission according to one embodiment of the present disclosure, as shown in FIG. 6C. In FIG. 6C, a first node U1C and a second node U2C are in communication via an SL interface, while the second node U2C and a third node U3C are in communication via SL. It should be particularly noted that the sequencing of the embodiments herein does not set any limit on the signal transmission order and implementation order in the present disclosure.

The first node U1C determines a first target QoS parameter group in step S11C, transmits a first signaling in step S12C, and receives a second signaling in step S13C, transmits a first information set in step S14C, transmits a second information set in step S15C, and transmits a third information set in step S16C.

The second node U2C receives a first signaling in step S21C, and transmits a second signaling in step S22C, receives a second information set in step S23C, receives a third information set in step S24C, and transmits a fourth information set in step S25C.

The third node U3C receives a fourth information set in step S31C.

In Embodiment 6C, determining a first target QoS parameter group; and transmitting a first information set, a second information set and a third information set; herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group; receiving a second signaling; herein, the second signaling indicates a second QoS parameter set, the second QoS parameter set comprises one or more QoS parameter groups, and the second QoS parameter set is used to determine the second QoS parameter group; transmitting a first signaling, the first signaling comprising a first QoS parameter set, the first QoS parameter set comprising multiple QoS parameter groups; herein, the second signaling indicates the second QoS parameter set from the first QoS parameter set; the first packet through the radio bearer transmitting the third information set and the radio bearer transmitting the fourth information set satisfies the first target QoS parameter group; the first information set comprises at least one of the second identity or the third identity.

In one embodiment, a receiver of the first signaling is the second node.

In one embodiment, the first signaling is transmitted via a PC5 interface.

In one embodiment, the first signaling is transmitted through sidelink.

In one embodiment, the first signaling is transmitted through unicast.

In one embodiment, the first signaling is transmitted through groupcast.

In one embodiment, the first signaling comprises higher layer information.

In one embodiment, the first signaling comprises RRC layer information.

In one embodiment, the first signaling comprises all or part of IEs in an RRC signaling.

In one embodiment, the first signaling comprises an RRCReconfigurationSidelink message.

In one embodiment, the first signaling comprises RRCReconfigurationSidelink-IEs.

In one embodiment, the first signaling comprises RRCReconfigurationRequestSidelink message.

In one embodiment, the first signaling comprises RRCReconfigurationRequestSidelink-IEs.

In one embodiment, the first signaling comprises an SL-RelayResourceReq IE in an RRC signaling.

In one embodiment, the first signaling comprises all or part of fields of an IE in an RRC signaling.

In one embodiment, the first signaling comprises an SL-SDAP-ConfigPC5 field in an RRC signaling.

In one embodiment, the first signaling comprises an sl-MappedQoS-FlowsToAddList field in an RRC signaling.

In one embodiment, the first signaling comprises the first QoS parameter set.

In one embodiment, the first signaling comprises an sl-QoS-InfoList-allowed field in an RRC signaling, the sl-QoS-InfoList-allowed field indicating the first QoS parameter set.

In one embodiment, the first QoS parameter set comprises multiple QoS parameter groups.

In one embodiment, the first QoS parameter set comprises indexes of multiple QoS parameter groups.

In one subembodiment of the above embodiment, a QoS parameter group index indicates one QoS parameter group from a QoS parameter group list.

In one embodiment, the first QoS parameter set is a subset of the QoS parameter group list.

In one embodiment, the first QoS parameter set is the same as the QoS parameter group list.

In one embodiment, the QoS parameter group list is preconfigured in the first node.

In one embodiment, the QoS parameter group list is preconfigured in the second node.

In one embodiment, the QoS parameter group list is configured by networks in the first node.

In one embodiment, the QoS parameter group list is configured by networks in the second node.

In one embodiment, the first QoS parameter set comprises the second QoS parameter group.

In one embodiment, a transmitter of the second signaling is the second node.

In one embodiment, the second signaling is a response to the first signaling.

In one embodiment, the second signaling is transmitted via a PC5 interface.

In one embodiment, the second signaling is transmitted through sidelink.

In one embodiment, the second signaling is transmitted through unicast.

In one embodiment, the second signaling comprises higher layer information.

In one embodiment, the second signaling comprises RRC layer information.

In one embodiment, the second signaling comprises all or part of IEs in an RRC signaling.

In one embodiment, the second signaling comprises an RRCReconfigurationSidelink message.

In one embodiment, the second signaling comprises RRCReconfigurationSidelink-IEs.

In one embodiment, the second signaling comprises RRCReconfigurationResponseSidelink message.

In one embodiment, the second signaling comprises RRCReconfigurationResponseSidelink-IEs.

In one embodiment, the second signaling comprises an SL-RelayResourceResp IE in an RRC signaling.

In one embodiment, the second signaling comprises all or part of fields of an IE in an RRC signaling.

In one embodiment, the second signaling comprises an SL-SDAP-ConfigPC5 field in an RRC signaling.

In one embodiment, the second signaling comprises an sl-MappedQoS-FlowsToAddList field in an RRC signaling.

In one embodiment, the second signaling indicates the second QoS parameter set.

In one embodiment, the second signaling comprises an sl-QoS-InfoList-selected field in an RRC signaling, the sl-QoS-InfoList-selected field indicating the second QoS parameter set.

In one embodiment, the second QoS parameter set comprises one QoS parameter group.

In one embodiment, the second QoS parameter set comprises multiple QoS parameter groups.

In one embodiment, the second QoS parameter set comprises an index of a QoS parameter group.

In one embodiment, the second QoS parameter set comprises indexes of multiple QoS parameter groups.

In one subembodiment of the above embodiments, a QoS parameter group index indicates one QoS parameter group from the QoS parameter group list.

In one embodiment, the second QoS parameter set is a subset of the QoS parameter group list.

In one embodiment, the second QoS parameter set is the same as the QoS parameter group list.

In one embodiment, the second QoS parameter group is a QoS parameter group randomly selected from the second QoS parameter set.

In one embodiment, the second QoS parameter group is a first QoS parameter group in the second QoS parameter set.

In one embodiment, the second QoS parameter group is a last QoS parameter group in the second QoS parameter set.

In one embodiment, the second QoS parameter group is a QoS parameter group with a minimum PQI value among multiple QoS parameter groups comprised by the second QoS parameter set.

In one embodiment, the second QoS parameter group is a QoS parameter group with a maximum PQI value among multiple QoS parameter groups comprised by the second QoS parameter set.

In one embodiment, the second QoS parameter group is a QoS parameter group with a minimum value of PC5 Flow Bit Rates among multiple QoS parameter groups comprised by the second QoS parameter set.

In one embodiment, the second QoS parameter group is a QoS parameter group with a maximum value of PC5 Flow Bit Rates among multiple QoS parameter groups comprised by the second QoS parameter set.

In one embodiment, the second QoS parameter group is a QoS parameter group with a minimum value of PC5 Link Aggregated Bit Rates among multiple QoS parameter groups comprised by the second QoS parameter set.

In one embodiment, the second QoS parameter group is a QoS parameter group with a maximum value of PC5 Link Aggregated Bit Rates among multiple QoS parameter groups comprised by the second QoS parameter set.

In one embodiment, the second QoS parameter group is a QoS parameter group with a minimum Range value among multiple QoS parameter groups comprised by the second QoS parameter set.

In one embodiment, the second QoS parameter group is a QoS parameter group with a maximum Range value among multiple QoS parameter groups comprised by the second QoS parameter set.

In one embodiment, the first packet is transmitted on the radio bearer transmitting the third information set and the radio bearer transmitting the fourth information set.

In one embodiment, the first information set comprises the second identity.

In one embodiment, the first information set comprises the third identity.

In one embodiment, the first information set comprises the second identity and the third identity.

In one embodiment, an sl-DestinationIdentity field in an RRC signaling comprised by the first information set indicates the second identity.

In one embodiment, an sl-Relayldentity field in an RRC signaling comprised by the first information set indicates the third identity.

In one embodiment, an sl-Pathldentity field in an RRC signaling comprised by the first information set indicates the second identity and the third identity, the third identity indicating the second node, and the second identity indicating the third node.

### Embodiment 7A

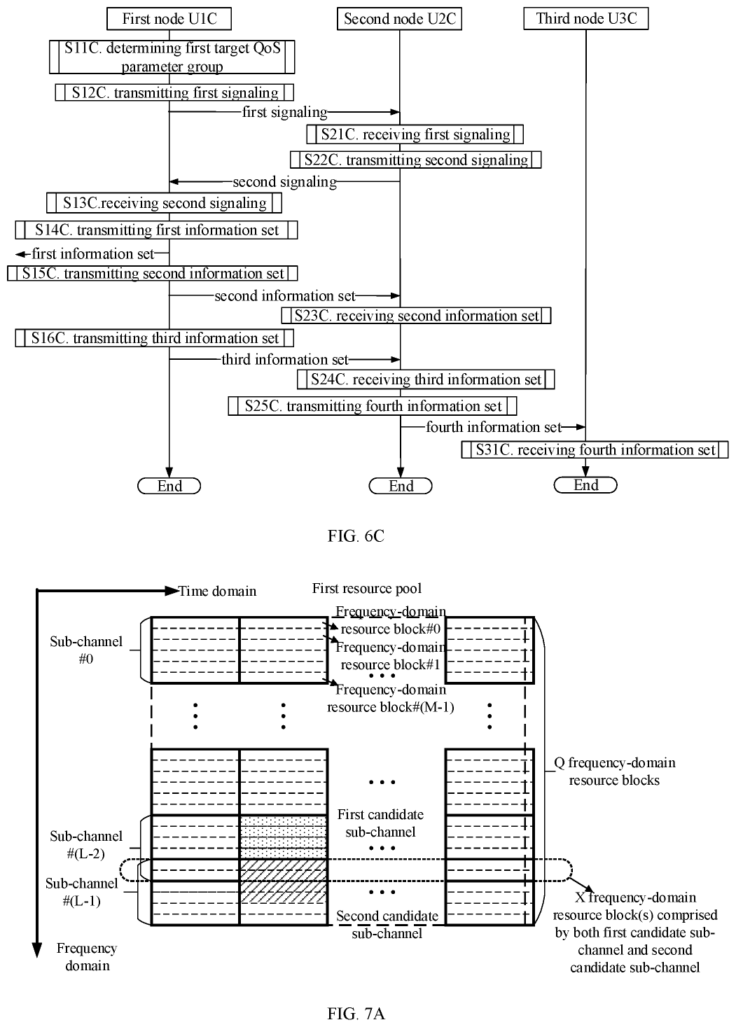

Embodiment 7A illustrates a schematic diagram of relations among a first candidate sub-channel, a second candidate sub-channel and a first resource pool according to one embodiment of the present disclosure, as shown in FIG. 7A. In FIG. 7A, the x axis represents time domain, and the y axis represents frequency domain; the large square framed with broken lines represents a first resource pool in the present disclosure; each rectangle framed with thick solid lines along the y axis represents a sub-channel of L sub-channels comprised by the first resource pool; each rectangle framed with broken lines along the y axis represents a frequency-domain resource block of Q frequency-domain resource blocks comprised by the first resource pool; the dot-filled rectangle framed with thick solid lines represents a first candidate sub-channel in the present disclosure; the slash-filled rectangle framed with thick solid lines represents a second candidate sub-channel in the present disclosure; broken-line framed rectangles in the dotted-line circle represent X same frequency-domain resource blocks comprised by both the first candidate sub-channel and the second candidate sub-channel.

In Embodiment 7A, the first resource pool comprises the Q frequency-domain resource blocks in frequency domain, Q being a positive integer greater than 1; the first resource pool comprises the L sub-channels in frequency domain, L being a positive integer greater than 1; any of the L sub-channels comprises M consecutive frequency-domain resource blocks in frequency domain, M being a positive integer greater than 1 and no greater than Q; the first candidate sub-channel and the second candidate sub-channel are two different sub-channels of the L sub-channels; X frequency-domain resource block(s) in the first candidate sub-channel is(are) the same as X frequency-domain resource block(s) in the second candidate sub-channel, X being a positive integer no greater than M.

In one embodiment, the first candidate sub-channel and the second candidate sub-channel are two different sub-channels of the L sub-channels comprised by the first resource pool.

In one embodiment, the first candidate sub-channel and the second candidate sub-channel are two overlapping sub-channels of the L sub-channels comprised by the first resource pool.

In one embodiment, a frequency-domain resource block comprised by the first candidate sub-channel and a frequency-domain resource block comprised by the second candidate sub-channel are the same.

In one embodiment, the first candidate sub-channel comprises M consecutive frequency-domain resource blocks, and a first target frequency-domain resource block is one of the M consecutive frequency-domain resource blocks comprised by the first candidate sub-channel.

In one embodiment, the second candidate sub-channel comprises M consecutive frequency-domain resource blocks, and a first target frequency-domain resource block is one of the M consecutive frequency-domain resource blocks comprised by the second candidate sub-channel.

In one embodiment, a first target frequency-domain resource block is one of M consecutive frequency-domain resource blocks comprised by the first candidate sub-channel, and the first target frequency-domain resource block is also one of M consecutive frequency-domain resource blocks comprised by the second candidate sub-channel.

In one embodiment, a first target frequency-domain resource block is one of M consecutive frequency-domain resource blocks comprised by the first candidate sub-channel, and the first target frequency-domain resource block is also one of M consecutive frequency-domain resource blocks comprised by the second candidate sub-channel; a second target frequency-domain resource block is one of M consecutive frequency-domain resource blocks comprised by the first candidate sub-channel, and the second target frequency-domain resource block is different from any frequency-domain resource block of M consecutive frequency-domain resource blocks comprised by the second candidate sub-channel.

In one embodiment, a first target frequency-domain resource block is one of M consecutive frequency-domain resource blocks comprised by the first candidate sub-channel, and the first target frequency-domain resource block is also one of M consecutive frequency-domain resource blocks comprised by the second candidate sub-channel; a third target frequency-domain resource block is one of M consecutive frequency-domain resource blocks comprised by the second candidate sub-channel, and the third target frequency-domain resource block is different from any frequency-domain resource block of M consecutive frequency-domain resource blocks comprised by the first candidate sub-channel.

In one embodiment, a first target frequency-domain resource block is one of M consecutive frequency-domain resource blocks comprised by the first candidate sub-channel, and the first target frequency-domain resource block is also one of M consecutive frequency-domain resource blocks comprised by the second candidate sub-channel; a second target frequency-domain resource block is one of M consecutive frequency-domain resource blocks comprised by the first candidate sub-channel, and the second target frequency-domain resource block is different from any frequency-domain resource block of M consecutive frequency-domain resource blocks comprised by the second candidate sub-channel; a third target frequency-domain resource block is one of M consecutive frequency-domain resource blocks comprised by the second candidate sub-channel, and the third target frequency-domain resource block is different from any frequency-domain resource block of M consecutive frequency-domain resource blocks comprised by the first candidate sub-channel.

In one embodiment, a first target frequency-domain resource block group comprises X frequency-domain resource block(s), and any frequency-domain resource block in the first target frequency-domain resource block group is a frequency-domain resource block of M consecutive frequency-domain resource blocks comprised by the first candidate sub-channel, and any frequency-domain resource block in the first target frequency-domain resource block group is also a frequency-domain resource block of M consecutive frequency-domain resource blocks comprised by the second candidate sub-channel; X is a positive integer no greater than M.

In one embodiment, a first target frequency-domain resource block group comprises X frequency-domain resource block(s), and any frequency-domain resource block in the first target frequency-domain resource block group is a frequency-domain resource block of M consecutive frequency-domain resource blocks comprised by the first candidate sub-channel, and any frequency-domain resource block in the first target frequency-domain resource block group is also a frequency-domain resource block of M consecutive frequency-domain resource blocks comprised by the second candidate sub-channel; a second target frequency-domain resource block is one of M consecutive frequency-domain resource blocks comprised by the first candidate sub-channel, and the second target frequency-domain resource block is different from any frequency-domain resource block of M consecutive frequency-domain resource blocks comprised by the second candidate sub-channel; X is a positive integer no greater than M.

In one embodiment, a first target frequency-domain resource block group comprises X frequency-domain resource block(s), and any frequency-domain resource block in the first target frequency-domain resource block group is a frequency-domain resource block of M consecutive frequency-domain resource blocks comprised by the first candidate sub-channel, and any frequency-domain resource block in the first target frequency-domain resource block group is also a frequency-domain resource block of M consecutive frequency-domain resource blocks comprised by the second candidate sub-channel; a third target frequency-domain resource block is a frequency-domain resource block of M consecutive frequency-domain resource blocks comprised by the second candidate sub-channel, and the third target frequency-domain resource block is different from any frequency-domain resource block of M consecutive frequency-domain resource blocks comprised by the first candidate sub-channel; X is a positive integer no greater than M.

In one embodiment, a first target frequency-domain resource block group comprises X frequency-domain resource block(s), and any frequency-domain resource block in the first target frequency-domain resource block group is a frequency-domain resource block of M consecutive frequency-domain resource blocks comprised by the first candidate sub-channel, and any frequency-domain resource block in the first target frequency-domain resource block group is also a frequency-domain resource block of M consecutive frequency-domain resource blocks comprised by the second candidate sub-channel; a second target frequency-domain resource block is one of M consecutive frequency-domain resource blocks comprised by the first candidate sub-channel, and the second target frequency-domain resource block is different from any frequency-domain resource block of M consecutive frequency-domain resource blocks comprised by the second candidate sub-channel; a third target frequency-domain resource block is one of M consecutive frequency-domain resource blocks comprised by the second candidate sub-channel, and the third target frequency-domain resource block is different from any frequency-domain resource block of M consecutive frequency-domain resource blocks comprised by the first candidate sub-channel; X is a positive integer no greater than M.

In one embodiment, indexes of the L sub-channels in the first resource pool are sequentially arranged according to an ascending order of frequency.

In one embodiment, L-1 sub-channels comprised in the first resource pool are orthogonal in frequency domain.

In one embodiment, any two sub-channels of L-1 sub-channels comprised in the first resource pool are orthogonal in frequency domain.

In one embodiment, the L-1 sub-channels comprised in the first resource pool belong to the L sub-channels comprised in the first resource pool.

In one embodiment, the L-1 sub-channels comprised in the first resource pool comprise M×(L-1) frequency-domain resource blocks.

In one embodiment, the L-1 sub-channels comprised in the first resource pool comprise M×(L-1) consecutive frequency-domain resource blocks.

In one embodiment, the first candidate sub-channel is one of the L-1 sub-channels comprised in the first resource pool.

In one embodiment, the first candidate sub-channel is a sub-channel of highest frequency of the L-1 sub-channels comprised in the first resource pool.

In one embodiment, the first candidate sub-channel is a (L-1)-th sub-channel of highest frequency of the L sub-channels comprised in the first resource pool.

In one embodiment, the first candidate sub-channel is a sub-channel with a sub-channel index of (L-2) of the L sub-channels comprised in the first resource pool.

In one embodiment, the second candidate sub-channel is the L-th sub-channel of the L sub-channels comprised in the first resource pool.

In one embodiment, the second candidate sub-channel is a sub-channel with a sub-channel index of (L-1) of the L sub-channels comprised in the first resource pool.

In one embodiment, the second candidate sub-channel is a sub-channel of highest frequency of the L sub-channels comprised in the first resource pool.

In one embodiment, the second candidate sub-channel comprises M frequency-domain resource blocks of highest frequency of the Q frequency-domain resource blocks comprised in the first resource pool.

In one embodiment, each frequency-domain resource block of the Q frequency-domain resource blocks comprised in the first resource pool other than the M×(L−1) frequency-domain resource blocks comprised by the L−1 sub-channels belongs to the second candidate sub-channel.

In one embodiment, the second candidate sub-channel comprises Q-M×(L−1) frequency-domain resource blocks of the Q frequency-domain resource blocks comprised in the first resource pool, and any frequency-domain resource block of the Q-M×(L−1) frequency-domain resource blocks does not belong to the L−1 sub-channels in the first resource pool.

### Embodiment 7B

Embodiment 7B illustrates a schematic diagram of a second target value, as shown in FIG. 7B.

In Embodiment 7B, the first signaling in the present disclosure indicates a second target value, the second target value being a non-negative integer; when the first signaling is the first-type signaling, a fourth value and a fifth value are jointly used to determine the second target value; when the first signaling is the third-type signaling, of a sixth value and the fifth value only the sixth value is used to determine the second target value; the fourth value is equal to a number of serving cell-monitoring occasion pairs for transmitting the first-type signalings accumulated in a first time window by a serving cell and monitoring occasion to which the first signaling belongs according to a first rule; the sixth value is equal to a number of serving cell-monitoring occasion pairs for transmitting the third-type signalings accumulated in the first time window by a serving cell and monitoring occasion to which the first signaling belongs according to a first rule; the fifth value is equal to a total number of serving cell-monitoring occasion pairs for transmitting the second-type signalings accumulated in the first time window by a serving cell and monitoring occasion to which the first signaling belongs according to a first rule.

In one embodiment, the first field of the first signaling indicates a first target value and a second target value.

In one embodiment, the first signaling comprises a second field, and the second field of the first signaling indicates the second target value, the second field being different from the first field.

In one embodiment, the first target value is a total DAI, and the second target value is a counter DAI.

In one embodiment, the first signaling is the first-type signaling, the fourth value and the fifth value are used to determine a third integer, and the third integer is used to determine the second target value.

In one embodiment, the first signaling is the first-type signaling, and a sum of the fourth value and the fifth value is used to determine the second target value.

In one embodiment, the first signaling is the first-type signaling, the fourth value and the fifth value are used to determine a third integer, and an output of the third integer being input to the first function is equal to the second target value.

In one embodiment, the third integer is equal to a result of linear transformation of the fourth value and the fifth value, and the third integer is used to determine the second target value.

In one embodiment, the third integer is equal to a sum of the fourth value and the fifth value, and the third integer is used to determine the second target value.

In one embodiment, the third integer is linear with a sum of the fourth value and the fifth value, and the third integer is used to determine the second target value.

In one embodiment, the first signaling is the third-type signaling, the sixth value is used to determine a fourth integer, and the fourth integer is used to determine the second target value.

In one embodiment, the first signaling is the third-type signaling, the sixth value is used to determine a fourth integer, and an output of the fourth integer being input to the first function is equal to the second target value.

In one embodiment, the first signaling is the third-type signaling, and an output of the sixth integer being input to the first function is equal to the second target value.

In one embodiment, the first signaling is the first-type signaling, and the second target value is used by the first node for determining a sum of the fourth value and the fifth value.

In one embodiment, the first signaling is the third-type signaling, and the second target value is used by the first node for determining the sixth value.

### Embodiment 7C

Embodiment 7C illustrates a schematic diagram of a first radio bearer, a second radio bearer, a first QoS parameter group, a second QoS parameter group and a first target QoS parameter group according to one embodiment of the present disclosure, as shown in FIG. 7C.

In one embodiment, the first QoS parameter group is applied in the first radio bearer.

In one embodiment, the second QoS parameter group is applied in the second radio bearer.

In one embodiment, the first target QoS parameter group is applied in a service to which the first packet belongs.

In one embodiment, the first target QoS parameter group is applied in a QoS flow to which the first packet belongs.

In one embodiment, the first target QoS parameter group is applied in a PC5 QoS flow to which the first packet belongs.

In one embodiment, the first packet is transmitted on the first radio bearer and the second radio bearer.

In one embodiment, a delay, a packet error rate, a maximum data burst volume, PC5 flow bit rates, PC5 link aggregated bit rates and a range comprised in the first packet after being through the first radio bearer and the second radio bearer respectively fulfill Packet Delay Budget, Packet Error Rate, Maximum Data Burst Volume, PC5 Flow Bit Rates, PC5 Link Aggregated Bit Rates and Range in the first target QoS parameter group.

In one embodiment, a delay, a packet error rate and a range comprised in the first packet after being through the first radio bearer and the second radio bearer respectively fulfill Packet Delay Budget, Packet Error Rate and Range in the first target QoS parameter group.

In one embodiment, a delay comprised in the first packet after being through the first radio bearer and the second radio bearer is no greater than Packet Delay Budget in the first target QoS parameter group.

In one embodiment, the packet error rate comprised in the first packet after being through the first radio bearer and the second radio bearer is no greater than Packet Error Rate in the first target QoS parameter group.

In one embodiment, a maximum data burst volume comprised in the first packet after being through the first radio bearer and the second radio bearer is no greater than Maximum Data Burst Volume in the first target QoS parameter group.

In one embodiment, PC5 flow bit rates comprised in the first packet after being through the first radio bearer and the second radio bearer is no greater than PC5 Flow Bit Rates in the first target QoS parameter group.

In one embodiment, PC5 link aggregated bit rates comprised in the first packet after being through the first radio bearer and the second radio bearer is no greater than PC5 Link Aggregated Bit Rates in the first target QoS parameter group.

In one embodiment, a range comprised in the first packet after being through the first radio bearer and the second radio bearer is no greater than Range in the first target QoS parameter group.

### Embodiment 8A

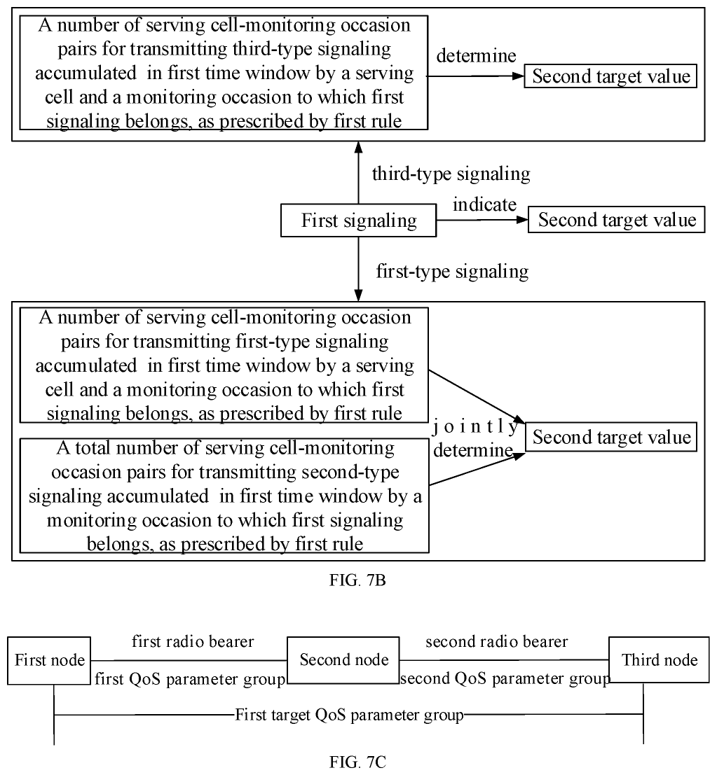

Embodiment 8A illustrates a schematic diagram of relations among a first sub-channel, a first signaling, a first candidate sub-channel, a second candidate sub-channel and a target sub-channel group according to one embodiment of the present disclosure, as shown in FIG. 8A. In FIG. 8A, a rectangle filled with oblique grids represents a first signaling in the present disclosure; a dot-filled rectangle framed with thick solid lines represents the first candidate sub-channel in the present disclosure; and a slash-filled rectangle framed with thick solid lines represents the second candidate sub-channel in the present disclosure; a rectangle framed with thick solid lines circled in the broken-line box represents a first sub-channel in the present disclosure.

In Case A of Embodiment 8A, the target sub-channel group comprises two different sub-channels of the L sub-channels, the first candidate sub-channel is one of the two different sub-channels comprised by the target sub-channel group, and the first sub-channel is a sub-channel which is lower in frequency domain of the two different sub-channels comprised by the target sub-channel group; in Case B of Embodiment 8A, the target sub-channel group comprises two different sub-channels of the L sub-channels, the second candidate sub-channel is one of the two different sub-channels comprised by the target sub-channel group, and the first sub-channel is a sub-channel which is lower in frequency domain of the two different sub-channels comprised by the target sub-channel group.

In Case C of Embodiment 8A, the target sub-channel group only comprises the first candidate sub-channel of the L sub-channels, the first sub-channel being the same as the first candidate sub-channel; in Case D of Embodiment 8A, the target sub-channel group only comprises the second candidate sub-channel of the L sub-channels, the first sub-channel being the same as the second candidate sub-channel.

In one embodiment, the first candidate sub-channel is one of the positive integer number of sub-channels comprised by the target sub-channel group, and the first sub-channel is a sub-channel which is the lowest one in frequency domain among the positive integer number of sub-channels comprised by the target sub-channel group.

In one embodiment, the first candidate sub-channel is one of the positive integer number of sub-channels comprised by the target sub-channel group, and the first sub-channel is a sub-channel with a minimum sub-channel index among the positive integer number of sub-channels comprised by the target sub-channel group.

In one embodiment, the first candidate sub-channel is one of the positive integer number of sub-channels comprised by the target sub-channel group, and a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group.

In one embodiment, the second candidate sub-channel is one of the positive integer number of sub-channels comprised by the target sub-channel group, and the first sub-channel is a sub-channel which is the lowest one in frequency domain among the positive integer number of sub-channels comprised by the target sub-channel group.

In one embodiment, the second candidate sub-channel is one of the positive integer number of sub-channels comprised by the target sub-channel group, and the first sub-channel is a sub-channel with a minimum sub-channel index among the positive integer number of sub-channels comprised by the target sub-channel group.

In one embodiment, the second candidate sub-channel is one of the positive integer number of sub-channels comprised by the target sub-channel group, and a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group.

In one embodiment, when the first candidate sub-channel is one of the positive integer number of sub-channels comprised by the target sub-channel group, the first sub-channel is a sub-channel which is the lowest one in frequency domain among the positive integer number of sub-channels comprised by the target sub-channel group; when the second candidate sub-channel is one of the positive integer number of sub-channels comprised by the target sub-channel group, the first sub-channel is a sub-channel which is the lowest one in frequency domain among the positive integer number of sub-channels comprised by the target sub-channel group.

### Embodiment 8B

Embodiment 8B illustrates a schematic diagram of first-type signaling and second-type signaling according to one embodiment of the present disclosure, as shown in FIG. 8B.

In Embodiment 8B, the first-type signaling corresponds to a first priority, and the third-type signaling corresponds to a second priority, the first priority being different from the second priority.

In one embodiment, the first priority is configured by a higher layer signaling.

In one embodiment, the first priority is configured by an RRC signaling.

In one embodiment, the first priority is indicated by the first-type signaling.

In one embodiment, the second priority is configured by a higher layer signaling.

In one embodiment, the second priority is configured by an RRC signaling.

In one embodiment, the second priority is indicated by the third-type signaling.

In one embodiment, a given signaling corresponds to a given priority, and a signaling identifier carried by the given signaling is used to determine whether the given priority is configured by a higher layer signaling or indicated by the given signaling.

In one subembodiment, the given signaling is the first-type signaling, and the given priority is the first priority.

In one subembodiment, the given signaling is the second-type signaling, and the given priority is the first priority.

In one subembodiment, the given signaling is the third-type signaling, and the given priority is the second priority.

In one subembodiment, the signaling identifier carried by the given signaling is a Radio Network Temporary Identifier (RNTI).

In one subembodiment, the signaling identifier carried by the given signaling is a non-negative integer.

In one subembodiment, the signaling identifier carried by the given signaling is used to generate a Reference Signal (RS) sequence of DMRS of the given signaling.

In one subembodiment, the signaling identifier carried by the given signaling is used to scramble a CRC bit sequence of the given signaling.

In one embodiment, the first-type signaling comprises a third field, and the third field comprised in the first-type signaling is used to indicate the first priority.

In one embodiment, the first-type signaling comprises a third field, and the third field comprised in the first-type signaling indicates an index of the first priority.

In one embodiment, the second-type signaling comprises a third field, and the third field comprised in the second-type signaling is used to indicate the first priority.

In one embodiment, the second-type signaling comprises a third field, and the third field comprised in the second-type signaling indicates an index of the first priority.

In one embodiment, the third-type signaling comprises a third field, and the third field comprised in the third-type signaling is used to indicate the second priority.

In one embodiment, the third-type signaling comprises a third field, and the third field comprised in the third-type signaling indicates an index of the second priority.

In one embodiment, the third field comprises a positive integer number of bit(s).

In one embodiment, the third field comprises a bit.

In one embodiment, the third field is a Priority indicator Field.

In one embodiment, for the specific definition of the Priority indicator Field, refer to 3GPP TS38.212, section 7.3.1.2.

In one embodiment, the first priority is higher than the second priority.

In one embodiment, the first priority is higher than the second priority, and an index of the first priority is larger than an index of the second priority.

In one embodiment, the first priority is higher than the second priority, an index of the first priority is equal to 1, and an index of the second priority is equal to 0.

In one embodiment, the first priority is lower than the second priority.

In one embodiment, the first priority is lower than the second priority, and an index of the first priority is smaller than an index of the second priority.

In one embodiment, the first priority is lower than the second priority, and an index of the first priority is equal to 0, and an index of the second priority is equal to 1.

In one embodiment, the first priority is higher than the second priority, a value of the third field in the first-type signaling is equal to 1, and a value of the third field in the third-type signaling is equal to 0.

In one embodiment, the first priority is lower than the second priority, a value of the third field in the first-type signaling is equal to 0, and a value of the third field in the third-type signaling is equal to 1.

In one embodiment, the first priority is higher than the second priority, and a value of the third field in the second-type signaling is equal to 1.

In one embodiment, the first priority is lower than the second priority, and a value of the third field in the second-type signaling is equal to 0.

In one embodiment, an RRC signaling is used to indicate that the first-type signaling comprises the third field.

In one embodiment, an RRC signaling is used to indicate that the second-type signaling comprises the third field.

In one embodiment, an RRC signaling is used to indicate that the third-type signaling comprises the third field.

In one embodiment, the correspondence between the first-type signaling and the first priority is pre-defined.

In one embodiment, the correspondence between the third-type signaling and the second priority is pre-defined.

In one embodiment, the correspondence between the first-type signaling and the first priority is pre-configured.

In one embodiment, the correspondence between the third-type signaling and the second priority is pre-configured.

In one embodiment, the correspondence between the first-type signaling and the first priority is configurable.

In one embodiment, the correspondence between the third-type signaling and the second priority is configurable.

In one embodiment, the second-type signaling corresponds to the first priority.

In one embodiment, the correspondence between the second-type signaling and the first priority is pre-defined.

In one embodiment, the correspondence between the second-type signaling and the first priority is pre-configured.

In one embodiment, the correspondence between the second-type signaling and the first priority is configurable.

In one embodiment, the method in the first node also includes:

receiving second information;

herein, the second information is used to determine that the first-type signaling corresponds to the first priority.

In one embodiment, the first receiver also receives second information; herein, the second information is used to determine that the first-type signaling corresponds to the first priority.

In one embodiment, the method in the second node also includes:

transmitting second information;

herein, the second information is used to determine that the first-type signaling corresponds to the first priority.

In one embodiment, the second transmitter also transmits second information; herein, the second information is used to determine that the first-type signaling corresponds to the first priority.

In one embodiment, the second information is semi-statically configured.

In one embodiment, the second information is carried by a higher layer signaling.

In one embodiment, the second information is carried by an RRC signaling.

In one embodiment, the second information is carried by a MAC CE signaling.

In one embodiment, the second information belongs to an IE in an RRC signaling.

In one embodiment, the second information comprises multiple IEs in an RRC signaling.

In one embodiment, the second information is used to determine that the second-type signaling corresponds to the second priority.

In one embodiment, the second information is used to determine whether the first priority is higher than the second priority.

In one embodiment, the method in the first node also includes:

receiving third information;

herein, the third information is used to determine that the second-type signaling corresponds to the first priority.

In one embodiment, the first receiver also receives third information; herein, the third information is used to determine that the second-type signaling corresponds to the first priority.

In one embodiment, the method in the second node also includes:

transmitting third information;

herein, the third information is used to determine that the second-type signaling corresponds to the first priority.

In one embodiment, the second transmitter also transmits third information; herein, the third information is used to determine that the second-type signaling corresponds to the first priority.

In one embodiment, the third information is semi-statically configured.

In one embodiment, the third information is carried by a higher layer signaling.

In one embodiment, the third information is carried by an RRC signaling.

In one embodiment, the third information is carried by a MAC CE signaling.

In one embodiment, the third information belongs to an IE in an RRC signaling.

In one embodiment, the third information comprises multiple IEs in an RRC signaling.

### Embodiment 8C

Embodiment 8C illustrates a schematic diagram of a first QoS set, a second QoS set and a second QoS parameter group according to one embodiment of the present disclosure, as shown in FIG. 8C. In FIG. 8C, the slash-filled rectangle represents a second QoS parameter group.

In one embodiment, the second QoS parameter set is a subset of the first QoS parameter set.

In one embodiment, the second QoS parameter set is the same as the first QoS parameter set.

In one embodiment, the second QoS parameter set comprises the second QoS parameter group.

In one embodiment, the second QoS parameter set only comprises the second QoS parameter group.

In one embodiment, one QoS parameter group comprised by the second QoS parameter set is indicated by an index of the QoS parameter group in the first QoS parameter set.

In one embodiment, the first QoS parameter set comprises 5 QoS parameter groups, and one QoS parameter group comprised by the second QoS parameter set is a second QoS parameter group comprised in the first QoS parameter set, the second signaling indicating an index of a QoS parameter group comprised by the second QoS parameter set as 2.

In one embodiment, multiple QoS parameter groups comprised by the second QoS parameter set are indicated by indexes of the multiple QoS parameter groups in the first QoS parameter set.

In one embodiment, the first QoS parameter set comprises 5 QoS parameter groups, and two QoS parameter groups comprised by the second QoS parameter set are a second QoS parameter group and a fourth QoS parameter group comprised in the first QoS parameter set, the second signaling indicating indexes of two QoS parameter groups comprised by the second QoS parameter set as 2 and 4, respectively.

### Embodiment 9A

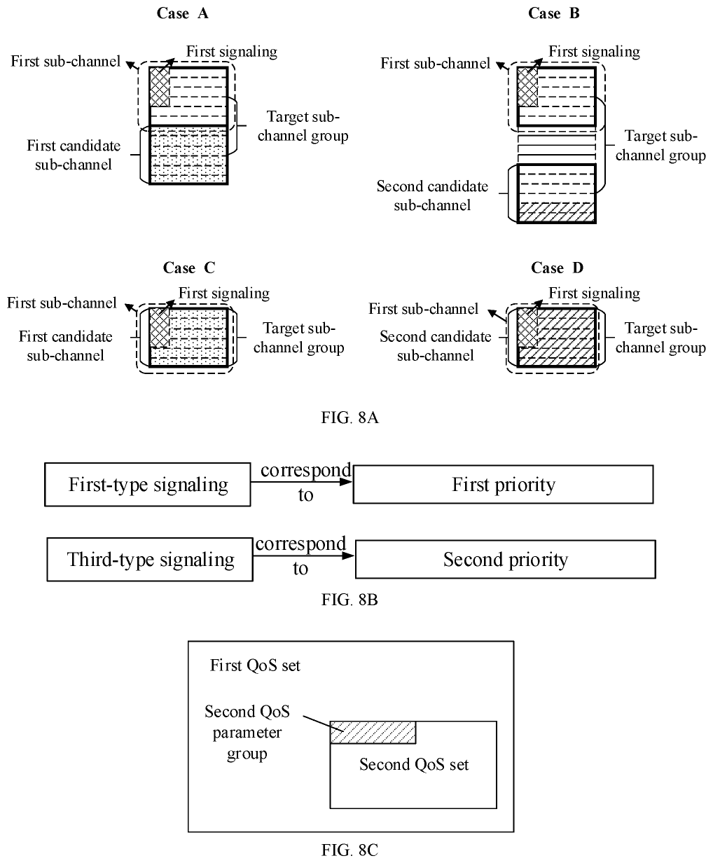

Embodiment 9A illustrates a schematic diagram of relations among a first sub-channel, a first signaling, a first candidate sub-channel, a second candidate sub-channel and a target sub-channel group according to one embodiment of the present disclosure, as shown in FIG. 9A. In FIG. 9A, a rectangle filled with oblique grids represents a first signaling in the present disclosure; a dot-filled rectangle framed with thick solid lines represents the first candidate sub-channel in the present disclosure; and a slash-filled rectangle framed with thick solid lines represents the second candidate sub-channel in the present disclosure; a rectangle framed with thick solid lines circled in the broken-line box represents a first sub-channel in the present disclosure.

In Embodiment 9A, when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group.

In Case A of Embodiment 9A, the target sub-channel group comprises two different sub-channels of the L sub-channels, the first candidate sub-channel is one of the two different sub-channels comprised by the target sub-channel group, and the first sub-channel is a sub-channel which is lower in frequency domain of the two different sub-channels comprised by the target sub-channel group; in Case B of Embodiment 9A, the target sub-channel group comprises two different sub-channels of the L sub-channels, the second candidate sub-channel is one of the two different sub-channels comprised by the target sub-channel group, and the first sub-channel is a sub-channel which is higher in frequency domain of the two different sub-channels comprised by the target sub-channel group.

In one embodiment, the target sub-channel group comprises two different sub-channels of the L sub-channels, the second candidate sub-channel is one of the two different sub-channels comprised by the target sub-channel group, and the first sub-channel is the same as the second candidate sub-channel.

In one embodiment, the target sub-channel group comprises two different sub-channels of the L sub-channels, the second candidate sub-channel is one of the two different sub-channels comprised by the target sub-channel group, and a frequency-domain resource block which is highest in frequency domain among the M contiguous frequency-domain resource blocks comprised by the first sub-channel is the same as a frequency-domain resource block which is highest in frequency domain among the M contiguous frequency-domain resource blocks comprised by the second candidate sub-channel.

In Case C of Embodiment 9A, the target sub-channel group only comprises the first candidate sub-channel of the L sub-channels, the first sub-channel being the same as the first candidate sub-channel, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel; in Case D of Embodiment 9A, the target sub-channel group only comprises the second candidate sub-channel of the L sub-channels, the first sub-channel being the same as the second candidate sub-channel, a frequency-domain resource block which is highest in frequency domain among the M contiguous frequency-domain resource blocks comprised by the first sub-channel is the same as a frequency-domain resource block which is highest in frequency domain among the M contiguous frequency-domain resource blocks comprised by the second candidate sub-channel.

In one embodiment, the second candidate sub-channel is one of the positive integer number of sub-channels comprised by the target sub-channel group, and the first sub-channel is a sub-channel which is highest in frequency domain among the positive integer number of sub-channels comprised by the target sub-channel group.

In one embodiment, the second candidate sub-channel is one of the positive integer number of sub-channels comprised by the target sub-channel group, and the first sub-channel is a sub-channel with a maximum sub-channel index among the positive integer number of sub-channels comprised by the target sub-channel group.

In one embodiment, the second candidate sub-channel is one of the positive integer number of sub-channels comprised by the target sub-channel group, and the first sub-channel is the second candidate sub-channel.

In one embodiment, the second candidate sub-channel is one of the positive integer number of sub-channels comprised by the target sub-channel group, and a frequency-domain resource block which is highest in frequency domain among M contiguous frequency-domain resource blocks comprised by the first sub-channel is the same as a frequency-domain resource block which is highest in frequency domain among the positive integer number of frequency-domain resource blocks comprised by the target sub-channel group.

In one embodiment, the second candidate sub-channel is one of the positive integer number of sub-channels comprised by the target sub-channel group, and a frequency-domain resource block which is highest in frequency domain among M contiguous frequency-domain resource blocks comprised by the first sub-channel is the same as a frequency-domain resource block which is highest in frequency domain among M contiguous frequency-domain resource blocks comprised by the second candidate sub-channel.

In one embodiment, when the first candidate sub-channel is one of the positive integer number of sub-channels comprised by the target sub-channel group, the first sub-channel is a sub-channel which is the lowest one in frequency domain among the positive integer number of sub-channels comprised by the target sub-channel group; when the second candidate sub-channel is one of the positive integer number of sub-channels comprised by the target sub-channel group, the first sub-channel is a sub-channel which is highest in frequency domain among the positive integer number of sub-channels comprised by the target sub-channel group.

In one embodiment, when the first candidate sub-channel is one of the positive integer number of sub-channels comprised by the target sub-channel group, the first sub-channel is a sub-channel which is the lowest one in frequency domain among the positive integer number of sub-channels comprised by the target sub-channel group; when the second candidate sub-channel is one of the positive integer number of sub-channels comprised by the target sub-channel group, the first sub-channel is the second candidate sub-channel.

### Embodiment 9B

Embodiment 9B illustrates a schematic diagram of a first information block set, as shown in FIG. 9B.

In Embodiment 9B, when the first signaling in the present disclosure is a first-type signaling in the present disclosure, the first information block set comprises the first information block subset and the second information block subset in the present disclosure; when the first signaling in the present disclosure is a third-type signaling in the present disclosure, the first information block set comprises only the first information block subset of the first information block subset and the second information block subset.

In one embodiment, any information block in the first information block subset comprises Uplink Control Information (UCI).

In one embodiment, any information block in the first information block subset comprises HARQ-ACK.

In one embodiment, any information block in the second information block subset comprises UCI.

In one embodiment, any information block in the second information block subset comprises HARQ-ACK.

In one embodiment, the first information block subset comprises a positive integer number of information block(s), and the second information block subset comprises a positive integer number of information block(s), any information block in the first information block subset not belonging to the second information block subset.

### Embodiment 9C

Embodiment 9C illustrates a structure block diagram of a processing device in a first node according to one embodiment of the present disclosure, as shown in FIG. 9C. In FIG. 9C, a first node processing device 900C comprises a first receiver 901C and a first transmitter 902C.

The first receiver 901C comprises at least one of the transmitter/receiver 456 (comprising the antenna 460C), the receiving processor 452C or the controller/processor 490C in FIG. 4B of the present disclosure; the first transmitter 902C comprises at least one of the transmitter/receiver 456 (comprising the antenna 460C), the transmitting processor 455C or the controller/processor 490C in FIG. 4B of the present disclosure.

In Embodiment 9C, the first receiver 901C determines a first target QoS parameter group; the first transmitter 902C transmits a first information set, a second information set and a third information set; herein, the first information set indicates a first QoS parameter group, the second information set indicates a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the first receiver 901C receives a second signaling; herein, the second signaling indicates a second QoS parameter set, the second QoS parameter set comprises one or more QoS parameter groups, and the second QoS parameter set is used to determine the second QoS parameter group.

In one embodiment, the first receiver 901C receives a second signaling; herein, the second signaling indicates a second QoS parameter set, the second QoS parameter set comprises one or more QoS parameter groups, and the second QoS parameter set is used to determine the second QoS parameter group; the first transmitter 902C transmits a first signaling, the first signaling comprising a first QoS parameter set, the first QoS parameter set comprising multiple QoS parameter groups; herein, the second signaling indicates the second QoS parameter set from the first QoS parameter set.

In one embodiment, the first packet through the radio bearer transmitting the third information set and the radio bearer transmitting the fourth information set satisfies the first target QoS parameter group.

In one embodiment, the first information set comprises at least one of the second identity or the third identity.

### Embodiment 10A

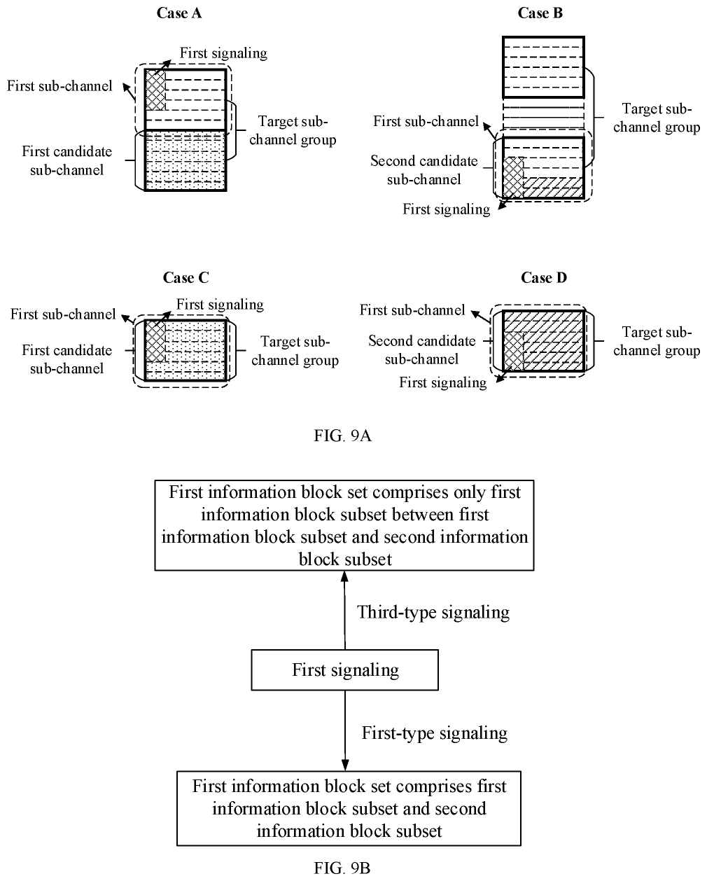

Embodiment 10A illustrates a schematic diagram of relations among a first sub-channel, a first signaling, a first candidate sub-channel, a second candidate sub-channel and a target sub-channel group according to one embodiment of the present disclosure, as shown in FIG. 10A. In FIG. 10A, a rectangle filled with oblique grids represents a first signaling in the present disclosure; a dot-filled rectangle framed with thick solid lines represents the first candidate sub-channel in the present disclosure; and a slash-filled rectangle framed with thick solid lines represents the second candidate sub-channel in the present disclosure; a rectangle framed with thick solid lines circled in the broken-line box represents a first sub-channel in the present disclosure.

In Embodiment 10A, when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

In Case A of Embodiment 10A, the target sub-channel group comprises two different sub-channels of the L sub-channels, the first candidate sub-channel is one of the two different sub-channels comprised by the target sub-channel group, and the first sub-channel is the first candidate sub-channel; in Case B of Embodiment 10A, the target sub-channel group comprises two different sub-channels of the L sub-channels, the second candidate sub-channel is a sub-channel which is lower in frequency domain of the two different sub-channels comprised by the target sub-channel group, and the first sub-channel is the first candidate sub-channel.

In one embodiment, the target sub-channel group comprises two different sub-channels of the L sub-channels, the second candidate sub-channel is a sub-channel which is lower in frequency domain of the two different sub-channels comprised by the target sub-channel group, and a frequency-domain resource block which is the lowest one in frequency domain among the M contiguous frequency-domain resource blocks comprised by the first sub-channel is the same as a frequency-domain resource block which is the lowest one in frequency domain among the M contiguous frequency-domain resource blocks comprised by the first candidate sub-channel.

In Case C of Embodiment 10A, the target sub-channel group only comprises the first candidate sub-channel of the L sub-channels, the first sub-channel being the same as the first candidate sub-channel; in Case D of Embodiment 10A, the target sub-channel group only comprises the second candidate sub-channel of the L sub-channels, the first sub-channel being the same as the first candidate sub-channel.

In one embodiment, the target sub-channel group only comprises the first candidate sub-channel of the L sub-channels, and a frequency-domain resource block which is the lowest one in frequency domain among the M contiguous frequency-domain resource blocks comprised by the first sub-channel is the same as a frequency-domain resource block which is the lowest one in frequency domain among the M contiguous frequency-domain resource blocks comprised by the first candidate sub-channel.

In one embodiment, the target sub-channel group only comprises the second candidate sub-channel of the L sub-channels, and a frequency-domain resource block which is the lowest one in frequency domain among the M contiguous frequency-domain resource blocks comprised by the first sub-channel is the same as a frequency-domain resource block which is the lowest one in frequency domain among the M contiguous frequency-domain resource blocks comprised by the first candidate sub-channel.

In one embodiment, the second candidate sub-channel is a sub-channel which is the lowest one in frequency domain among the positive integer number of sub-channels comprised by the target sub-channel group, and the first sub-channel is the first candidate sub-channel.

In one embodiment, the second candidate sub-channel is a sub-channel which is the lowest one in frequency domain among the positive integer number of sub-channels comprised by the target sub-channel group, and a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

In one embodiment, the second candidate sub-channel is one of the positive integer number of sub-channels comprised by the target sub-channel group, when the second candidate sub-channel is a sub-channel which is the lowest one in frequency domain among the positive integer number of sub-channels comprised by the target sub-channel group, the first sub-channel is the first candidate sub-channel; when the second candidate sub-channel is a sub-channel among the positive integer number of sub-channels comprised by the target sub-channel group other than the sub-channel which is the lowest one in frequency domain, the first sub-channel is a sub-channel which is the lowest one in frequency domain among the positive integer number of sub-channels comprised by the target sub-channel group.

In one embodiment, the second candidate sub-channel is one of the positive integer number of sub-channels comprised by the target sub-channel group, when a frequency-domain resource block which is the lowest one in frequency domain among M frequency-domain resource blocks comprised by the second candidate sub-channel is the same as a frequency-domain resource block which is the lowest one in frequency domain among the positive integer number of frequency-domain resource blocks comprised by the target sub-channel, a frequency-domain resource block which is the lowest one in frequency domain among M frequency-domain resource blocks comprised by the first sub-channel is the same as a frequency-domain resource block which is the lowest one in frequency domain among M frequency-domain resource blocks comprised by the first candidate sub-channel; when a frequency-domain resource block which is the lowest one in frequency domain among M frequency-domain resource blocks comprised by the second candidate sub-channel is different from a frequency-domain resource block which is the lowest one in frequency domain among the positive integer number of frequency-domain resource blocks comprised by the target sub-channel, a frequency-domain resource block which is the lowest one in frequency domain among M frequency-domain resource blocks comprised by the first sub-channel is the same as a frequency-domain resource block which is the lowest one in frequency domain among the positive integer number of frequency-domain resource blocks comprised by the target sub-channel.

### Embodiment 10B

Embodiment 10B illustrates a schematic diagram of a HARQ-ACK associated with a first signaling, as shown in FIG. 10B.

In Embodiment 10B, the first signaling is used for indicating semi-persistent scheduling release, and that the HARQ-ACK associated with the first signaling indicates whether the first signaling is correctly received.

### Embodiment 10C

Embodiment 10C illustrates a structure block diagram of a processing device in a second node according to one embodiment of the present disclosure, as shown in FIG. 10C. In FIG. 10C, a second node's processing device 1000C comprises a second receiver 1001C and a second transmitter 1002C.

The second receiver 1001C comprises at least one of the transmitter/receiver 416C (comprising the antenna 420C), the receiving processor 412C or the controller/processor 440C in FIG. 4A of the present disclosure; the second transmitter 1002C comprises at least one of the transmitter/receiver 416 (comprising the antenna 420C), the transmitting processor 415C or the controller/processor 440C in FIG. 4A of the present disclosure.

In Embodiment 10C, the second receiver 1001C receives a second information set and a third information set; herein, a first information set is used to indicate a first QoS parameter group, the second information set is used to indicate a second QoS parameter group, and the third information set comprises a first identity, a third identity and a first packet; the first QoS parameter group and the second QoS parameter group are respectively used for a radio bearer transmitting the third information set and a radio bearer transmitting a fourth information set, the fourth information set comprising a second identity, the third identity and the first packet; the first identity and the second identity are respectively Link Layer Identifiers; the first target QoS parameter group is used for generating at least one of the first QoS parameter group or the second QoS parameter group.

In one embodiment, the second transmitter 1002C transmits a second signaling; herein, the second signaling indicates a second QoS parameter set, the second QoS parameter set comprises one or more QoS parameter groups, and the second QoS parameter set is used to determine the second QoS parameter group.

In one embodiment, the second transmitter 1002C transmits a second signaling; herein, the second signaling indicates a second QoS parameter set, the second QoS parameter set comprises one or more QoS parameter groups, and the second QoS parameter set is used to determine the second QoS parameter group; the second receiver 1001C receives a first signaling, the first signaling comprising a first QoS parameter set, the first QoS parameter set comprising multiple QoS parameter groups; herein, the second signaling indicates the second QoS parameter set from the first QoS parameter set.

In one embodiment, the first packet through the radio bearer transmitting the third information set and the radio bearer transmitting the fourth information set satisfies the first target QoS parameter group.

In one embodiment, the first information set comprises at least one of the second identity or the third identity.

### Embodiment 11A

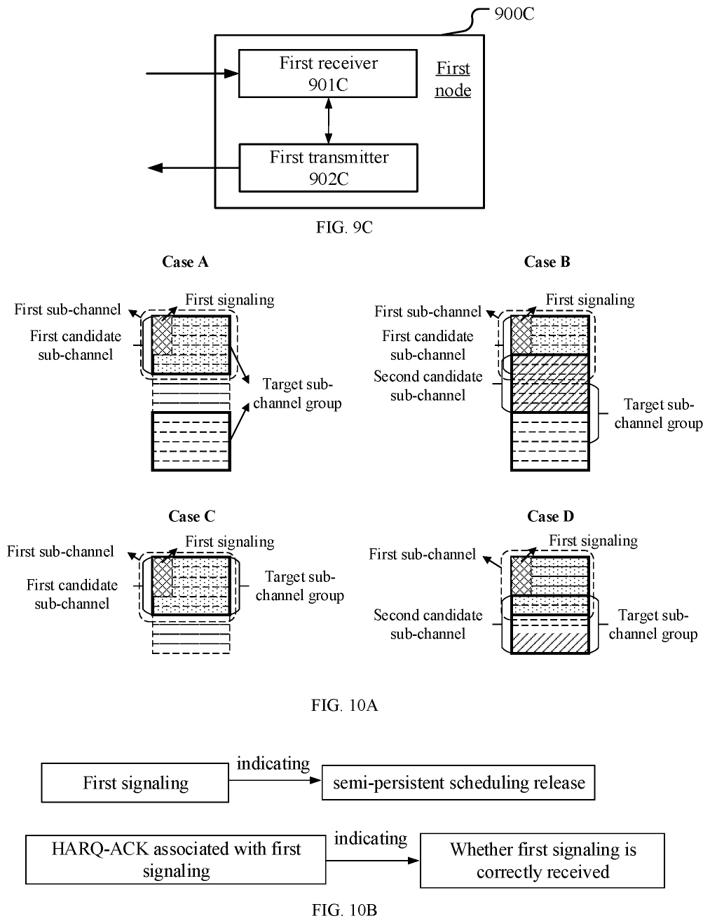

Embodiment 11A illustrates a schematic diagram of relations among a first signaling, a first signal and a target sub-channel group according to one embodiment of the present disclosure, as shown in FIG. 11A. In FIG. 11A, the rectangle filled with oblique grids represents a first signaling in the present disclosure; the broken-line framed rectangle filled with dots represents a first signal in the present disclosure; the rectangle framed with thick solid lines represents a sub-channel in the present disclosure.

In Embodiment 11A, the first signaling indicates priority of the first signal; the first signaling indicates a time-frequency resource occupied by the first signal, and the time-frequency resource occupied by the first signal indicated by the first signaling comprises the target sub-channel group in frequency domain.

In one embodiment, the priority of the first signal is a positive integer.

In one embodiment, the priority of the first signal is configured by a higher layer signaling.

In one embodiment, the priority of the first signal is one of P positive integers, P being a positive integer.

In one embodiment, the priority of the first signal is one of positive integers from 1 to P.

In one embodiment, the priority of the first signal is one of P non-negative integers, P being a positive integer.

In one embodiment, the priority of the first signal is one of non-negative integers from 0 to (P−1).

In one embodiment, the P is equal to 8.

In one embodiment, the P is equal to 10.

In one embodiment, the first signaling indicates a time-frequency resource occupied by the first signal.

In one embodiment, the first signaling indicates a time-domain resource occupied by the first signal.

In one embodiment, the first signaling indicates a frequency-domain resource occupied by the first signal.

In one embodiment, the first signaling indicates slot(s) occupied by the first signal.

In one embodiment, the first signaling indicates multicarrier symbol(s) occupied by the first signal.

In one embodiment, the first signaling indicates sub-channel(s) occupied by the first signal.

In one embodiment, the first signaling indicates a number of sub-channel(s) occupied by the first signal.

In one embodiment, the time-frequency resource occupied by the first signal indicated by the first signaling belongs to the target sub-channel group in frequency domain.

In one embodiment, the time-frequency resource occupied by the first signal indicated by the first signaling belongs to the positive integer number of sub-channel(s) comprised by the target sub-channel group in frequency domain.

In one embodiment, the time-frequency resource occupied by the first signal indicated by the first signaling is the positive integer number of sub-channel(s) comprised by the target sub-channel group in frequency domain.

In one embodiment, the time-frequency resource occupied by the first signal indicated by the first signaling is the positive integer number of frequency-domain resource block(s) comprised by the target sub-channel group in frequency domain.

In one embodiment, the time-frequency resource occupied by the first signal indicated by the first signaling comprises the target sub-channel group in frequency domain.

### Embodiment 11B

Embodiment 11B illustrates another schematic diagram of a HARQ-ACK associated with a first signaling, as shown in FIG. 11B.

In Embodiment 11B, the first node in the present disclosure receives a first bit block set; herein, the first signaling comprises scheduling information of the first bit block set; the HARQ-ACK associated with the first signaling indicates whether each bit block in the first bit block set is correctly received.

In one embodiment, the first bit block set comprises a positive integer number of TB(s).

In one embodiment, the first bit block set comprises one 1B.

In one embodiment, the first bit block set comprises a positive integer number of CBG(s).

In one embodiment, the first bit block set comprises a positive integer number of bit(s).

In one embodiment, the scheduling information of the first bit block set comprises at least one of an occupied time-domain resource, an occupied frequency-domain resource, a Modulation and Coding Scheme (MCS), configuration information of DeModulation Reference Signals (DMRS), a Hybrid Automatic Repeat reQuest (HARQ) process ID, a Redundancy Version (RV), a New Data Indicator (NDI), or a transmission antenna port, or a corresponding Transmission Configuration Indicator (TCI) state.

In one subembodiment, the configuration information of DMRS comprises at least one of a Reference Signal (RS) sequence, a mapping mode, a DMRS type, an occupied time-domain resource, an occupied frequency-domain resource, an occupied code-domain resource, a cyclic shift or an Orthogonal Cover Code (OCC).

### Embodiment 12A

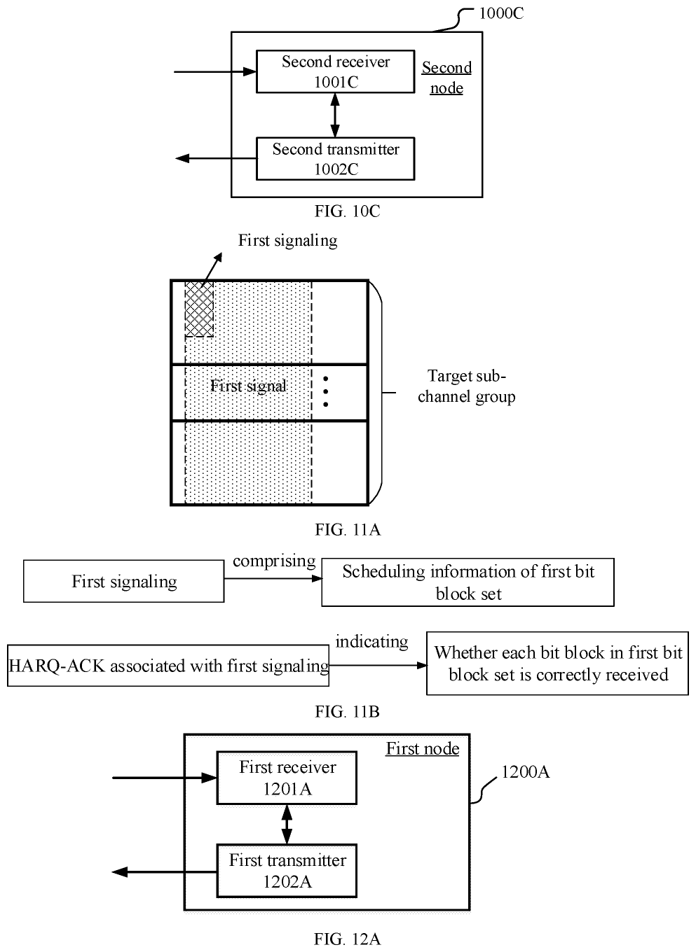

Embodiment 12A illustrates a structure block diagram of a processing device used in a first node, as shown in FIG. 12A. In FIG. 12A, a first node's processing device 1200A is mainly composed of a first receiver 1201A and a first transmitter 1202A.

In one embodiment, the first receiver 1201A comprises at least one of the antenna 452, the transmitter/receiver 454, the multi-antenna receiving processor 458, the receiving processor 456, the controller/processor 459, the memory 460 or the data source 467 in FIG. 4A of the present disclosure.

In one embodiment, the first transmitter 1202A comprises at least one of the antenna 452, the transmitter/receiver 454, the multi-antenna transmitting processor 457, the transmitting processor 468, the controller/processor 459, the memory 460 or the data source 467 in FIG. 4A of the present disclosure.

In Embodiment 12A, the first receiver 1201A receives first information; and the first transmitter 1202A transmits a first signaling in a first sub-channel; the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group, and the first signaling indicates a quantity of the positive integer number of sub-channels comprised by the target sub-channel group.

In one embodiment, the first sub-channel belongs to the target sub-channel group; when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group; the first signaling indicates a quantity of the positive integer number of sub-channels comprised by the target sub-channel group.

In one embodiment, when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

In one embodiment, the first transmitter 1202A transmits a first signal in the target sub-channel group; the first signaling indicates priority of the first signal; the first signaling indicates a time-frequency resource occupied by the first signal, and the time-frequency resource occupied by the first signal indicated by the first signaling comprises the target sub-channel group in frequency domain.

In one embodiment, the first receiver 1201A monitors a second signaling in a first target time-frequency resource group; and the first receiver 1201A monitors a third signaling in a second target time-frequency resource group; a measurement on the first target time-frequency resource group is used by the first receiver 1201A for determining whether a first candidate time-frequency resource block belongs to a candidate resource pool; and a measurement on the second target time-frequency resource group is used by the first receiver 1201A for determining whether a second candidate time-frequency resource block belongs to a candidate resource pool; the second signaling indicates the first target time-frequency resource group, while the third signaling indicates the second target time-frequency resource group; both the first target time-frequency resource group and the second target time-frequency resource group belong to a first sensing window in time domain; the first target time-frequency resource group comprises T1 time-frequency resource block(s), and each of the T1 time-frequency resource block(s) comprised by the first target time-frequency resource group comprises the first candidate sub-channel in frequency domain, T1 being a positive integer; the second target time-frequency resource group comprises T2 time-frequency resource block(s), and each of the T2 time-frequency resource block(s) comprised by the second target time-frequency resource group comprises the second candidate sub-channel in frequency domain, T2 being a positive integer; frequency-domain resources occupied by the first candidate time-frequency resource block and frequency-domain resources occupied by the first target time-frequency resource group are the same; frequency-domain resources occupied by the second candidate time-frequency resource block and frequency-domain resources occupied by the second target time-frequency resource group are the same; the candidate resource pool comprises a positive integer number of time-frequency resource block(s), and any time-frequency resource block comprised in the candidate resource pool is later than the first sensing window in time domain, and the time-frequency resource occupied by the first signal indicated by the first signaling belongs to the candidate resource pool.

In one embodiment, the first node 1200A is a UE.

In one embodiment, the first node 1200A is a relay node.

In one embodiment, the first node 1200A is a base station.

### Embodiment 12B

Embodiment 12B illustrates a structure block diagram of a processing device in a first node, as shown in FIG. 12B. In FIG. 12B, a first node's processing device 1200B comprises a first receiver 1201B and a first transmitter 1202B.

In one embodiment, the first node 1200B is a UE.

In one embodiment, the first node 1200B is a relay node.

In one embodiment, the first node 1200B is vehicle-mounted communication equipment.

In one embodiment, the first node 1200B is a UE supporting V2X communications.

In one embodiment, the first node 1200B is a relay node supporting V2X communications.

In one embodiment, the first receiver 1201B comprises at least one of the antenna 452, the receiver 454, the multi-antenna receiving processor 458, the receiving processor 456, the controller/processor 459, the memory 460 or the data source 467 in FIG. 4A of the present disclosure.

In one embodiment, the first receiver 1201B comprises at least the first five of the antenna 452, the receiver 454, the multi-antenna receiving processor 458, the receiving processor 456, the controller/processor 459, the memory 460 and the data source 467 in FIG. 4A of the present disclosure.

In one embodiment, the first receiver 1201B comprises at least the first four of the antenna 452, the receiver 454, the multi-antenna receiving processor 458, the receiving processor 456, the controller/processor 459, the memory 460 and the data source 467 in FIG. 4A of the present disclosure.

In one embodiment, the first receiver 1201B comprises at least the first three of the antenna 452, the receiver 454, the multi-antenna receiving processor 458, the receiving processor 456, the controller/processor 459, the memory 460 and the data source 467 in FIG. 4A of the present disclosure.

In one embodiment, the first receiver 1201B comprises at least the first two of the antenna 452, the receiver 454, the multi-antenna receiving processor 458, the receiving processor 456, the controller/processor 459, the memory 460 and the data source 467 in FIG. 4A of the present disclosure.

In one embodiment, the first transmitter 1202B comprises at least one of the antenna 452, the transmitter 454, the multi-antenna transmitting processor 457, the transmitting processor 468, the controller/processor 459, the memory 460 or the data source 467 in FIG. 4A of the present disclosure.

In one embodiment, the first transmitter 1202B comprises at least the first five of the antenna 452, the transmitter 454, the multi-antenna transmitting processor 457, the transmitting processor 468, the controller/processor 459, the memory 460 and the data source 467 in FIG. 4A of the present disclosure.

In one embodiment, the first transmitter 1202B comprises at least the first four of the antenna 452, the transmitter 454, the multi-antenna transmitting processor 457, the transmitting processor 468, the controller/processor 459, the memory 460 and the data source 467 in FIG. 4A of the present disclosure.

In one embodiment, the first transmitter 1202B comprises at least the first three of the antenna 452, the transmitter 454, the multi-antenna transmitting processor 457, the transmitting processor 468, the controller/processor 459, the memory 460 and the data source 467 in FIG. 4A of the present disclosure.

In one embodiment, the first transmitter 1202B comprises at least the first two of the antenna 452, the transmitter 454, the multi-antenna transmitting processor 457, the transmitting processor 468, the controller/processor 459, the memory 460 and the data source 467 in FIG. 4A of the present disclosure.

The first receiver 1201B monitors first-type signalings, second-type signalings and third-type signalings in a first time-frequency resource pool; and receives a first signaling in the first time-frequency resource pool.

The first transmitter 1202B transmits a first information block set in a first radio resource block.

In Embodiment 12B, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one embodiment, the first-type signaling corresponds to a first priority, and the third-type signaling corresponds to a second priority, the first priority being different from the second priority.

In one embodiment, the first receiver 1201B receives a second signaling in the first time-frequency resource pool; herein, the second signaling is a second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

In one embodiment, the first receiver 1201B also receives L1-1 signaling(s) of L1 signalings other than the first signaling in the first time-frequency resource pool, L1 being a positive integer greater than 1; herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings.

In one embodiment, the first transmitter 1202B also transmits the second information block subset in a second radio resource block; herein, the first signaling is the third-type signaling; the second signaling is used to indicate the second radio resource block, the second radio resource block being orthogonal to the first radio resource block in time domain.

In one embodiment, the first receiver 1201B also receives L2-1 signaling(s) of L2 signalings other than the second signaling in the first time-frequency resource pool, L2 being a positive integer greater than 1; herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

In one embodiment, the first signaling is used for indicating semi-persistent scheduling release, and that the HARQ-ACK associated with the first signaling indicates whether the first signaling is correctly received.

In one embodiment, the first receiver 1201B also receives a first bit block set; herein, the first signaling comprises scheduling information of the first bit block set; the HARQ-ACK associated with the first signaling indicates whether each bit block in the first bit block set is correctly received.

### Embodiment 13A

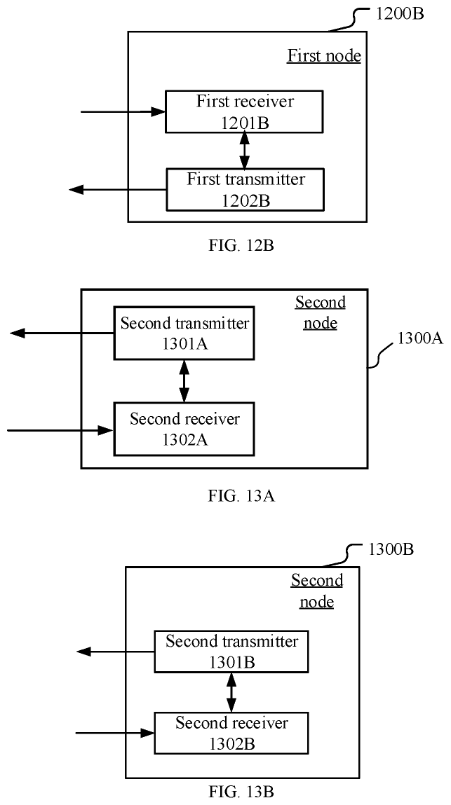

Embodiment 13A illustrates a structure block diagram of a processing device used in a second node, as shown in FIG. 13A. In FIG. 13A, a second node's processing device 1300A is mainly composed of a second transmitter 1301A and a second receiver 1302A.

In one embodiment, the second transmitter 1301A comprises at least one of the antenna 420, the transmitter/receiver 418, the multi-antenna transmitting processor 471, the transmitting processor 416, the controller/processor 475 or the memory 476 in FIG. 4A of the present disclosure.

In one embodiment, the second receiver 1302A comprises at least one of the antenna 420, the transmitter/receiver 418, the multi-antenna receiving processor 472, the receiving processor 470, the controller/processor 475 or the memory 476 in FIG. 4A of the present disclosure.

In Embodiment 13A, the second receiver 1302A receives first information; and the second receiver 1302A receives a first signaling in a first sub-channel; the first information indicates a first resource pool, the first resource pool comprising Q frequency-domain resource blocks, Q being a positive integer greater than 1; the first sub-channel is one of L sub-channels, L being a positive integer greater than 1, any one of the L sub-channels comprises M contiguous frequency-domain resource blocks in frequency domain, and the frequency-domain resource blocks comprised by any one of the L sub-channels belong to the first resource pool, M being a positive integer number greater than 1 and no greater than Q, the first information indicating M; a first candidate sub-channel and a second candidate sub-channel are two different sub-channels among the L sub-channels, a frequency-domain resource block comprised by the first candidate sub-channel and a frequency-domain resource block comprised by the second candidate sub-channel are the same; either of the first candidate sub-channel and the second candidate sub-channel belongs to a target sub-channel group, the target sub-channel group comprising a positive integer number of sub-channels; each sub-channel comprised by the target sub-channel group is one of the L sub-channels, and the first signaling is used to indicate the target sub-channel group.

In one embodiment, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group, and the first signaling indicates a quantity of the positive integer number of sub-channels comprised by the target sub-channel group.

In one embodiment, the first sub-channel belongs to the target sub-channel group; when the first candidate sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, a frequency-domain resource block which is highest in frequency domain among the M contiguous frequency-domain resource blocks comprised by the first sub-channel is the same as a frequency-domain resource block which is highest in frequency domain among the positive integer number of frequency-domain resource blocks comprised by the target sub-channel group; the first signaling indicates a quantity of the positive integer number of sub-channels comprised by the target sub-channel group.

In one embodiment, when the first candidate sub-channel belongs to the target sub-channel group, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel of the positive integer number of sub-channels comprised by the target sub-channel group other than the sub-channel which is the lowest one in frequency domain, the first sub-channel belongs to the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the positive integer number of frequency-domain resource blocks comprised by the target sub-channel group; when the second candidate sub-channel belongs to the target sub-channel group, and the second candidate sub-channel is a sub-channel which is the lowest one in frequency domain among the positive integer number of sub-channels comprised by the target sub-channel group, the first sub-channel is a sub-channel of the L sub-channels other than the positive integer number of sub-channels comprised by the target sub-channel group, a frequency-domain resource block which is the lowest one in frequency domain among the M contiguous frequency-domain resource blocks comprised by the first sub-channel is the same as a frequency-domain resource block which is the lowest one in frequency domain among the M frequency-domain resource blocks comprised by the first candidate sub-channel.

In one embodiment, the second receiver 1302A receives a first signal in the target sub-channel group; the first signaling indicates priority of the first signal; the first signaling indicates a time-frequency resource occupied by the first signal, and the time-frequency resource occupied by the first signal indicated by the first signaling comprises the target sub-channel group in frequency domain.

In one embodiment, the second node 1300A is a base station.

In one embodiment, the second node 1300A is a relay node.

In one embodiment, the second node 1300A is a UE.

### Embodiment 13B

Embodiment 13B illustrates a structure block diagram of a processing device in a second node, as shown in FIG. 13B. In FIG. 13B, a second node's processing device 1300B comprises a second transmitter 1301B and a second receiver 1302B.

In one embodiment, the second node 1300B is a UE.

In one embodiment, the second node 1300B is a base station.

In one embodiment, the second node 1300B is a relay node.

In one embodiment, the second transmitter 1301B comprises at least one of the antenna 420, the transmitter 418, the multi-antenna transmitting processor 471, the transmitting processor 416, the controller/processor 475 or the memory 476 in FIG. 4A of the present disclosure.

In one embodiment, the second transmitter 1301B comprises at least the first five of the antenna 420, the transmitter 418, the multi-antenna transmitting processor 471, the transmitting processor 416, the controller/processor 475 and the memory 476 in FIG. 4A of the present disclosure.

In one embodiment, the second transmitter 1301B comprises at least the first four of the antenna 420, the transmitter 418, the multi-antenna transmitting processor 471, the transmitting processor 416, the controller/processor 475 and the memory 476 in FIG. 4A of the present disclosure.

In one embodiment, the second transmitter 1301B comprises at least the first three of the antenna 420, the transmitter 418, the multi-antenna transmitting processor 471, the transmitting processor 416, the controller/processor 475 and the memory 476 in FIG. 4A of the present disclosure.

In one embodiment, the second transmitter 1301B comprises at least the first two of the antenna 420, the transmitter 418, the multi-antenna transmitting processor 471, the transmitting processor 416, the controller/processor 475 and the memory 476 in FIG. 4A of the present disclosure.

In one embodiment, the second receiver 1302B comprises at least one of the antenna 420, the receiver 418, the multi-antenna receiving processor 472, the receiving processor 470, the controller/processor 475 or the memory 476 in FIG. 4A of the present disclosure.

In one embodiment, the second receiver 1302B comprises at least the first five of the antenna 420, the receiver 418, the multi-antenna receiving processor 472, the receiving processor 470, the controller/processor 475 and the memory 476 in FIG. 4A of the present disclosure.

In one embodiment, the second receiver 1302B comprises at least the first four of the antenna 420, the receiver 418, the multi-antenna receiving processor 472, the receiving processor 470, the controller/processor 475 and the memory 476 in FIG. 4A of the present disclosure.

In one embodiment, the second receiver 1302B comprises at least the first three of the antenna 420, the receiver 418, the multi-antenna receiving processor 472, the receiving processor 470, the controller/processor 475 and the memory 476 in FIG. 4A of the present disclosure.

In one embodiment, the second receiver 1302B comprises at least the first two of the antenna 420, the receiver 418, the multi-antenna receiving processor 472, the receiving processor 470, the controller/processor 475 and the memory 476 in FIG. 4A of the present disclosure.

The second transmitter 1301B transmits a first signaling in a first time-frequency resource pool.

The second receiver 1302B receives a first information block set in a first radio resource block.

In Embodiment 13B, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

In one embodiment, the first-type signaling corresponds to a first priority, and the third-type signaling corresponds to a second priority, the first priority being different from the second priority.

In one embodiment, the second transmitter 1301B also transmits a second signaling in the first time-frequency resource pool; herein, the second signaling is a second-type signaling, a first information block subset comprises a HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

In one embodiment, the second transmitter 1301B also transmits L1-1 signaling(s) of L1 signalings other than the first signaling in the first time-frequency resource pool, L1 being a positive integer greater than 1; herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings.

In one embodiment, the second receiver 1302B also receives the second information block subset in a second radio resource block; herein, the first signaling is the third-type signaling; the second signaling is used to indicate the second radio resource block, the second radio resource block being orthogonal to the first radio resource block in time domain.

In one embodiment, the second transmitter 1301B also transmits L2-1 signaling(s) of L2 signalings other than the second signaling in the first time-frequency resource pool, L2 being a positive integer greater than 1; herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

In one embodiment, the first signaling is used for indicating semi-persistent scheduling release, and that the HARQ-ACK associated with the first signaling indicates whether the first signaling is correctly received.

In one embodiment, the second transmitter 1301B also transmits a first bit block set; herein, the first signaling comprises scheduling information of the first bit block set; the HARQ-ACK associated with the first signaling indicates whether each bit block in the first bit block set is correctly received.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The first node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present disclosure includes but is not limited to mobile phones, tablet computers, notebooks, network cards, low-consumption equipment, eMTC terminals, NB-IOT terminals, vehicle-mounted communication equipment, aircrafts, airplanes, unmanned aerial vehicles, telecontrolled aircrafts, etc. The UE or ender in the present disclosure includes but is not limited to mobile phones, tablet computers, notebooks, network cards, low-consumption equipment, eMTC terminals, NB-IOT terminals, vehicle-mounted communication equipment, aircrafts, airplanes, unmanned aerial vehicles, telecontrolled aircrafts, etc. The base station or network equipment in the present disclosure includes but is not limited to macro-cellular base stations, micro-cellular base stations, home base stations, relay base station, eNB, gNB, Transmitter Receiver Point (TRP), GNSS, relay satellite, satellite base station, airborne base station, and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, monitoring first-type signalings, second-type signalings and third-type signalings in a first time-frequency resource pool; and receiving a first signaling in the first time-frequency resource pool;
a first transmitter, transmitting a first information block set in a first radio resource block;
wherein, the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

2. The first node according to claim 1, wherein the first-type signaling corresponds to a first priority, and the third-type signaling corresponds to a second priority, the first priority being different from the second priority.

3. The first node according to claim 1, wherein the first receiver receives a second signaling in the first time-frequency resource pool; herein, the second signaling is a second-type signaling, a first information block subset comprises the HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

4. The first node according to any of claim 3, wherein the first receiver also receives L1-1 signaling(s) of L1 signalings other than the first signaling in the first time-frequency resource pool, L1 being a positive integer greater than 1; herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings;
or, the first transmitter also transmits the second information block subset in a second radio resource block; herein, the first signaling is the third-type signaling; the second signaling is used to indicate the second radio resource block, the second radio resource block being orthogonal to the first radio resource block in time domain;
or, the first receiver also receives L2-1 signaling(s) of L2 signalings other than the second signaling in the first time-frequency resource pool, L2 being a positive integer greater than 1; herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

5. The first node according to claim 1, wherein the first signaling is used for indicating semi-persistent scheduling release, and that the HARQ-ACK associated with the first signaling indicates whether the first signaling is correctly received;
or, the first receiver also receives a first bit block set; herein, the first signaling comprises scheduling information of the first bit block set; the HARQ-ACK associated with the first signaling indicates whether each bit block in the first bit block set is correctly received.

6. A second node for wireless communications, comprising:
a second transmitter, transmitting a first signaling in a first time-frequency resource pool; and
a second receiver, receiving a first information block set in a first radio resource block;
wherein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

7. The second node according to claim 6, wherein the first-type signaling corresponds to a first priority, and the third-type signaling corresponds to a second priority, the first priority being different from the second priority.

8. The second node according to claim 6, wherein the second transmitter also transmits a second signaling in the first time-frequency resource pool; herein, the second signaling is a second-type signaling, a first information block subset comprises the HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

9. The second node according to claim 8, wherein the second transmitter also transmits L1-1 signaling(s) of L1 signalings other than the first signaling in the first time-frequency resource pool, L1 being a positive integer greater than 1; herein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings;
or, the second receiver also receives the second information block subset in a second radio resource block; herein, the first signaling is the third-type signaling; the second signaling is used to indicate the second radio resource block, the second radio resource block being orthogonal to the first radio resource block in time domain;
or, the second transmitter also transmits L2-1 signaling(s) of L2 signalings other than the second signaling in the first time-frequency resource pool, L2 being a positive integer greater than 1; herein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

10. The second node according to claim 6, wherein the first signaling is used for indicating semi-persistent scheduling release, and that the HARQ-ACK associated with the first signaling indicates whether the first signaling is correctly received;
or, the second transmitter also transmits a first bit block set; herein, the first signaling comprises scheduling information of the first bit block set; the HARQ-ACK associated with the first signaling indicates whether each bit block in the first bit block set is correctly received.

11. A method in a first node for wireless communications, comprising:
monitoring first-type signalings, second-type signalings and third-type signalings in a first time-frequency resource pool;
receiving a first signaling in the first time-frequency resource pool; and
transmitting a first information block set in a first radio resource block;
wherein the first signaling is the first-type signaling or the third-type signaling, and the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

12. The second node according to claim 11, wherein the first-type signaling corresponds to a first priority, and the third-type signaling corresponds to a second priority, the first priority being different from the second priority.

13. The second node according to claim 11, comprising:
receiving a second signaling in the first time-frequency resource pool;
wherein, the second signaling is the second-type signaling, a first information block subset comprises the HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

14. The second node according to claim 13, comprising: receiving L1-1 signaling(s) of L1 signalings other than the first signaling in the first time-frequency resource pool, L1 being a positive integer greater than 1; wherein the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings.
or, comprising: transmitting the second information block subset in a second radio resource block; wherein, the first signaling is the third-type signaling; the second signaling is used to indicate the second radio resource block, the second radio resource block being orthogonal to the first radio resource block in time domain;
or, comprising: receiving L2-1 signaling(s) of L2 signalings other than the second signaling in the first time-frequency resource pool, L2 being a positive integer greater than 1; wherein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

15. The second node according to claim 11, wherein the first signaling is used for indicating semi-persistent scheduling release, and that the HARQ-ACK associated with the first signaling indicates whether the first signaling is correctly received;
or, comprising: receiving a first bit block set; herein, the first signaling comprises scheduling information of the first bit block set; the HARQ-ACK associated with the first signaling indicates whether each bit block in the first bit block set is correctly received.

16. A method in a second node for wireless communications, comprising:
transmitting a first signaling in a first time-frequency resource pool; and
receiving a first information block set in a first radio resource block;
wherein, the first signaling is the first-type signaling or the third-type signaling, the first signaling is used to indicate the first radio resource block, and the first information block set comprises a HARQ-ACK associated with the first signaling; both the first-type signaling and the third-type signaling comprise a first field, and the first field of the first signaling indicates a first target value, the first target value being a non-negative integer; when the first signaling is the first-type signaling, a number of the first-type signalings and a number of the second-type signalings transmitted in the first time-frequency resource pool are jointly used to determine the first target value; when the first signaling is the third-type signaling, a number of the third-type signalings transmitted in the first time-frequency resource pool is used to determine the first target value, and the first target value is unrelated to the number of the second-type signalings transmitted in the first time-frequency resource pool.

17. The second node according to claim 16, wherein the first-type signaling corresponds to a first priority, and the third-type signaling corresponds to a second priority, the first priority being different from the second priority.

18. The second node according to claim 16, comprising:
transmitting a second signaling in the first time-frequency resource pool;
wherein, the second signaling is the second-type signaling, a first information block subset comprises the HARQ-ACK associated with the first signaling, and a second information block subset comprises a HARQ-ACK associated with the second signaling; when the first signaling is the first-type signaling, the first information block set comprises the first information block subset and the second information block subset; when the first signaling is the third-type signaling, the first information block set comprises only the first information block subset of the first information block subset and the second information block subset.

19. The second node according to claim 18, comprising: transmitting L1-1 signaling(s) of L1 signalings other than the first signaling in the first time-frequency resource pool, L1 being a positive integer greater than 1; wherein, the first signaling is a last one of the L1 signalings; each of the L1 signalings is the first-type signaling, or, each of the L1 signalings is the third-type signaling; the first information block subset comprises L1 information blocks, the L1 signalings respectively correspond to the L1 information blocks, the L1 information blocks respectively comprising HARQ-ACKs associated with the corresponding signalings;
or, comprising: receiving the second information block subset in a second radio resource block; wherein, the first signaling is the third-type signaling; the second signaling is used to indicate the second radio resource block, the second radio resource block being orthogonal to the first radio resource block in time domain;
or, comprising: transmitting L2-1 signaling(s) of L2 signalings other than the second signaling in the first time-frequency resource pool, L2 being a positive integer greater than 1; wherein, the second signaling is a last one of the L2 signalings; each of the L2 signalings is the second-type signaling; the second information block subset comprises L2 information blocks, the L2 signalings respectively correspond to the L2 information blocks, the L2 information blocks respectively comprising HARQ-ACKs associated with the corresponding signalings.

20. The second node according to claim 16, wherein the first signaling is used for indicating semi-persistent scheduling release, and that the HARQ-ACK associated with the first signaling indicates whether the first signaling is correctly received;
or, comprising: transmitting a first bit block set; herein, the first signaling comprises scheduling information of the first bit block set; the HARQ-ACK associated with the first signaling indicates whether each bit block in the first bit block set is correctly received.
